(19) United States
(12) Patent Application Publication
(10) Pub. No.: US 2026/0286224 A1
(43) Pub. Date: Sep. 24, 2026

(54) LIQUID CRYSTAL COMPOSITION, LIGHT ABSORPTION ANISOTROPIC FILM, LAMINATE, AND IMAGE DISPLAY DEVICE

(71) Applicant: FUJIFILM Corporation, Tokyo (JP)

(72) Inventors: Wataru HOSHINO, Minamiashigara-shi (JP); Hiroshi MATSUYAMA, Minamiashigara-shi (JP); Hiroyuki OKUSA, Minamiashigara-shi (JP)

(73) Assignee: FUJIFILM Corporation, Tokyo (JP)

(21) Appl. No.: 19/668,823

(22) Filed: May 6, 2026

Related U.S. Application Data
(63) Continuation of application No. PCT/JP2024/045890, filed on Dec. 25, 2024.

(30) Foreign Application Priority Data
Dec. 27, 2023 (JP) 2023-221298

(51) Int. Cl. C09K 19/54; G02B 5/00; G02F 1/13363

(52) U.S. Cl. CPC C09K 19/544; G02B 5/003; G02F 1/133638; C09K 2019/548

(57) ABSTRACT

A liquid crystal composition is provided that forms a light absorption anisotropic film with suppressed surface unevenness and excellent alignment. The composition includes a liquid crystal compound, a dichroic substance, a first polymer having a repeating unit with a specified structure, and a second polymer having a different repeating unit with the specified structure. A ratio of silicon atom content in the first polymer to that in the second polymer is 1 or greater relative to total solid content. Also provided are a light absorption anisotropic film, a laminate, and an image display device using the composition.

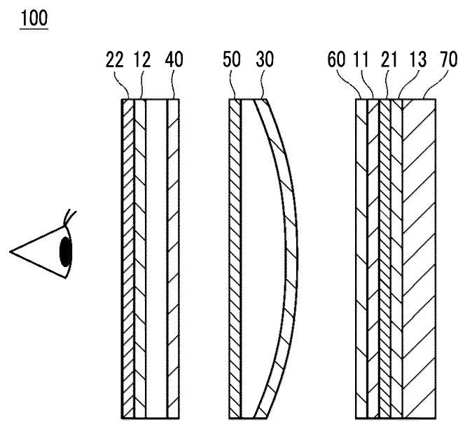

### CROSS-REFERENCE TO RELATED APPLICATIONS

This application is a Continuation of PCT International Application No. PCT/JP2024/045890 filed on Dec. 25, 2024, which claims priority under 35 U.S.C. § 119(a) to Japanese Patent Application No. 2023-221298 filed on Dec. 27, 2023. The above applications are hereby expressly incorporated by reference, in their entirety, into the present application.

### BACKGROUND OF THE INVENTION

### 1. Field of the Invention

The present invention relates to a liquid crystal composition, a light absorption anisotropic film, a laminate, and an image display device.

### 2. Description of the Related Art

An optical film such as an optical compensation sheet and a retardation film is used in various display devices from the viewpoint of eliminating image coloration, controlling a viewing angle, and the like.

For example, WO2022/014342A discloses an optically anisotropic layer obtained using a liquid crystal composition including a liquid crystal compound, a dichroic substance, and an interface improver having a repeating unit including a fluorine atom, and discloses that an optically anisotropic layer in which an orientation defect and the like are suppressed can be obtained by using an interface improver having a repeating unit including a fluorine atom.

### SUMMARY OF THE INVENTION

In recent years, due to the poor degradability and toxicity thereof, the regulation of perfluoroalkyl compounds and polyfluoroalkyl compounds (PFAS) has been promoted, and the use of alternatives that do not use a fluorine atom, typically alternative materials containing a silicon atom, has been studied.

Therefore, the present inventors have found that, in a liquid crystal composition including a liquid crystal compound, a dichroic substance, and an interface improver including a fluorine atom as described in WO2022/014342A, in a case where a light absorption anisotropic film is formed using a polymer (interface improver) having a repeating unit including a silicon atom instead of the interface improver including a fluorine atom, there is a case where surface unevenness occurs or a case where the alignment degree is insufficient.

Therefore, an object of the present invention is to provide a liquid crystal composition with which it is possible to form a light absorption anisotropic film in which the occurrence of surface unevenness is suppressed and the alignment degree is also excellent, a light absorption anisotropic film, a laminate, and an image display device.

As a result of intensive studies, the present inventors have found that the above-described object can be achieved by the following configuration.

[1]

A liquid crystal composition including:
a liquid crystal compound;
a dichroic substance;
a polymer 1 having a repeating unit A including a structure represented by Formula (A); and
a polymer 2 having a repeating unit A including a structure represented by Formula (A), the polymer 2 being different from the polymer 1,
in which in a case where a content of silicon atoms contained in the polymer 1 is denoted by X1 parts by mass and a content of silicon atoms contained in the polymer 2 is denoted by X2 parts by mass with respect to 100 parts by mass of a total solid content mass of the liquid crystal composition, a ratio represented by X1/X2 is 1 or more.

In Formula (A),
R^{A1} and R^{A2} each independently represent a hydrogen atom or an alkyl group.
R^{A3} represents a hydrogen atom, a halogen atom, or a substituent.
X represents a substituent including one or more structures represented by Formula (a).

In Formula (a),
* represents a bonding position.
R^{a1}, R^{a2}, and R^{a3} each independently represent an alkyl group, an alkenyl group, an aryl group, or an alkylene aryl group, which may have a substituent.
   [2]

The liquid crystal composition according to [1],
in which, in a case where a content of the repeating unit A contained in the polymer 1 is denoted by A1% by mass with respect to all repeating units of the polymer 1, and
a content of the repeating unit A contained in the polymer 2 is denoted by A2% by mass with respect to all repeating units of the polymer 2, a ratio represented by A1/A2 is more than 1.
   [3]

The liquid crystal composition according to [2],
in which the ratio represented by A1/A2 is 1.2 to 7.50.
   [4]

The liquid crystal composition according to [2] or [3],
in which A1 is 30.0% to 75.0% by mass, and
A2 is 10.0% to 50.0% by mass.
   [5]

The liquid crystal composition according to [2] or [3],
in which A1 is 30.0% to 90.0% by mass, and
A2 is 5.0% to 65.0% by mass.
   [6]

The liquid crystal composition according to any one of [1] to [5],
in which the ratio represented by X1/X2 is 1.10 to 41.32.
   [7]

The liquid crystal composition according to any one of [1] to [5],
in which the ratio represented by X1/X2 is 1.10 to 79.34.
   [8]

The liquid crystal composition according to any one of [1] to [7],
in which X1 is 0.0016 to 0.057 parts by mass, and
X2 is 0.0013 to 0.0500 parts by mass.
   [9]

The liquid crystal composition according to any one of [1] to [7],
in which X1 is 0.0027 to 0.0546 parts by mass, and
X2 is 0.0006 to 0.0437 parts by mass.
   [10]

The liquid crystal composition according to any one of [1] to [9],
in which at least one of the polymer 1 or the polymer 2 has a repeating unit B represented by Formula (B).

In Formula (B),
R^{B1}, R^{B2}, and R^{B3} each independently represent a hydrogen atom, a halogen atom, a cyano group, an alkyl group, an alkenyl group, or an aryl group.
R^{B4} and R^{B5} each independently represent a hydrogen atom or a substituent. In a case where R^{B4} and R^{B5} each represent a substituent, R^{B4} and R^{B5} may be linked to each other to form a ring.
   [11]

The liquid crystal composition according to any one of [1] to [10],
in which at least one of the polymer 1 or the polymer 2 has a repeating unit D represented by Formula (D).

In Formula (D),
R^{D1}, R^{D2}, and R^{D3} each independently represent a hydrogen atom, a halogen atom, a cyano group, an alkyl group, an alkenyl group, or an aryl group.
L^{D1} represents a single bond, —COO—, or —CO—.
Sp^{D1} represents a divalent hydrocarbon group having 1 to 20 carbon atoms. Provided that, one —CH₂— or two or more —CH₂—'s which are not adjacent to each other among —CH₂—'s constituting a part of the hydrocarbon group may be each independently substituted with —O—, —S—, —NH—, or —N(Q)-, and Q represents a substituent.
L^{D2} and L^{D3} each independently represent a single bond or a divalent linking group.
Cy^{D} represents a divalent linking group including a mesogen group.
D represents a hydrogen-bonding group formed of a hydrogen atom and a non-metal atom of Groups 14 to 16. Provided that, the non-metal atom may have a substituent.
n represents an integer of 1 to 3. In a case where n is 2 or 3, a plurality of L^{D2}'s may be the same or different from each other, and a plurality of Cy^{D}'s may be the same or different from each other.
   [12]

The liquid crystal composition according to any one of [1] to [11],
in which at least one of the polymer 1 or the polymer 2 has both a repeating unit B represented by Formula (B) and a repeating unit D represented by Formula (D).

In Formula (B),
R^{B1}, R^{B2}, and R^{B3} each independently represent a hydrogen atom, a halogen atom, a cyano group, an alkyl group, an alkenyl group, or an aryl group.
R^{B4} and R^{B5} each independently represent a hydrogen atom or a substituent. In a case where R^{B4} and R^{B5} each represent a substituent, R^{B4} and R^{B5} may be linked to each other to form a ring.

In Formula (D),
R^{D1}, R^{D2}, and R^{D3} each independently represent a hydrogen atom, a halogen atom, a cyano group, an alkyl group, an alkenyl group, or an aryl group.
L^{D1} represents a single bond, —COO—, or —CO—.
Sp^{D1} represents a divalent hydrocarbon group having 1 to 20 carbon atoms. Provided that, one —CH₂— or two or more —CH₂—'s which are not adjacent to each other among —CH₂—'s constituting a part of the hydrocarbon group may be each independently substituted with —O—, —S—, —NH—, or —N(Q)-, and Q represents a substituent.
L^{D2} and L^{D3} each independently represent a single bond or a divalent linking group.
Cy^{D} represents a divalent linking group including a mesogen group.
D represents a hydrogen-bonding group formed of a hydrogen atom and a non-metal atom of Groups 14 to 16. Provided that, the non-metal atom may have a substituent.
n represents an integer of 1 to 3. In a case where n is 2 or 3, a plurality of L^{D2}'s may be the same or different from each other, and a plurality of Cy^{D}'s may be the same or different from each other.
   [13]

The liquid crystal composition according to any one of [1] to [9],
in which at least one of the polymer 1 or the polymer 2 has a repeating unit E which does not contain a fluorine atom or a polymerizable group, and
the repeating unit E satisfies Condition 1 or Condition 2.
Condition 1: the repeating unit E has a polar group at a terminal of a side chain
Condition 2: the repeating unit E is represented by Formula (E-1) or (E-2)

In Formula E-1,
R^{E2} represents a hydrogen atom or a substituent.
L^{E1} represents a single bond or a divalent linking group selected from the group consisting of —O—, —S—, —COO—, —OCO—, —CONR^{L1}—, —NR^{L1}COO—, —CR^{L1}N—, a substituted or unsubstituted divalent aliphatic group, a substituted or unsubstituted divalent aromatic group, and a combination thereof, and R^{L1} represents a hydrogen atom or an alkyl group having 1 to 20 carbon atoms.
A ring E represents a ring structure having a cationized nitrogen atom.
X represents an anion.
L² represents a hydrogen atom or a substituent.

In Formula (E-2),
R^{E3} represents a hydrogen atom or a substituent.
L^{E3} represents a single bond or a divalent linking group selected from the group consisting of —O—, —S—, —COO—, —OCO—, —CONR^{L1}—, —NR^{L1}COO—, —CR^{L1}N—, a substituted or unsubstituted divalent aliphatic group, a substituted or unsubstituted divalent aromatic group, and a combination thereof, and R^{L1} represents a hydrogen atom or an alkyl group having 1 to 20 carbon atoms.
R^{E4} and R^{E5} each independently represent a hydrogen atom, a substituted or unsubstituted aliphatic hydrocarbon group, a substituted or unsubstituted aryl group, or a substituted or unsubstituted heteroaryl group, and R^{E4} and R^{E5} may be linked to each other through a linking group consisting of an alkylene linking group, an arylene linking group, or a combination of these groups.
   [14]

A light absorption anisotropic film obtained by using the liquid crystal composition according to any one of [1] to [13].

[15]

The light absorption anisotropic film according to [14],
in which an alignment state of the liquid crystal compound and the dichroic substance contained in the light absorption anisotropic film is immobilized, and
an angle θ between a transmittance central axis of the light absorption anisotropic film and a normal direction of a surface of the light absorption anisotropic film is more than 45° and 90° or less.
   [16]

The light absorption anisotropic film according to [14],
in which an alignment state of the liquid crystal compound and the dichroic substance contained in the light absorption anisotropic film is immobilized, and
an angle θ between a transmittance central axis of the light absorption anisotropic film and a normal direction of a surface of the light absorption anisotropic film is 0° or more and 45° or less.
   [17]

A laminate including:
the light absorption anisotropic film according to any one of [14] to [16]; and a λ/4 plate.
   [18]

An image display device including:
the light absorption anisotropic film according to any one of [14] to [16]; and
a display element.

According to the present invention, it is possible to provide a liquid crystal composition, a light absorption anisotropic film, a laminate, and an image display device, with which a light absorption anisotropic film in which occurrence of surface unevenness is suppressed and an alignment degree is also excellent can be formed.

### BRIEF DESCRIPTION OF THE DRAWINGS

The FIGURE is a side view schematically showing an embodiment of a virtual reality display device which is an example of an image display device according to the present invention.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

In the present specification, the numerical range expressed by using “to” means a range including the numerical values before and after “to” as the lower limit value and the upper limit value. In a numerical range described in a stepwise manner in the present specification, an upper limit value or a lower limit value described in a certain numerical range may be replaced with an upper limit value or a lower limit value in another numerical range described in a stepwise manner. In addition, in the numerical range described in the present specification, an upper limit value or a lower limit value described in a certain numerical range may be replaced with values shown in Examples.

In addition, in the present specification, materials that correspond to each component may be used alone or in combination of two or more kinds. Here, in a case where two or more kinds of materials are used in combination for each component, the content of the component refers to the total content of the materials to be combined unless specified otherwise.

Further, in the present specification, “(meth)acrylate” denotes “acrylate” or “methacrylate”, “(meth)acryl” denotes “acryl” or “methacryl”, “(meth)acryloyl” denotes “acryloyl” or “methacryloyl”, and “(meth)acrylic acid” denotes “acrylic acid” or “methacrylic acid”.

In addition, a bonding direction of divalent groups described in the present specification is not limited unless otherwise specified. For example, in a case where Y in a compound represented by Formula “X—Y—Z” is —C(O)—O—, Y may be —C(O)—O— or —O—C(O)—. In addition, the above-described compound may be “X—C(O)—O—Z” or “X—O—C(O)—Z”.

In addition, in the present specification, “orthogonal” and “parallel” related to an angle mean a range within ±10° of the exact angle, and “same” and “different” related to an angle can be determined based on whether or not a difference therebetween is less than 5°.

In addition, in the present specification, “visible light” refers to 380 to 780 nm.

In addition, in the present specification, in a case where there is no particular description regarding a measurement wavelength, the measurement wavelength is 550 nm.

In the present specification, “slow axis” means a direction in which the in-plane refractive index is maximum. In addition, the “slow axis” of the light absorption anisotropic film is intended to mean a slow axis of the entire light absorption anisotropic film.

In the present specification, “Re(λ)” and “Rth(λ)” represent an in-plane retardation at a wavelength λ and a thickness direction retardation at the wavelength λ, respectively.

Here, the values of the in-plane retardation and the thickness-direction retardation refer to values measured using AxoScan OPMF-1 (manufactured by Opto Science, Inc.) with a light having a measurement wavelength.

Specifically, by inputting an average refractive index ((nx+ny+nz)/3) and a film thickness (d (μm)) to AxoScan OPMF-1, it is possible to calculate:
a slow axis direction) (°),

$$Re ( λ ) = R 0 ( λ ) ,$$

$$and$$

$$Rth ( λ ) = ( ( nx + ny ) / 2 - nx ) \times d$$

are calculated.

R0(λ) is expressed in a numerical value calculated with AxoScan OPMF-1, and means Re(λ).

### [Substituent W]

A substituent W used in the present specification represents any of the following groups.

Examples of the substituent W include a halogen atom, an alkyl group having 1 to 20 carbon atoms, a halogenated alkyl group having 1 to 20 carbon atoms, a cycloalkyl group having 1 to 20 carbon atoms, an alkylcarbonyl group having 1 to 10 carbon atoms, an alkoxycarbonyl group having 1 to 10 carbon atoms, an alkylcarbonyloxy group having 1 to 10 carbon atoms, an alkylamino group having 1 to 10 carbon atoms, an alkylaminocarbonyl group, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group (also referred to as a hetero ring group), a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), a sulfate group (—OSO₃H), and other known substituents.

The details of the substituent are described in paragraph 0023 of JP2007-234651A.

Further, the substituent W may be a group represented by Formula (W1).

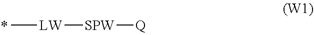

In Formula (W1), LW represents a single bond or a divalent linking group, SPW represents a divalent spacer group, Q represents a terminal group, and * represents a bonding position.

Examples of the divalent linking group represented by LW include —O—, —Si(CH₃)₂—, —(Si(CH₃)₂O)_{g}— (g represents an integer of 1 to 10), —N(Z)—, —C(Z)═C(Z¹)—, —C(Z)═N—, —C(O)—, —C(O)O—, —O—C(O)O—, —C(O)N(Z)—, —C(Z)═C(Z¹)—C(O)O—, —C(Z)═N—, —C(Z)═C(Z¹)—C(O)N(Z²)—, —C(Z)═C(Z¹)—C(O)—S—, —C(Z)═N—N═C(Z¹)— (Z, Z¹, and Z² each independently represent a hydrogen atom, an alkyl group having 1 to 4 carbon atoms, a cycloalkyl group, an aryl group, a cyano group, or a halogen atom), —C≡C—, —N═N—, —S—, —S(O)—, —S(O)(O)—, —(O)S(O)O—, —O(O)S(O)O—, and —SC(O)—. LW may be a group in which two or more of these groups are combined (hereinafter, also abbreviated as “L-C”).

Examples of the divalent spacer group represented by SPW include a linear, branched, or cyclic alkylene group having 1 to 50 carbon atoms, and a heterocyclic group having 1 to 20 carbon atoms.

The carbon atoms of the alkylene group and the heterocyclic group may be substituted with —O—, —Si(CH₃)₂—, —(Si(CH₃)₂O)_{g}— (g represents an integer of 1 to 10), —N(Z)—, —C(Z)═C(Z¹)—, —C(Z)═N—, —C(Z)₂—C(Z¹)₂—, —C(O)—, —C(O)O—, —O—C(O)O—, —C(O)N(Z)—, —C(Z)═C(Z¹)—C(O)O—, —C(Z)═N—, —C(Z)═C(Z¹)—C(O)N(Z²)—, —C(Z)═C(Z¹)—C(O)—S—, —C(Z)═N—N═C(Z¹)— (Z, Z¹, and Z² each independently represent a hydrogen atom, an alkyl group having 1 to 4 carbon atoms, a cycloalkyl group, an aryl group, a cyano group, or a halogen atom), —C≡C—, —N═N—, —S—, —C(S)—, —S(O)—, —SO₂—, —(O)S(O)O—, —O(O)S(O)O—, —SC(O)—, or a group obtained by combining two or more of these groups.

The hydrogen atom of the above alkylene group and the hydrogen atom of the heterocyclic group may be substituted with a halogen atom, a cyano group, —Z^{H1}, —OH, —OZ^{H1}, —COOH, —C(O)Z^{H1}, —C(O)OZ^{H1}, —OC(O)Z^{H1}, —OC(O)OZ^{H1}, —NZ^{H1}Z^{H2}, —NZ^{H1}C(O)Z^{H2}, —NZ^{H1}C(O)OZ^{H2}, —C(O)NZ^{H1}Z^{H2}, —OC(O)NZ^{H1}Z^{H2}, —NZ^{H1}C(O)NZ^{H2}OZ^{H3}, —SH, —SZ^{H1}, —C(S)Z^{H1}, —C(O)SZ^{H1}, or —SC(O)Z^{H1}. Here, Z^{H1}, Z^{H2}, and Z^{H3} each independently represent an alkyl group having 1 to 10 carbon atoms, a halogenated alkyl group, or -L-CL.

In -L-CL, L represents a single bond or a divalent linking group. Specific examples of the divalent linking group are the same as those for LW and SPW described above.

In -L-CL, CL represents a crosslinkable group. Specific examples of the crosslinkable group include crosslinkable groups represented by Formulae (P-1) to (P-30).

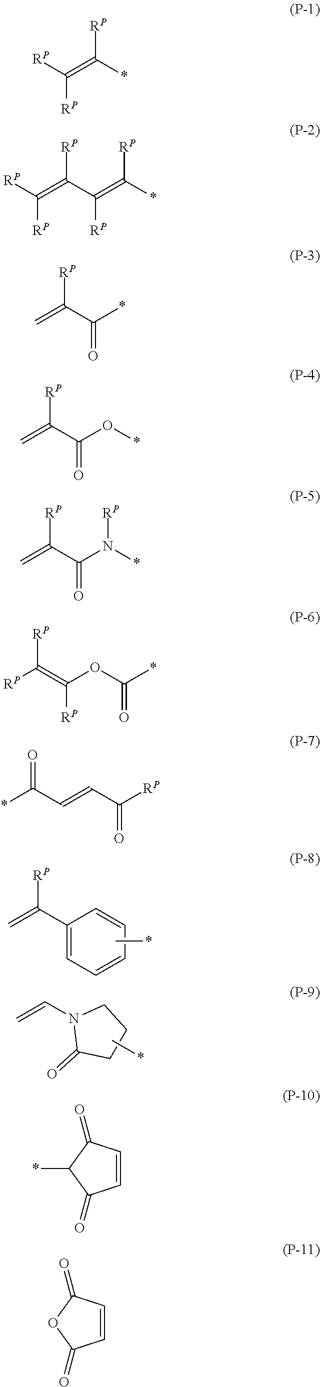

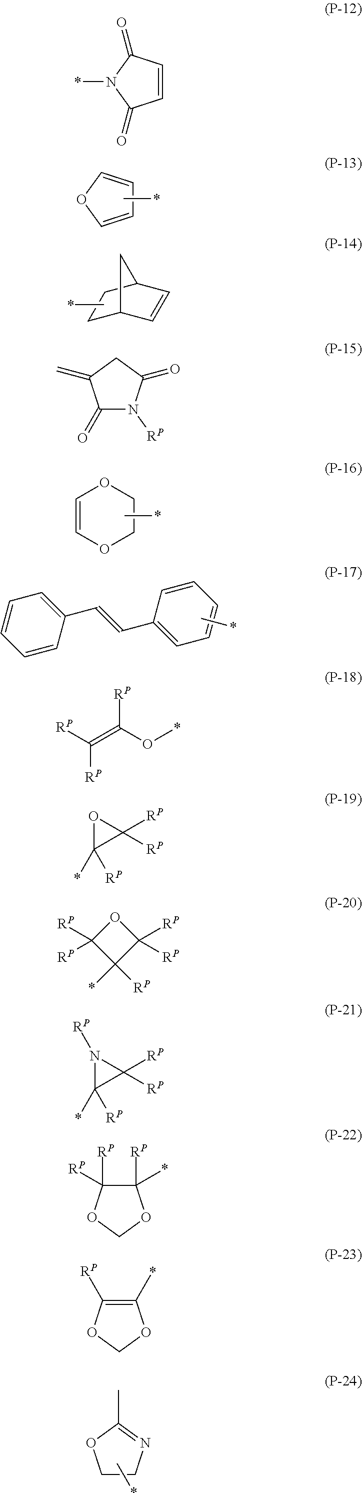

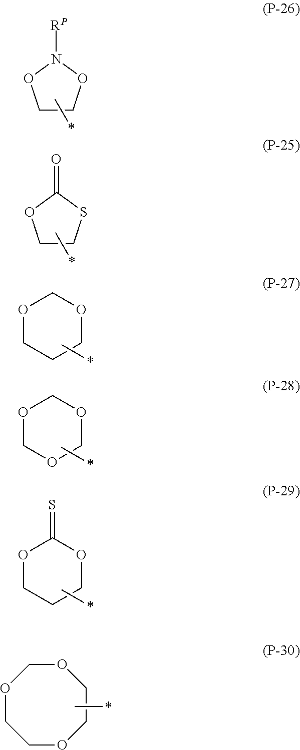

In Formulae (P-1) to (P-30), R^{P} represents a hydrogen atom, a halogen atom, a linear, branched, or cyclic alkylene group having 1 to 10 carbon atoms, a halogenated alkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group, a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), or a sulfate group (—OSO₃H), and a plurality of R^{P}'s may be the same or different from each other.

Preferred embodiments of the crosslinkable group include a radically polymerizable group and a cationically polymerizable group. As the radically polymerizable group, a vinyl group represented by Formula (P-1), a butadiene group represented by Formula (P-2), a (meth)acryl group represented by Formula (P-4), a (meth)acrylamide group represented by Formula (P-5), a vinyl acetate group represented by Formula (P-6), a fumaric acid ester group represented by Formula (P-7), a styryl group represented by Formula (P-8), a vinylpyrrolidone group represented by Formula (P-9), a maleic acid anhydride represented by Formula (P-11), or a maleimide group represented by Formula (P-12) is preferable. As the cationically polymerizable group, a vinyl ether group represented by Formula (P-18), an epoxy group represented by Formula (P-19), or an oxetanyl group represented by Formula (P-20) is preferable.

Examples of terminal groups represented by Q include a hydrogen atom, a halogen atom, a linear, branched, or cyclic alkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group (which may also be referred to as a hetero ring group), a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), a sulfate group (—OSO₃H), or a crosslinkable group represented by Formulae (P-1) to (P-30) described above.

### [Liquid Crystal Composition]

The liquid crystal composition according to the embodiment of the present invention is a liquid crystal composition including a liquid crystal compound, a dichroic substance, a polymer 1 having a repeating unit A having a structure represented by Formula (A), and a polymer 2 having a repeating unit A having a structure represented by Formula (A) and being different from the polymer 1.

In addition, in the liquid crystal composition according to the embodiment of the present invention, in a case where a content of silicon atoms contained in the polymer 1 is defined as X1 parts by mass and a content of silicon atoms contained in the polymer 2 is defined as X2 parts by mass with respect to 100 parts by mass of a total solid content mass of the liquid crystal composition, a ratio represented by X1/X2 is 1 or more.

In a case where the liquid crystal composition according to the embodiment of the present invention is used, it is possible to suppress the occurrence of surface unevenness and to form a light absorption anisotropic film having an excellent alignment degree. The details of this reason have not been clarified yet, but it is assumed to be due to the following reasons.

It is presumed that, in a case where the liquid crystal composition includes the polymer 1 and the polymer 2, these polymers act in a complementary manner to improve a function of reducing the surface tension of the liquid crystal composition, and as a result, the occurrence of surface unevenness is suppressed as compared with a case where a liquid crystal composition including only one kind of polymer having a repeating unit A having a structure represented by Formula (A) is used.

In addition, it is presumed that, in a case where the liquid crystal composition includes the polymer 1 and the polymer 2, the aggregation of the polymer is suppressed as compared with a case where a liquid crystal composition including only one kind of polymer having a repeating unit A having a structure represented by Formula (A) is used, and as a result, the aggregation of the liquid crystal compound or the dichroic substance, which causes an orientation defect, is also suppressed, and the alignment degree of the obtained light absorption anisotropic film is improved.

The liquid crystal composition according to the embodiment of the present invention may include two or more kinds of polymers having a repeating unit A having a structure represented by Formula (A), or may include three or more kinds of polymers having a repeating unit A having a structure represented by Formula (A).

In a case where three or more kinds of polymers having a repeating unit A having a structure represented by Formula (A) are included, at least two kinds of polymers among the three or more kinds of polymers may satisfy a relationship (specifically, a value of X1/X2 or the like) in the polymer 1 and the polymer 2 described later.

It is preferable that the polymer having a repeating unit A having a structure represented by Formula (A), which is contained in the liquid crystal composition according to the embodiment of the present invention, does not have a fluorine atom.

Hereinafter, each component contained in the liquid crystal composition according to the embodiment of the present invention will be described in detail.

### [Liquid Crystal Compound]

The liquid crystal composition according to the embodiment of the present invention contains a liquid crystal compound.

As the liquid crystal compound, both a polymer liquid crystal compound and a low-molecular-weight liquid crystal compound can be used, and from the viewpoint of increasing an alignment degree, a polymer liquid crystal compound is preferable. In addition, the polymer liquid crystal compound and the low-molecular-weight liquid crystal compound may be used in combination as the liquid crystal compound.

Here, the “polymer liquid crystal compound” denotes a liquid crystal compound having a repeating unit in the chemical structure.

In addition, the “low-molecular-weight liquid crystal compound” refers to a liquid crystal compound not including a repeating unit in a chemical structure.

Examples of the polymer liquid crystal compound include thermotropic liquid crystalline polymers described in JP2011-237513A and polymer liquid crystal compounds described in paragraphs 0012 to 0042 of WO2018/199096A.

Examples of the low-molecular-weight liquid crystal compound include liquid crystal compounds described in paragraphs 0072 to 0088 of JP2013-228706A, and among these, a liquid crystal compound exhibiting smectic properties is preferable.

Examples of such a liquid crystal compound include those described in paragraphs 0019 to 0140 of WO2022/014340A, the description of which is incorporated herein by reference.

From the viewpoint of being able to further increase the alignment degree, a side-chain type polymer liquid crystal compound is preferable as the polymer liquid crystal compound. The side-chain type polymer liquid crystal compound is a liquid crystal compound having a repeating unit.

Suitable examples of the side-chain type polymer liquid crystal compound include a liquid crystal compound having a repeating unit represented by Formula (1), described in paragraph 0014 of WO2018/199096A.

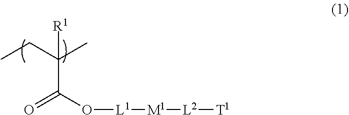

In Formula (1), R¹ represents a hydrogen atom or a methyl group, L¹ and L² each independently represent a single bond or a divalent linking group, M¹ represents a mesogenic group, and T¹ represents a terminal group.

In addition, suitable examples of the low-molecular-weight liquid crystal compound include a compound represented by Formula (2), described in paragraph 0074 of JP2013-228706A.

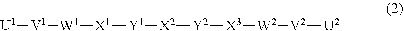

In Formula (2),
X¹, X², and X³ each independently represent a 1,4-phenylene group which may have a substituent or a cyclohexane-1,4-diyl group which may have a substituent. At least one of X¹, X², or X³ represents a 1,4-phenylene group which may have a substituent. —CH₂— constituting the cyclohexane-1,4-diyl group which may have a substituent may be substituted with —O—, —S—, or —NR—. R represents an alkyl group having 1 to 6 carbon atoms or a phenyl group.
Y¹ and Y² each independently represent —CH₂CH₂—, —CH₂O—, —COO—, —OCOO—, a single bond, —N═N—, —CR^{a}═CR^{b}—, —C≡C—, or —CR^{a}═N—. R^{a} and R^{b} each independently represent a hydrogen atom or an alkyl group having 1 to 4 carbon atoms.
U¹ represents a hydrogen atom or a polymerizable group.
U² represents a polymerizable group.
W¹ and W² each independently represent a single bond, —O—, —S—, —COO—, or —OCOO—.
V¹ and V² each independently represent an alkanediyl group having 1 to 20 carbon atoms, which may have a substituent, where —CH₂— constituting the alkanediyl group may be substituted with —O—, —S—, or —NH—.

From the viewpoint of increasing the alignment degree, the liquid crystal compound preferably has at least one group selected from the group consisting of a fluorine atom, a cyano group, a trifluoromethyl group, and a nitro group.

From the viewpoint that the effect of the present invention is more excellent, a weight-average molecular weight (Mw) of the polymer liquid crystal compound is preferably 1000 to 500,000 and more preferably 2,000 to 300,000. In a case where the Mw of the polymer liquid crystal compound is within the above range, the polymer liquid crystal compound can be easily handled.

In particular, from the viewpoint of suppressing cracking during the coating, the weight-average molecular weight (Mw) of the polymer liquid crystal compound is preferably 10000 or more and more preferably in a range of 10000 to 300000.

In addition, from the viewpoint of temperature latitude of the alignment degree, the weight-average molecular weight (Mw) of the polymer liquid crystal compound is preferably less than 100,000 and more preferably 2,000 or more and less than 100,000.

Here, the weight-average molecular weight of the polymer liquid crystal compound is a value measured by a gel permeation chromatography (GPC) method.
Solvent (eluant): N-methylpyrrolidone
Device name: TOSOH HLC-8220GPC
Column: Connect and use three of TOSOH TSKgel Super AWM-H (6 mm×15 cm)
Column temperature: 25° C.
Sample concentration: 0.1% by mass
Flow rate: 0.35 ml/min
Calibration curve: TSK standard polystyrene manufactured by TOSOH Corporation, calibration curves of 7 samples with Mw of 2,800,000 to 1,050 (Mw/Mn=1.03 to 1.06) are used

A content of the liquid crystal compound is preferably 25 to 2,000 parts by mass, more preferably 100 to 1,300 parts by mass, and still more preferably 200 to 900 parts by mass with respect to 100 parts by mass of the content of the above-described dichroic substance. In a case where the content of the liquid crystal compound is within the above-described range, the alignment degree of the dichroic substance is further improved.

### [Dichroic Substance]

The liquid crystal composition of the present invention contains a dichroic substance.

Here, the dichroic substance means a coloring agent having different absorbances depending on the direction.

In addition, the dichroic substance may or may not exhibit liquid crystallinity.

The dichroic substance is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). Further, known dichroic substances (dichroic coloring agents) of the related art can be used.

Specific examples thereof include those described in paragraphs 0067 to 0071 of JP2013-228706A, paragraphs 0008 to 0026 of JP2013-227532A, paragraphs 0008 to 0015 of JP2013-209367A, paragraphs 0045 to 0058 of JP2013-14883A, paragraphs 0012 to 0029 of JP2013-109090A, paragraphs 0009 to 0017 of JP2013-101328A, paragraphs 0051 to 0065 of JP2013-37353A, paragraphs 0049 to 0073 of JP2012-63387A, paragraphs 0016 to 0018 of JP1999-305036A (JP-H11-305036A), paragraphs 0009 to 0011 of JP2001-133630A, paragraphs 0030 to 0169 of JP2011-215337A, paragraphs 0021 to 0075 of JP2010-106242A, paragraphs 0011 to 0025 of JP2010-215846A, paragraphs 0017 to 0069 of JP2011-048311A, paragraphs 0013 to 0133 of JP2011-213610A, paragraphs 0074 to 0246 of JP2011-237513A, paragraphs 0005 to 0051 of JP2016-006502A, paragraphs 0014 to 0032 of JP2018-053167A, paragraphs 0014 to 0033 of JP2020-11716A, paragraphs 0005 to 0041 of WO2016/060173A, paragraphs 0008 to 0062 of WO2016/136561A, paragraphs 0014 to 0033 of WO2017/154835A, paragraphs 0014 to 0033 of WO2017/154695A, paragraphs 0013 to 0037 of WO2017/195833A, paragraphs 0014 to 0034 of WO2018/164252A, paragraphs 0021 to 0030 of WO2018/186503A, paragraphs 0043 to 0063 of WO2019/189345A, paragraphs 0043 to 0085 of WO2019/225468A, paragraphs 0050 to 0074 of WO2020/004106A, and paragraphs 0015 to 0038 of WO2021/044843 A.

As the dichroic substance, a dichroic azo coloring agent compound is preferable.

The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, any of nematic properties or smectic properties may be exhibited. A temperature range at which the liquid crystallinity is exhibited is preferably room temperature (about 20° C. to 28° C.) to 300° C., and from the viewpoint of handleability and manufacturing suitability, more preferably 50° C. to 200° C.

In the present invention, from the viewpoint of tint adjustment, it is preferable to use at least one coloring agent compound (first dichroic azo coloring agent compound) having a maximal absorption wavelength in a wavelength range of 560 to 700 nm and at least one coloring agent compound (second dichroic azo coloring agent compound) having a maximal absorption wavelength in a wavelength range of 455 nm or more and less than 560 nm.

In the present invention, three or more dichroic azo coloring agent compounds may be used in combination. For example, from the viewpoint of making the light absorption anisotropic film close to black, it is preferable to use the first dichroic azo coloring agent compound, the second dichroic azo coloring agent compound, and at least one coloring agent compound (third dichroic azo coloring agent compound) having a maximal absorption wavelength in a wavelength range of 380 nm or more and less than 455 nm in combination.

In the present invention, from the viewpoint of excellent light fastness of the light absorption anisotropic film, it is preferable to contain two or more kinds of the first dichroic azo coloring agent compounds.

In the present invention, the dichroic azo coloring agent compound preferably has a crosslinkable group.

Examples of the crosslinkable group include a (meth)acryloyl group, an epoxy group, an oxetanyl group, and a styryl group. Among these, a (meth)acryloyl group is preferable.

From the viewpoint of further increasing the alignment degree of the light absorption anisotropic film to be formed, a content of the dichroic substance is preferably 3 to 90 parts by mass, more preferably 5 to 70 parts by mass, and still more preferably 10 to 60 parts by mass with respect to the total solid content mass (100 parts by mass) of the liquid crystal composition. In a case where a plurality of dichroic substances are used in combination, it is preferable that the total amount of the plurality of dichroic substances is in the above-described range.

Here, in the present specification, the “total solid content in the liquid crystal composition” refers to components excluding a solvent, and specific examples of the solid content include a liquid crystal compound, a dichroic substance, a polymer 1, a polymer 2, a polymerization initiator, and a vertical alignment agent.

### [Polymer 1]

The liquid crystal composition according to the embodiment of the present invention contains a polymer 1. The polymer 1 is a polymer having a repeating unit A including a structure represented by Formula (A).

It is preferable that the polymer 1 does not substantially have a fluorine atom. The fact that the polymer 1 does not substantially have a fluorine atom means that the total content of fluorine atoms contained in the polymer 1 is 5 parts by mass or less in 100 parts by mass of the polymer 1. The total content of fluorine atoms contained in the polymer 1 is more preferably 3 parts by mass or less and still more preferably 0 parts by mass.

From the viewpoint of easily obtaining a light absorption anisotropic film exhibiting horizontal alignment (an angle θ formed by a transmittance central axis of the light absorption anisotropic film and a normal direction of a surface of the light absorption anisotropic film is more than 45° and 90° or less) and the viewpoint of further improving the effect of the present invention, the polymer 1 is preferably a polymer (a copolymer) including the repeating unit A (preferably, the repeating unit A-1) and at least one of the repeating unit B or the repeating unit D, and more preferably a polymer (a copolymer) including the repeating unit A (preferably, the repeating unit A-1), the repeating unit B, and the repeating unit D.

On the other hand, from the viewpoint of easily obtaining a light absorption anisotropic film exhibiting vertical alignment (an angle θ formed by a transmittance central axis of the light absorption anisotropic film and a normal direction of a surface of the light absorption anisotropic film is 0° or more and 45° or less) and the viewpoint of further improving the effect of the present invention, the polymer 1 is also preferably a polymer (a copolymer) including the repeating unit A (preferably, the repeating unit A-1) and a repeating unit E satisfying Condition 1 or Condition 2 described later, and may further include a repeating unit F.

### <Repeating Unit A>

The repeating unit A is a repeating unit including a structure represented by Formula (A).

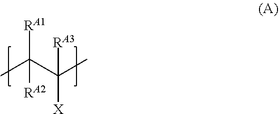

In Formula (A), R^{A1} and R^{A2} each independently represent a hydrogen atom or an alkyl group.

Examples of the alkyl group in R^{A1} and R^{A2} include a linear alkyl group having 1 to 18 carbon atoms (preferably having 1 to 6 carbon atoms and more preferably having 1 to 4 carbon atoms), and a branched or cyclic alkyl group having 3 to 18 carbon atoms (preferably having 3 to 9 carbon atoms and more preferably having 3 to 6 carbon atoms). Specific examples thereof include a methyl group, an ethyl group, a propyl group, a butyl group, an isopropyl group, a tert-butyl group, and a cyclohexyl group.

It is preferable that both R^{A1} and R^{A2} are hydrogen atoms.

In Formula (A), R^{A3} represents a hydrogen atom, a halogen atom, or a substituent.

Examples of the substituent in R^{A3} include an alkyl group, an alkenyl group, an aryl group, and a substituent having a linking group and having a structure of Formula (a) described later at a terminal.

Specific examples of the substituent having a linking group and having a structure of Formula (a) described later at a terminal include —CH₂—CO-L^{A1}-L^{A2}-(Si(R^{a1})(R^{a2})(R^{a3}))ₘ. The definition of -L^{A1}-L^{A2}-(Si(R^{a1})(R^{a2})(R^{a3}))ₘ is the same as the definition of -L^{A1}-L^{A2}-(Si(R^{a1})(R^{a2})(R^{a3}))ₘ in Formula (A-1) described later, and suitable aspects thereof are also the same.

The substituent in R^{A3} is preferably an alkyl group, more preferably a linear alkyl group having 1 to 4 carbon atoms, and still more preferably a methyl group or an ethyl group.

It is preferable that R^{A3} is a hydrogen atom or a methyl group.

In Formula (A), X represents a substituent (hereinafter, also referred to as a “substituent X”) having one or more structures represented by Formula (a) (hereinafter, also referred to as a “group a”).

As the substituent X, a monovalent hydrocarbon group having one or more groups a is preferable. The monovalent hydrocarbon group as the substituent X may be linear, branched, or cyclic, and is preferably linear or branched.

Examples of the monovalent hydrocarbon group in the substituent X include a monovalent aliphatic hydrocarbon group and a monovalent aromatic hydrocarbon group. The monovalent hydrocarbon group is preferably a monovalent aliphatic hydrocarbon group, and more preferably an alkyl group. The alkyl group may be linear, branched, or cyclic, and is preferably linear or branched. The number of carbon atoms in the alkyl group is preferably 1 to 30, more preferably 2 to 25, and still more preferably 2 to 20.

Here, one or more of —CH₂—'s constituting a part of the monovalent hydrocarbon group in the substituent X may be each independently substituted with a divalent group such as —O—, —CO—, —C(O)—O—, —C(O)—N(R^{X10})—, —[O—Si(R^{X11})₂]ₙₓ—, and —Si(R^{X12})₂—; and it is preferable that these —CH₂—'s are substituted with these divalent groups.
R^{X10} represents a hydrogen atom or an alkyl group having 1 to 6 carbon atoms, and is preferably a hydrogen atom. The alkyl group may be linear, branched, or cyclic, and is preferably linear or branched.
R^{X11} and R^{X12} each independently represent a hydrogen atom, a hydroxy group, the group a (that is, the group represented by Formula (a) described later), or an alkyl group having 1 to 6 carbon atoms; and an alkyl group having 1 to 6 carbon atoms or the group a is preferable. The alkyl group may be linear, branched, or cyclic, and is preferably linear or branched. Two R^{X11}'s may be the same or different from each other. Two R^{X12}'s may be the same or different from each other.
nx is a number of 1 or more, preferably a number of 1 to 100 and more preferably a number of 1 to 11. In a case where nx is a number of 2 or more, a plurality of [O—Si(R^{X11})₂]'s may be the same as or different from each other.

Examples of one suitable aspect of the substituent X include a group represented by Formula (X¹).

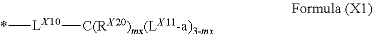

In Formula (X¹), * represents a bonding position.

In Formula (X¹), L^{X10} and L^{X11} each independently represent a divalent hydrocarbon group. Provided that, one or more of —CH₂—'s constituting a part of the divalent hydrocarbon group may be each independently substituted with a divalent group such as —O—, —CO—, —C(O)—O—, —C(O)—N(R^{X10})—, —[O—Si(R^{X11})₂]ₙₓ—, and —Si(R^{X12})₂—. The definitions of R^{X10}, R^{X11}, R^{X12}, and nx are as described above. Two R^{X11}'s may be the same or different from each other. Two R^{X12}'s may be the same or different from each other. In a case where nx is a number of 2 or more, a plurality of [O—Si(R^{X11})₂]'s may be the same or different from each other.

Examples of the divalent hydrocarbon group in L^{X10} and L^{X11} include a divalent aliphatic hydrocarbon group and a divalent aromatic hydrocarbon group. The divalent hydrocarbon group is preferably a divalent aliphatic hydrocarbon group, and more preferably an alkylene group. The alkylene group may be linear, branched, or cyclic, but is preferably linear or branched and more preferably linear. The number of carbon atoms in the alkylene group is preferably 1 to 30, more preferably 2 to 25, and still more preferably 2 to 20.

In Formula (X¹), R^{X20} represents a hydrogen atom or a monovalent hydrocarbon group. The definition of the monovalent hydrocarbon group in R^{X20} is the same as the monovalent hydrocarbon group described in the substituent X above.

In Formula (X¹), a represents the structure (group) represented by Formula (a) described later.

In Formula (X¹), mx represents an integer of 0 to 2. In a case where mx is an integer of 0 or 1, a plurality of (L^{X11}-a)'s may be the same as or different from each other. In a case where mx is 2, two R^{X20}'s may be the same as or different from each other.

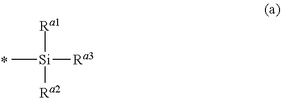

In Formula (a), * represents a bonding position.

In addition, R^{a1}, R^{a2}, and R^{a3} each independently represent an alkyl group, an alkenyl group, an aryl group, or an alkylene-aryl group, which may have a substituent. Specific examples of the substituent include the above-described substituent W; and among the above, a halogen atom, an alkyl group, an alkylcarbonyl group, an alkoxycarbonyl group, an alkylcarbonyloxy group, or an alkoxy group is preferable.

Examples of the alkyl group include a linear alkyl group having 1 to 18 carbon atoms, and a branched or cyclic alkyl group having 3 to 18 carbon atoms. Specific examples thereof include a methyl group, an ethyl group, a propyl group, a butyl group, an isopropyl group, a tert-butyl group, and a cyclohexyl group.

Examples of the alkenyl group include an alkenyl group having 2 to 12 carbon atoms. Specific examples thereof include a vinyl group, a 1-propenyl group, a 1-butenyl group, a 1-methyl-1-propenyl group, a 1-cyclopentenyl group, and a 1-cyclohexenyl group.

Examples of the aryl group include an aryl group having 6 to 12 carbon atoms. Specific examples thereof include a phenyl group, an α-methylphenyl group, and a naphthyl group.

Examples of the alkylene-aryl group include an alkylene-aryl group having 7 to 30 carbon atoms.

The number of groups a included in the substituent X is 1 or more; and from the viewpoint of further improving the alignment degree of the light absorption anisotropic film, it is preferably 2 or more, and more preferably 3 or more, and from the viewpoint of further suppressing alignment defects, it is preferably 18 or less, more preferably 12 or less, still more preferably 9 or less, and particularly preferably 6 or less.

From the viewpoint that the effect of the present invention is more excellent and the viewpoint that the alignment degree of the light absorption anisotropic film is more excellent, the repeating unit A is preferably a repeating unit A-1 represented by Formula (A-1).

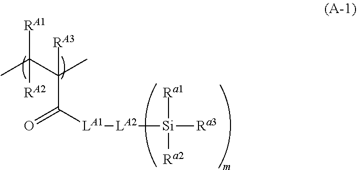

In Formula (A-1), R^{A1}, R^{A2}, and R^{A3} are the same as those described in Formula (A) above, and R^{a1}, R^{a2}, and R^{a3} are the same as those described in Formula (a) above.

In a case where m in Formula (A-1) is an integer of 2 or more, a plurality of R^{a1}'s may be the same or different from each other, a plurality of R^{a2}'s may be the same or different from each other, and a plurality of R^{a3}'s may be the same or different from each other.

In Formula (A-1), L^{A1} represents a single bond, —O—, or —NR^{Z}—. Provided that, RZ represents a hydrogen atom or a substituent.

Regarding —NR^{Z}— in L^{A1}, the substituent in RZ is preferably an alkyl group, more preferably a linear alkyl group having 1 to 4 carbon atoms, and still more preferably a methyl group or an ethyl group.

As L^{A1}, —O— or —NH— is preferable, and —O— is more preferable.

In Formula (A-1), L^{A2} represents a single bond or an m+1-valent linking group.

Suitable examples of the (m+1)-valent linking group in L^{A2} include an (m+1)-valent hydrocarbon group having 1 to 10 carbon atoms, which may have a substituent, in which a part of carbon atoms constituting the hydrocarbon group may be substituted with a heteroatom.

Here, as the substituent which may be included in the hydrocarbon group, an alkyl group is preferable, a linear alkyl group having 1 to 4 carbon atoms is more preferable, and a methyl group or an ethyl group is still more preferable.

In addition, examples of the heteroatom include a silicon atom, an oxygen atom, and a nitrogen atom.

In Formula (A-1), m represents an integer of 1 or more, and from the viewpoint that the alignment degree of the light absorption anisotropic film is more excellent, m is preferably an integer of 2 or more and more preferably an integer of 3 or more, and from the viewpoint that the alignment defects can be further suppressed, m is preferably an integer of 18 or less, more preferably an integer of 12 or less, still more preferably an integer of 9 or less, and particularly preferably an integer of 6 or less.

Specific examples of the repeating unit A include repeating units corresponding to the monomers represented by Formulae K-1 to K-38. In Examples which will be described later, the monomer represented by Formula K-1 is referred to as a “Monomer K-1”. The same applies to other monomers.

The monomer represented by Formula K-29 is a mixture of monomers having different numbers of —(O—Si(CH₃)₂)—, and thus the average value thereof is represented as n≈11. In addition, the same applies to monomers having the same notation.

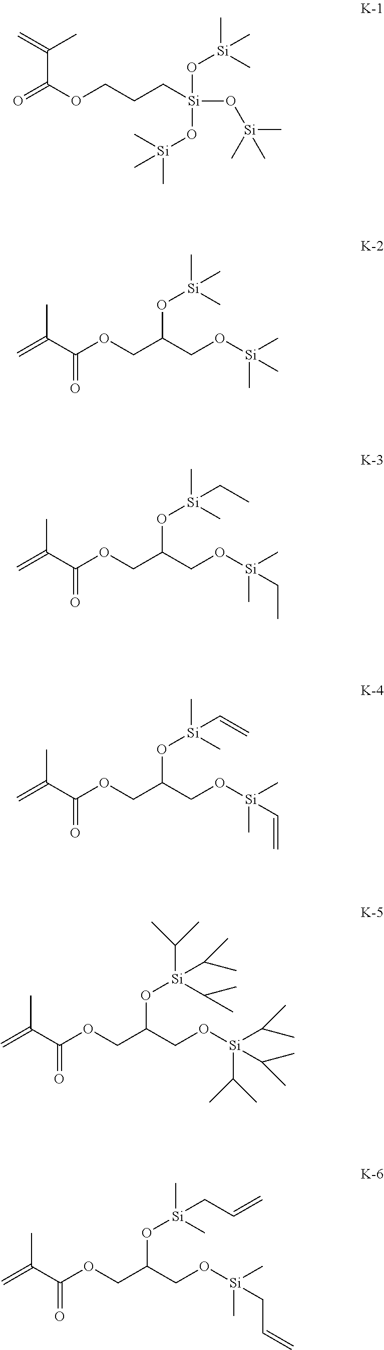

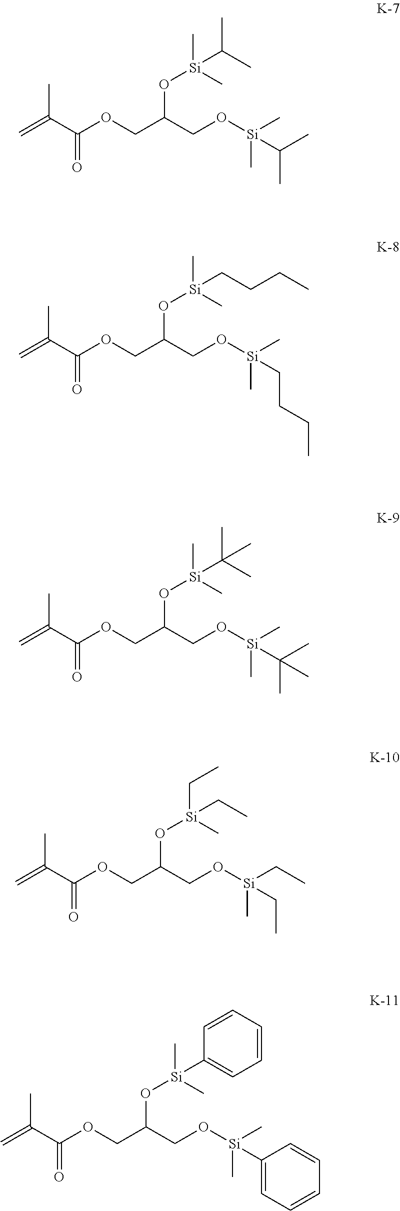

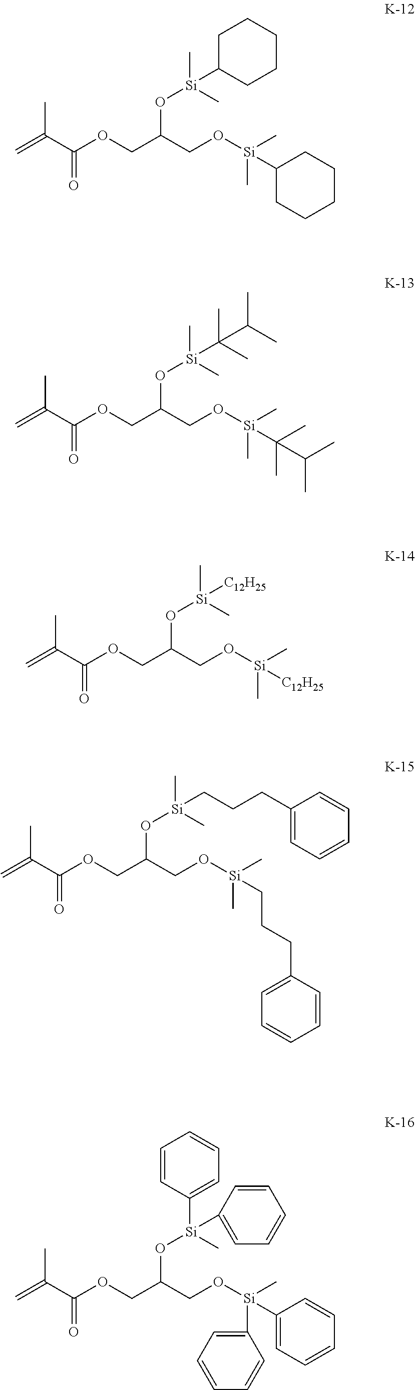

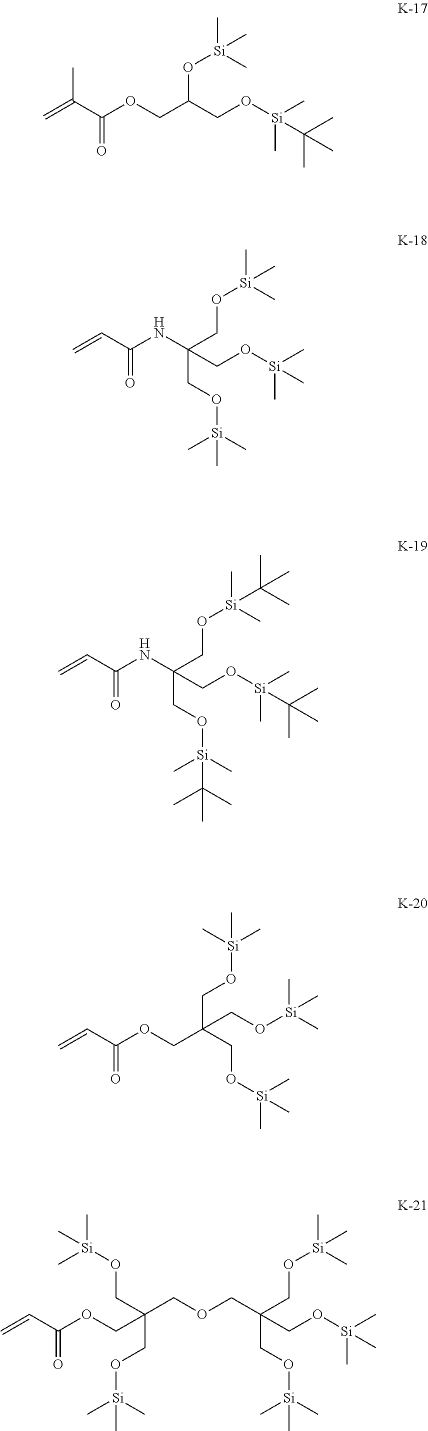

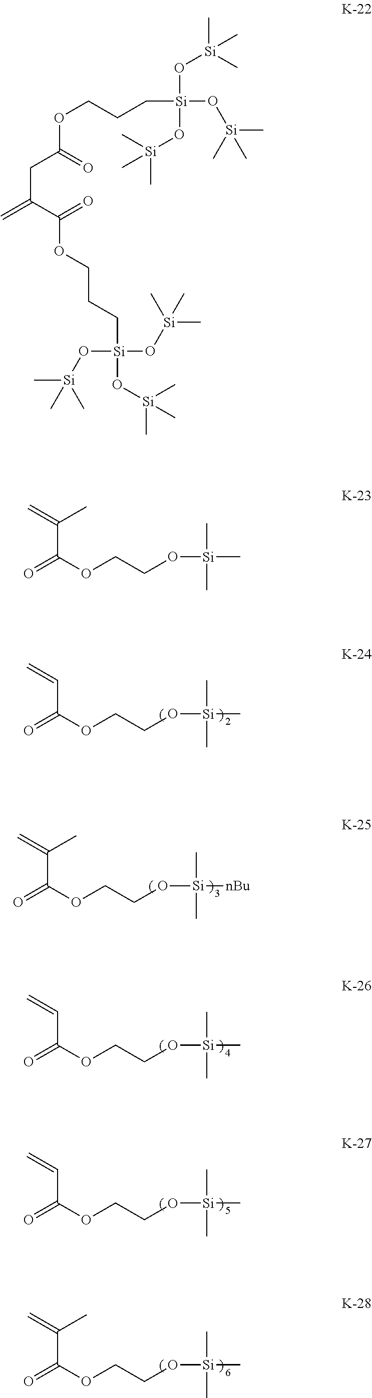

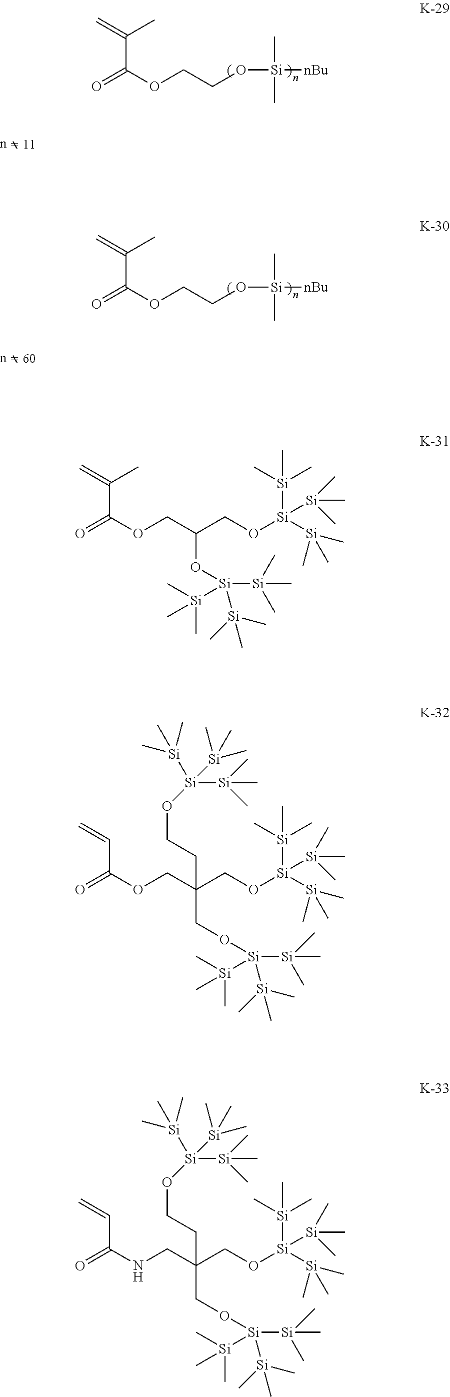

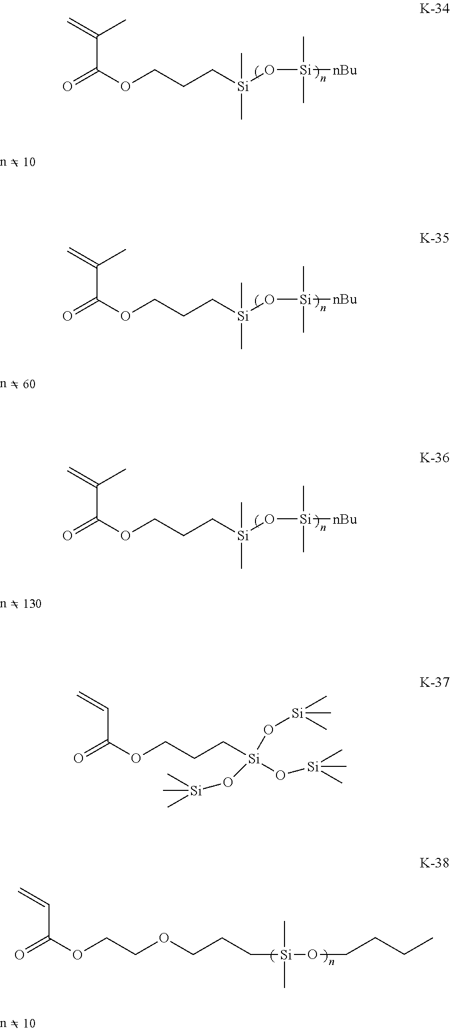

In a case where the purpose is to obtain a light absorption anisotropic film exhibiting horizontal alignment using the liquid crystal composition according to the embodiment of the present invention, a content A1 of the repeating unit A with respect to all repeating units (100% by mass) contained in the polymer 1 is preferably 10.0% to 90.0% by mass, more preferably 10.0% to 80.0% by mass, and still more preferably 30.0% to 75.0% by mass. In a case where the content of the repeating unit A is within the above-described range, the effect of the present invention is more excellent.

In a case where the purpose is to obtain a light absorption anisotropic film exhibiting vertical alignment using the liquid crystal composition according to the embodiment of the present invention, a content A1 of the repeating unit A with respect to all repeating units (100% by mass) contained in the polymer 1 is preferably 10.0% to 90.0% by mass, more preferably 20.0% to 90.0% by mass, and still more preferably 30.0% to 90.0% by mass. In a case where the content of the repeating unit A is within the above-described range, the effect of the present invention is more excellent.

The polymer 1 may contain only one kind of the repeating unit A, or may contain two or more kinds thereof. In a case where two or more kinds of the repeating units A are contained, the content of the repeating unit A means the total content of the repeating units A.

### <Repeating Unit B>

The repeating unit B is a repeating unit represented by Formula (B).

It is considered that the repeating unit B having an amide structure can improve the compatibility between the copolymer and the liquid crystal compound. As a result, it is presumed that a light absorption anisotropic film having a smaller number of alignment defects is obtained.

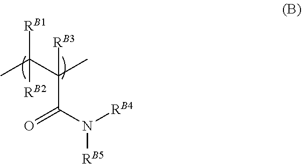

In Formula (B), R^{B1}, R^{B2}, and R^{B3} each independently represent a hydrogen atom, a halogen atom, a cyano group, an alkyl group, an alkenyl group, or an aryl group.

Examples of the alkyl group in R^{B1}, R^{B2}, and R^{B3} include a linear alkyl group having 1 to 18 carbon atoms (preferably having 1 to 6 carbon atoms and more preferably having 1 to 4 carbon atoms), and a branched or cyclic alkyl group having 3 to 18 carbon atoms (preferably having 3 to 9 carbon atoms and more preferably having 3 to 6 carbon atoms). Specific examples thereof include a methyl group, an ethyl group, a propyl group, a butyl group, an isopropyl group, a tert-butyl group, and a cyclohexyl group.

Examples of the alkenyl group as R^{B1}, R^{B2}, and R^{B3} include a linear alkenyl group having 2 to 18 carbon atoms and a branched alkenyl group having 3 to 18 carbon atoms. Specific examples thereof include a vinyl group, an aryl group, a 2-butenyl group, and a 3-pentenyl group.

Examples of the aryl group as R^{B1}, R^{B2}, and R^{B3} include an aryl group having 6 to 30 carbon atoms (preferably 6 to 20 carbon atoms and more preferably 6 to 12 carbon atoms). Specific examples thereof include a phenyl group, a 2,6-diethylphenyl group, a 3,5-ditrifluoromethylphenyl group, a styryl group, a naphthyl group, and a biphenyl group.

R^{B1}, R^{B2}, and R^{B3} are preferably a hydrogen atom or an alkyl group, more preferably a hydrogen atom or a methyl group, and still more preferably a hydrogen atom.

In Formula (B), R^{B4} and R^{B5} each independently represent a hydrogen atom or a substituent. In a case where R^{B4} and R^{B5} represent a substituent, R^{B4} and R^{B5} may be linked to each other to form a ring.

The total molecular weight of R^{B4} and R^{B5} is preferably 200 or less, more preferably 100 or less, and still more preferably 70 or less. The detailed reason for this is not clear but is presumed to be as follows. That is, it is considered that, in a case where the total of the molecular weights is 100 or less, the steric hindrance of the substituent is eliminated, the specific copolymer does not inhibit the alignment of the liquid crystal compound and the dichroic substance, and as a result, the order parameter of the liquid crystal is increased, and the alignment degree of the light absorption anisotropic film is more excellent.

The lower limit of the total molecular weight of R^{B4} and R^{B5} is preferably 2 or more.

From the viewpoint that the effects of the present invention are more excellent, as the substituent represented by R^{B4} and R^{B5}, an organic group is preferable, an organic group having 1 to 15 carbon atoms is more preferable, an organic group having 1 to 12 carbon atoms is still more preferable, and an organic group having 1 to 8 carbon atoms is particularly preferable.

Examples of the above-described organic group include a linear, branched, or cyclic alkyl group, an aromatic hydrocarbon group, and a heterocyclic group.

The number of carbon atoms of the alkyl group is preferably in a range of 1 to 15, more preferably in a range of 1 to 12, and still more preferably in a range of 1 to 8.

The carbon atom in the alkyl group may be substituted with —O—, —Si(CH₃)₂—, —(Si(CH₃)₂O)_{g}—, —(OSi(CH₃)₂)_{g}— (g represents an integer of 1 to 10), —N(Z)—, —C(Z)═C(Z¹)—, —C(Z)═N—, —N═C(Z)—, —C(O)—, —OC(O)—, —C(O)O—, —O—C(O)O—, —N(Z) C(O)—, —C(O)N(Z)—, —C(Z)═C(Z¹)—C(O)O—, —O—C(O)—C(Z)═C(Z¹)—, —C(Z)═N—, —N═C(Z)—, —C(Z)═C(Z¹)—C(O)N(Z²)—, —N(Z²)—C(O)—C(Z)═C(Z¹)—, —C(Z)═C(Z¹)—C(O)—S—, —S—C(O)—C(Z)—C(Z¹)—, —C(Z)═N—N═C(Z¹)—(Z, Z¹, and Z² each independently represent a hydrogen atom, an alkyl group having 1 to 4 carbon atoms, a cycloalkyl group, an aryl group, a cyano group, or a halogen atom), —C≡C—, —N═N—, —S—, —C(S)—, —S(O)—, —SO₂—, —(O)S(O)O—, —O(O)S(O)O—, —SC(O)—, —C(O)S—, and a group obtained by combining two or more of these groups. Among the groups which may be substituted with the carbon atoms of the alkyl group, from the viewpoint that the effects of the present invention are more excellent, —O—, —C(O)—, —N(Z)—, —OC(O)—, or —C(O)O— is preferable.

The hydrogen atom in the alkyl group may be substituted with a halogen atom, a cyano group, an aryl group, a nitro group, —OZ^{H1}, —C(O)Z^{H1}, —C(O)OZ^{H1}, —OC(O)Z^{H1}, —OC(O)OZ^{H1}, —NZ^{H1}Z^{H2}, —NZ^{H1}C(O)Z^{H2}, —NZ^{H1}C(O)OZ^{H2}, —C(O)NZ^{H1}Z^{H2}, —OC(O)NZ^{H1}Z^{H2}, —NZ^{H1}C(O)NZ^{H2}OZ^{H3}, —SZ^{H1}, —C(S)Z^{H1}, —C(O)SZ^{H1}, or —SC(O)Z^{H1}. Z^{H1}, Z^{H2}, and Z^{H3} each independently represent a hydrogen atom, a halogen atom, an alkyl group having 1 to 10 carbon atoms, a cyano group, or a nitro group. Among the groups which may be substituted with the hydrogen atoms of the alkyl group, from the viewpoint that the effects of the present invention are more excellent, —OH, —COOH, or an aryl group (preferably a phenyl group) is preferable.

The hydrogen atom in the aromatic hydrocarbon group and the hydrogen atom in the heterocyclic group may be substituted with a halogen atom, a cyano group, an alkyl group having 1 to 10 carbon atoms, a nitro group, —OZ^{H1}, —C(O)Z^{H1}, C(O)OZ^{H1}, —OC(O)Z^{H1}, —OC(O)OZ^{H1}, —NZ^{H1}Z^{H2}, —NZ^{H1}C(O)Z^{H2}, —NZ^{H1}C(O)OZ^{H2}, —C(O)NZ^{H1}Z^{H2}, —OC(O)NZ^{H1}Z^{H2}, —NZ^{H1}C(O)NZ^{H2}OZ^{H3}, —SZ^{H1}, —C(S)Z^{H1}, —C(O)SZ^{H1}, —SC(O)Z^{H1}, or —B(OH)₂. Z^{H1}, Z^{H2}, and Z^{H3} each independently represent a hydrogen atom, a halogen atom, an alkyl group having 1 to 10 carbon atoms, a cyano group, or a nitro group. Among the groups that the hydrogen atom of the aromatic hydrocarbon group and the hydrogen atom of the heterocyclic group may be substituted with, —OH and —B(OH)₂ are preferable from the viewpoint that the effects of the present invention are more excellent.

From the viewpoint that the effect of the present invention is more excellent, it is preferable that R^{B4} and R^{B5} each independently represent a hydrogen atom or an organic group having 1 to 15 carbon atoms. Suitable aspects of the organic group are as described above.

From the viewpoint that the effect of the present invention is more excellent, at least one of R^{B4} or R^{B5} is preferably a substituent and more preferably an organic group having 1 to 15 carbon atoms.

The ring formed by R^{B4} and R^{B5} being linked to each other is a heterocyclic ring having a nitrogen atom in Formula (B), and may further have heteroatoms such as an oxygen atom, a sulfur atom, and a nitrogen atom in the ring.

From the viewpoint that the effect of the present invention is more excellent, the ring formed by linking R^{B4} and R^{B5} linked to each other is preferably a 4- to 8-membered ring, more preferably a 5- to 7-membered ring, and still more preferably a 5- or 6-membered ring.

From the viewpoint that the effects of the present invention are more excellent, the number of carbon atoms constituting the ring formed by R^{B4} and R^{B5} being linked to each other is preferably in a range of 3 to 7 and more preferably in a range of 3 to 6.

The ring formed by linking R^{B4} and R^{B5} to each other may or may not have aromaticity, but it is preferable that the ring does not have aromaticity from the viewpoint that the effect of the present invention is more excellent.

Specific examples of the ring formed by R^{B4} and R^{B5} being linked to each other include the following groups.

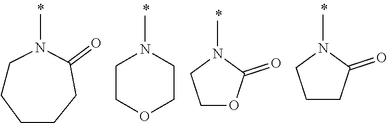

Specific examples of the repeating unit B are shown below, but the repeating unit B is not limited to the following structures.

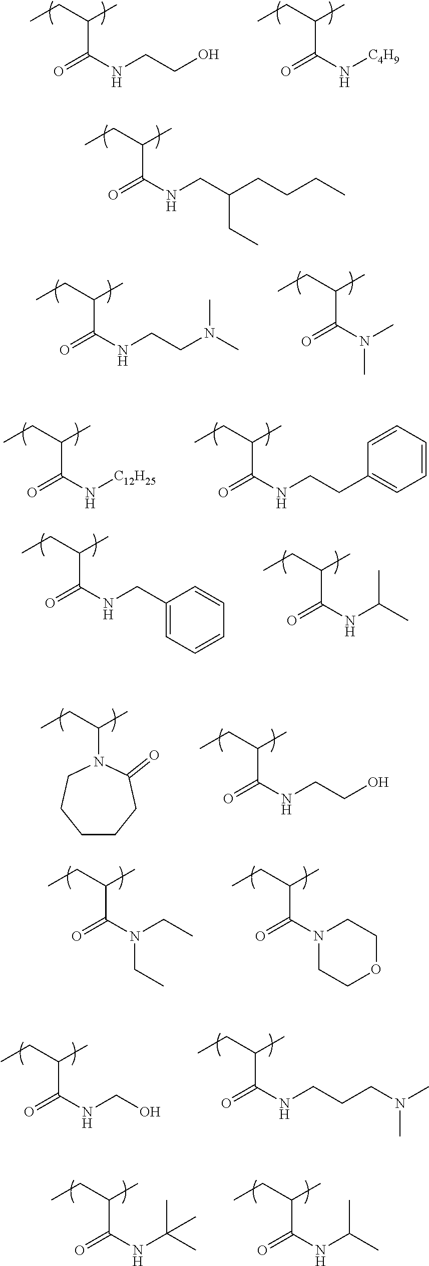

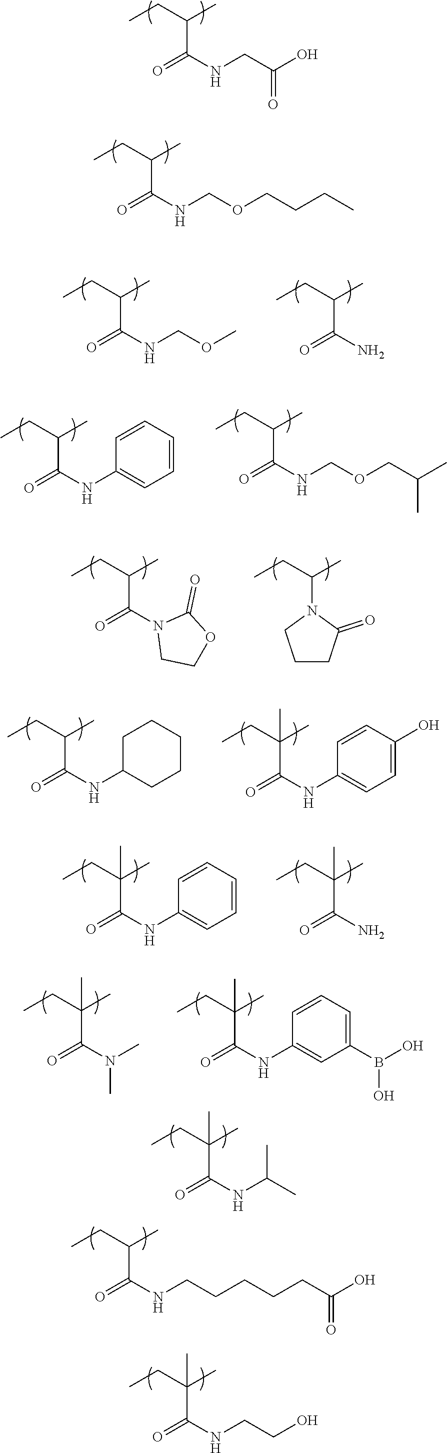

In a case where the polymer 1 has the repeating unit B, the content of the repeating unit B is preferably 2% to 75% by mass, more preferably 3% to 70% by mass, and still more preferably 5% to 65% by mass with respect to all repeating units (100% by mass) of the polymer 1. In a case where the content of the repeating unit B is within the above-described range, the effect of the present invention is more excellent.

In the polymer 1, the repeating unit B may be contained alone or in combination of two or more kinds thereof. In a case where two or more kinds of the repeating units B are contained, the content of the repeating unit B means the total content of the repeating units B.

### <Repeating Unit D>

The repeating unit D is a repeating unit represented by Formula (D).

The repeating unit D has a predetermined spacer group (Sp^{D1} in Formula (D) described later) and a linking group (Cy^{D} in Formula (D) described later) consisting of a predetermined ring structure. As a result, it is considered that the viscosity of the liquid crystal composition is improved and cissing is further suppressed.

In addition, since the repeating unit D has a predetermined hydrogen bonding group (D in Formula (D) described later), a multimer is formed by hydrogen bonding, and an air interface layer having high planarity suitable for aligning the liquid crystal compound and the dichroic substance is formed. Therefore, it is considered that the alignment degree of the formed light absorption anisotropic film is further improved.

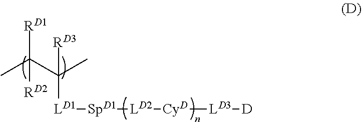

In Formular (D), R^{D1}, R^{D2}, and R^{D3} each independently represent a hydrogen atom, an alkyl group, an alkenyl group, or an aryl group.

Specific examples and suitable aspects of the alkyl group, the alkenyl group, and the aryl group in R^{D1}, R^{D2}, and R^{D3} are the same as those of the alkyl group, the alkenyl group, and the aryl group in R^{B1}, R^{B2}, and R^{B3} in Formula (B).

R^{D1}, R^{D2}, and R^{D3} are preferably a hydrogen atom or an alkyl group, more preferably a hydrogen atom or a methyl group, and still more preferably a hydrogen atom.

In Formula (D), L^{D1} represents a single bond, —COO—, or —CO—, and —CO— is preferable.

In Formula (D), Sp^{D1} represents a divalent aliphatic hydrocarbon group having 1 to 20 carbon atoms. The divalent hydrocarbon group may be linear or branched.

Examples of the divalent hydrocarbon group having 1 to 20 carbon atoms in Sp^{D1} include a divalent aliphatic hydrocarbon group having 1 to 20 carbon atoms, a divalent alicyclic hydrocarbon group having 3 to 20 carbon atoms, a divalent aromatic hydrocarbon group having 6 to 20 carbon atoms, and a divalent aromatic heterocyclic group having 6 to 20 carbon atoms. Among these, a divalent aliphatic hydrocarbon group having 1 to 20 carbon atoms is preferable.

Here, as the divalent aliphatic hydrocarbon group having 1 to 20 carbon atoms, an alkylene group having 1 to 15 carbon atoms is preferable, and an alkylene group having 1 to 8 carbon atoms is more preferable, and specific suitable examples thereof include a methylene group, an ethylene group, a propylene group, a butylene group, a pentylene group, a hexylene group, a methylhexylene group, and a heptylene group.

In addition, among —CH₂— groups constituting a part of the hydrocarbon group in Sp^{D1}, one —CH₂— or two or more —CH₂—'s which are not adjacent to each other may each independently be substituted with —O—, —S—, —NH—, or —N(Q)-. Q represents a substituent, examples thereof include the above-described substituent W, and among these, an alkyl group, an alkoxy group, or a halogen atom is preferable.

In Formula (D), L^{D2} and L^{D3} each independently represent a single bond or a divalent linking group.

Examples of the divalent linking group as L^{D2} and L^{D3} include —C(O)O—, —O—, —S—, —C(O)NR^{L1}—, —SO₂—, and —NR^{L1}R^{L2}—. In the formulae, R^{L1} and R^{L2} each independently represent a hydrogen atom or an alkyl group having 1 to 6 carbon atoms which may have a substituent. Examples of the substituent which may be included in the alkyl group having 1 to 6 carbon atoms include the above-described substituent W, and an alkyl group, an alkoxy group, or a halogen atom is preferable.

In Formula (D), Cy^{D} represents a divalent linking group having a mesogen group.

It is noted that the mesogenic group is a group indicating the main skeleton of liquid crystal molecules contributing to the formation of the liquid crystal. A liquid crystal molecule exhibits liquid crystallinity which is in an intermediate state (mesophase) between a crystal state and an isotropic liquid state. The mesogen group is not particularly limited, and for example, particularly description on pages 7 to 16 of “Flussige Kristalle in Tabellen II” (VEB Deutsche Verlag fur Grundstoff Industrie, Leipzig, 1984) and particularly the description in Chapter 3 of “Liquid Crystal Handbook” (Maruzen, 2000) edited by Liquid Crystal Handbook Editing Committee can be referred to.

The mesogen group preferably has 1 to 10 cyclic structures and more preferably has 1 to 7 cyclic structures. Specific examples of the cyclic structure include an aromatic hydrocarbon group, a heterocyclic group, and an alicyclic group.

The divalent linking group having a mesogen group in Cy^{D} is preferably a divalent mesogen group. Examples of the divalent mesogen group include a divalent aromatic hydrocarbon group, a divalent heterocyclic group, and a divalent alicyclic group.

Specific examples of the divalent aromatic hydrocarbon group include a phenylene group, a naphthylene group, a fluorene-diyl group, an anthracene-diyl group, and a tetracene-diyl group.

The divalent heterocyclic group may be any of aromatic or non-aromatic, but a divalent aromatic heterocyclic group is preferable as the divalent heterocyclic group from the viewpoint of further improving the alignment degree.

The atoms other than carbon constituting the divalent aromatic heterocyclic group include a nitrogen atom, a sulfur atom, and an oxygen atom. In a case where the aromatic heterocyclic group has a plurality of atoms other than carbon, constituting a ring, these atoms may be the same or different from each other.

Specific examples of the aromatic heterocyclic group include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, and a thienooxazole-diyl group.

Specific examples of the divalent alicyclic group include a cyclopentylene group and a cyclohexylene group, and the carbon atoms thereof may be substituted with —O—, —Si(CH₃)₂—, —N(Z^{M})—(Z^{M} represents a hydrogen atom, an alkyl group having 1 to 4 carbon atoms, a cycloalkyl group, an aryl group, a cyano group, or a halogen atom), —C(O)—, —S—, —C(S)—, —S(O)—, —SO₂—, or a group obtained by combining two or more of these groups.

Among these, from the viewpoint of more excellent effect of the present invention and more excellent alignment degree of the light absorption anisotropic film, Cy^{D} is preferably a divalent linking group represented by any of Formulae (Cy^{D}-1) to (Cy^{D}-15). In the following formulae, “*” represents a bonding position with respect to L^{D2} or L^{D3}, and the carbon atoms constituting the ring structures in the following Formulae may be substituted with heteroatom or may have a substituent. Examples of the substituents which may be included in the carbon atoms constituting the ring structures include the above-described substituent W, and an alkyl group, an alkoxy group, or a halogen atom is preferable.

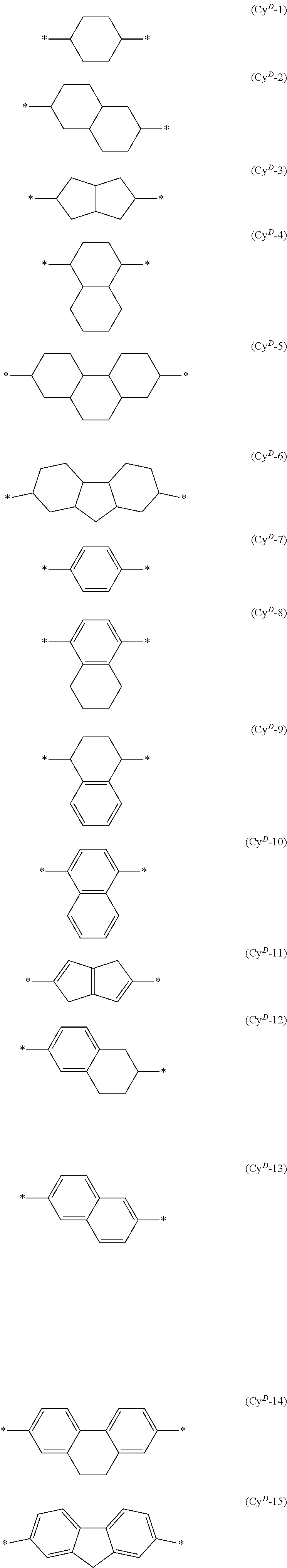

Specific examples of the divalent linking group represented by any of Formulae (Cy^{D}-1) to (Cy^{D}-15) include a 1,4-phenylene group, a 1,4-cyclohexylene group, a 1,4-cyclohexenyl group, a tetrahydropyran-2,5-diyl group, a 1,4-piperazine group, a 1,4-piperidine group, a 1,3-dioxane-2,5-diyl group, a tetrahydrothiopyran-2,5-diyl group, a 1,4-bicyclo(2,2,2) octylene group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 9-fluorenone-2,7-diyl group, a fluorene-2,7-diyl group, a thienothiophene-3,6-diyl group, a carbazole-3,6-diyl group, and a carbazole-2,7-diyl group.

From the viewpoint of further increasing the alignment degree of the light absorption anisotropic film to be formed, Cy^{D} in Formula (D) represents preferably a divalent linking group represented by any of Formulae (Cy^{D}-1), (Cy^{D}-4), (Cy^{D}-7), (Cy^{D}-10), or (Cy^{D}-13) and more preferably a divalent linking group represented by any of Formula (Cy^{D}-7) or Formula (Cy^{D}-13).

In Formula (D), D represents a hydrogen bonding group composed of a hydrogen atom and a non-metal atom of Group 14 to Group 16 (periodic table). However, the non-metal atom may have a substituent.

Here, examples of the non-metal atom of Group 14 to Group 16 include an oxygen atom, a sulfur atom, a nitrogen atom, and a carbon atom.

In addition, examples of the substituent which may be included in the non-metal atom (particularly, a nitrogen atom and a carbon atom) include a halogen atom, an alkyl group, an alkoxy group, an alkyl-substituted alkoxy group, a cyclic alkyl group, an aryl group (such as a phenyl group or a naphthyl group), a cyano group, an amino group, a nitro group, an alkylcarbonyl group, a sulfo group, and a hydroxyl group.

Examples of such a hydrogen bonding group include a hydrogen bonding donor group and a hydrogen bonding acceptor group.

Specific examples of the hydrogen bond-donating group include an amino group, an amide group, a urea group, a urethane group, a sulfonylamino group, a sulfo group, a phospho group, a hydroxy group, a mercapto group, a carboxyl group, a methylene group substituted with an electron withdrawing group, and a methine group substituted with electron withdrawing group. Among these, a carboxyl group or an amide group is preferable.

Specific examples of the hydrogen bond-accepting group include a heteroatom having an unshared electron pair on a heterocycle, a hydroxy group, an aldehyde, a ketone, a carboxyl group, carboxylic acid ester, carboxylic acid amide, a lactone, a lactam, sulfonic acid amide, a sulfo group, a phospho group, phosphoric acid amide, urethane, urea, an ether structure (particularly, a polymer structure having an oxygen atom contained in a polyether structure), an aliphatic amine, and an aromatic amine. Among these, a carboxyl group or an amide group is preferable.

In Formula (D), n represents an integer of 1 to 3. In a case where n is 2 or 3, a plurality of L^{D2}'s may be the same or different from each other, and a plurality of Cy^{D}'s may be the same or different from each other.

In the present invention, from the reason that the haze of the light absorption anisotropic film is more difficult to be observed (the haze is improved), n in Formula (D) is preferably 1 or 2, and from the reason that cissing is further suppressed during the formation of the light absorption anisotropic film, n in Formula (D) is more preferably 2.

In the present invention, from the viewpoint of further increasing the alignment degree of the light absorption anisotropic film to be formed, it is preferable that the repeating unit D is a repeating unit in which L^{D3} in Formula (D) represents a single bond and D represents-COOH, —NHCOR², or —CONHR³.

Here, R² and R³ each independently represent an alkyl group or an alkenyl group, which has 1 to 10 carbon atoms. The alkyl group and the alkenyl group may be linear or branched. One or two or more nonadjacent —CH₂—'s from among —CH₂—'s constituting a part of the alkyl group and the alkenyl group may be substituted with —O—.

Further, in the present invention, from the viewpoint that the haze of the light absorption anisotropic film is difficult to observe, it is preferable that the repeating unit D is a repeating unit in which L^{D3} in Formula (D) represents a single bond and D represents —NHCOR⁴.

Here, R⁴ represents an alkyl group or an alkenyl group having 1 to 3 carbon atoms. The alkyl group and the alkenyl group may be linear or branched. One or two or more nonadjacent —CH₂—'s from among —CH₂—'s constituting a part of the alkyl group and the alkenyl group may be substituted with —O—.

Examples of the monomer forming the repeating unit D include monomers represented by the following formulae. In the following formula, Me represents a methyl group and Ac represents an acetyl group.

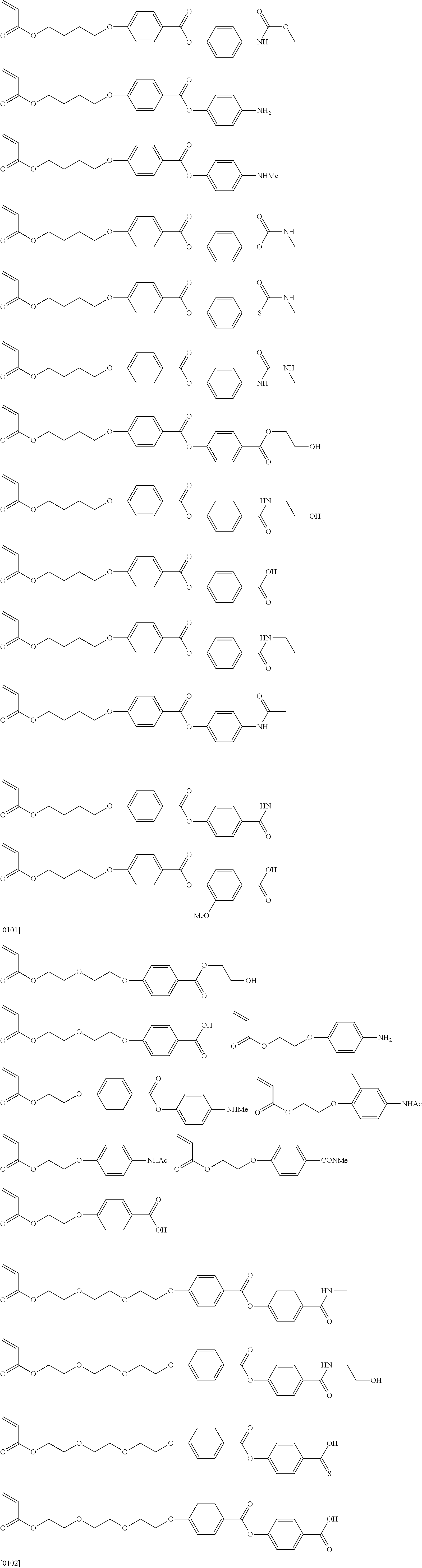

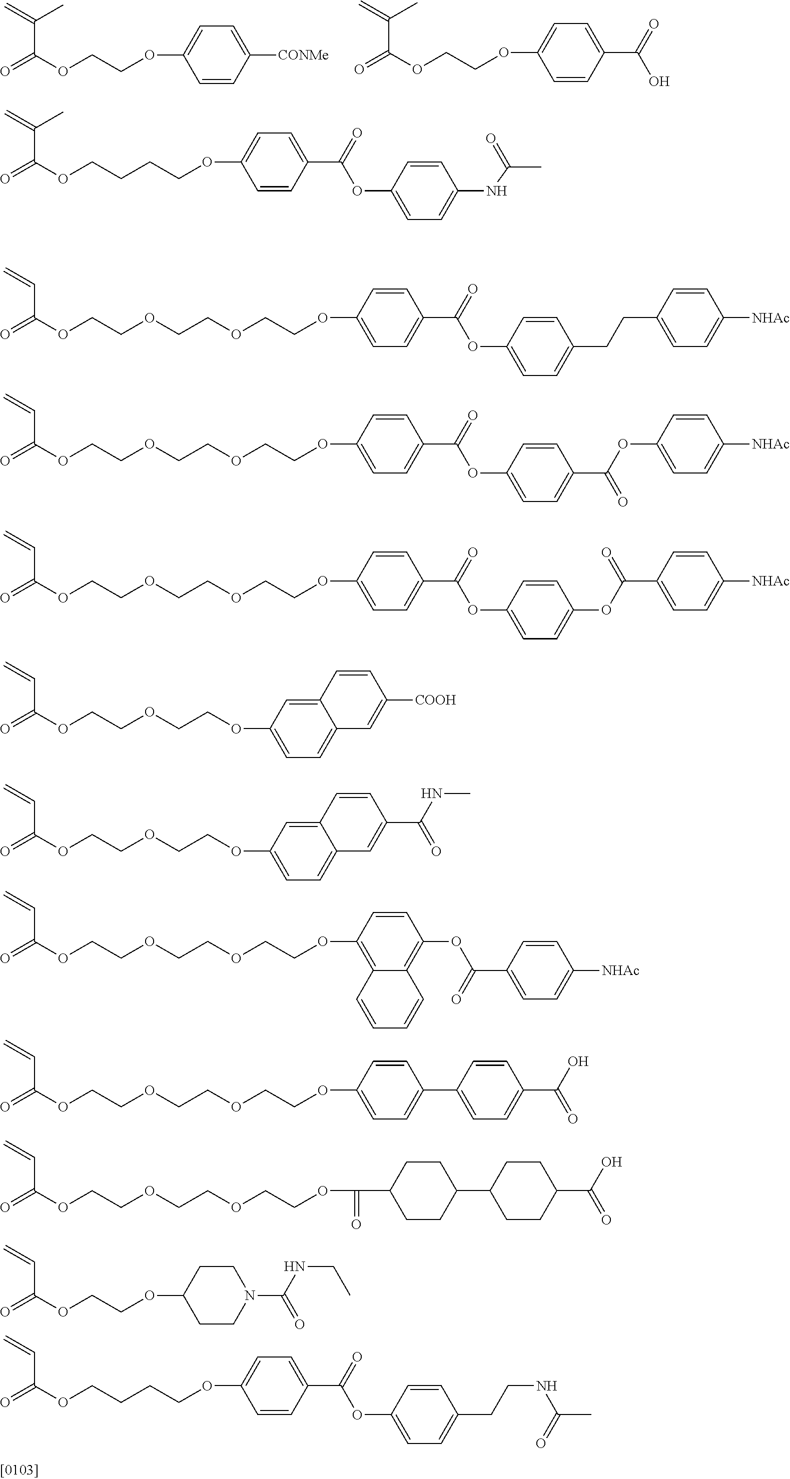

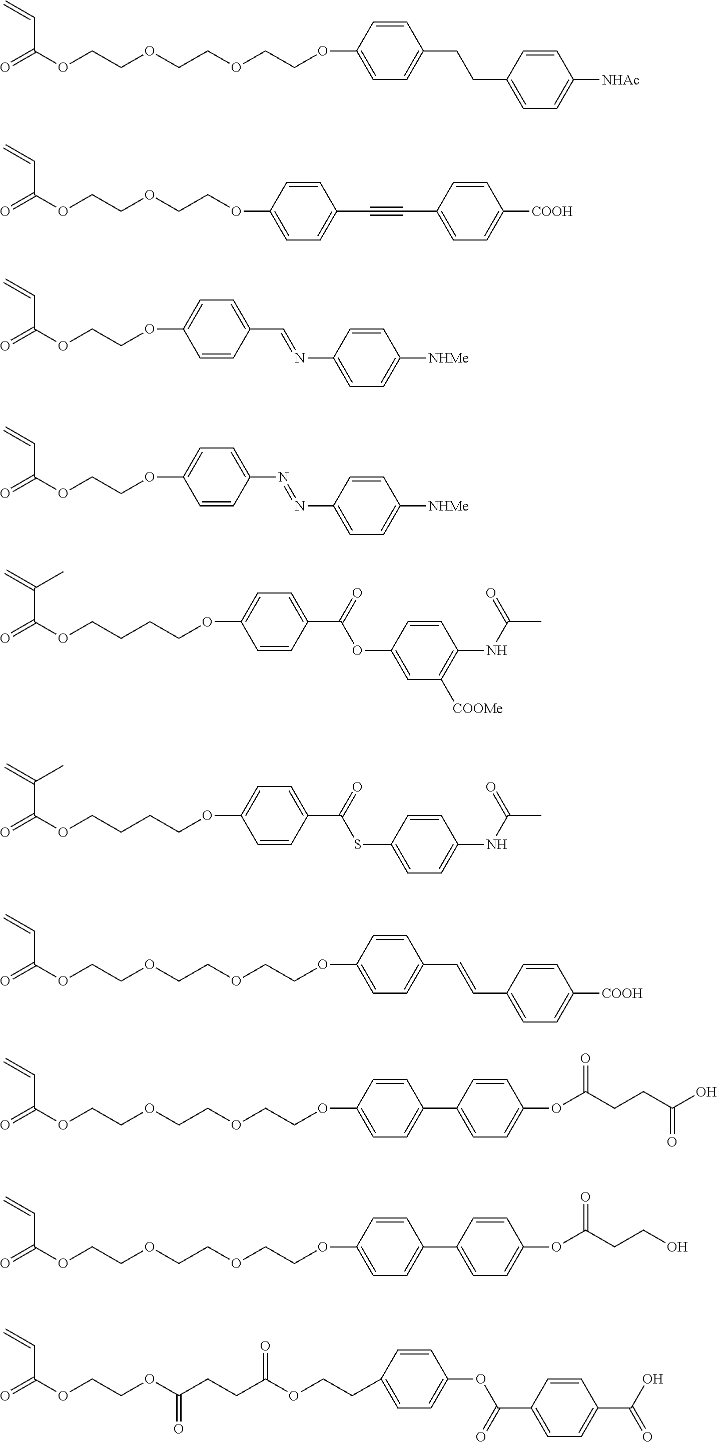

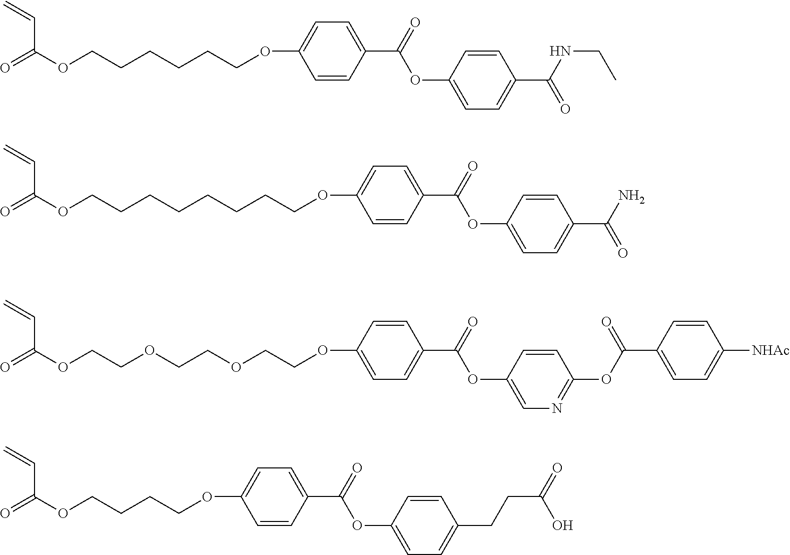

In a case where the polymer 1 has the repeating unit D, the content of the repeating unit D is preferably 5% to 85% by mass, more preferably 10% to 75% by mass, and still more preferably 20% to 70% by mass with respect to all repeating units (100% by mass) of the polymer 1. In a case where the content of the repeating unit D is within the above-described range, the effect of the present invention is more excellent.

The repeating unit D may be included alone or in combination of two or more kinds in the polymer 1. In a case where two or more kinds of the repeating units D are included, the content of the repeating unit D means the total content of the repeating units D.

### <Repeating Unit E>

The repeating unit E is a repeating unit which does not contain a fluorine atom or a polymerizable group, and satisfies Condition 1 or Condition 2.
Condition 1: The repeating unit E has a polar group at a terminal of a side chain.
Condition 2: The repeating unit E is represented by Formula (E-1) or (E-2).

### (Condition 1)

The repeating unit E satisfying Condition 1 is a repeating unit having a polar group at a terminal of a side chain.

Here, the polar group refers to a substituent which has a hydrogen atom and has a charge bias between a bond of the hydrogen atom and an atom to which the hydrogen atom is bonded, or an ion pair consisting of a deprotonated form or a proton adduct of the substituent.

Specific examples of the substituent include an amino group, an amide group, a urea group, a urethane group, a sulfonylamino group, a sulfo group, a phospho group, a hydroxy group, a mercapto group, a carboxyl group, a methylene group substituted with an electron withdrawing group, and a methine group substituted with an electron withdrawing group. Among these, a carboxyl group is preferable.

Specific examples of the ion pair include a carboxylate, an onium salt, a sulfonium salt, and a phosphonium salt.

The repeating unit E satisfying Condition 1 is preferably a repeating unit represented by Formula (K-1).

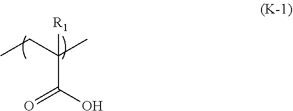

In Formula (K-1), R¹⁰ represents a hydrogen atom or an alkyl group having 1 to 20 carbon atoms, and among these, a hydrogen atom or an alkyl group having 1 to 10 carbon atoms is preferable, a hydrogen atom or an alkyl group having 1 to 4 carbon atoms is more preferable, and a hydrogen atom or a methyl group is still more preferable.

Specific examples of the monomer forming the repeating unit represented by Formula (K-1) include acrylic acid and methacrylic acid.

### (Condition 2)

The repeating unit E satisfying Condition 2 is a repeating unit represented by Formula (E-1) or (E-2).

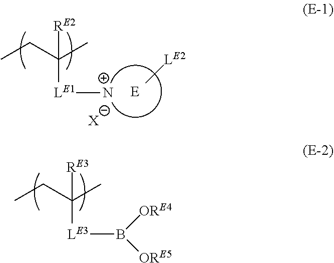

In Formulae (E-1) and (E-2), R^{E2} and R^{E3} each independently represent a hydrogen atom or a substituent.

In addition, in Formulae (E-1) and (E-2), L^{E1} and L^{E3} represent a single bond or a divalent linking group selected from the group consisting of —O—, —S—, —COO—, —OCO—, —CONR^{L1}—, —NR^{L1}COO—, —CR^{L1}N—, a substituted or unsubstituted divalent aliphatic group, a substituted or unsubstituted divalent aromatic group, and a combination thereof, and R^{L1} represents a hydrogen atom or an alkyl group having 1 to 20 carbon atoms.

In addition, in Formula (E-1), the ring E represents a ring structure having a cationized nitrogen atom.

In addition, in Formula (E-1), X represents an anion.

In addition, in Formula (E-1), L^{E2} represents a hydrogen atom or a substituent.

In addition, in Formula (E-2), R^{E4} and R^{E5} each independently represent a hydrogen atom, a substituted or unsubstituted aliphatic hydrocarbon group, a substituted or unsubstituted aryl group, or a substituted or unsubstituted heteroaryl group, and R^{E4} and R^{E5} may be linked to each other through a linking group consisting of an alkylene linking group, an arylene linking group, or a combination of these groups.

In Formulae (E-1) and (E-2), R^{E2} and R^{E3} each independently represent a hydrogen atom or a substituent.

Examples of the substituent represented by one aspect of R^{E2} and R^{E3} include the groups described in the substituent W described above, and among these, an aliphatic hydrocarbon group (for example, an alkyl group having 1 to 20 carbon atoms) is preferable.

R^{E2} and R^{E3} represent a hydrogen atom or an alkyl group having 1 to 20 carbon atoms, and among these, a hydrogen atom or an alkyl group having 1 to 10 carbon atoms is preferable, a hydrogen atom or an alkyl group having 1 to 4 carbon atoms is more preferable, and a hydrogen atom or a methyl group is still more preferable.

In addition, in Formulae (E-1) and (E-2), as described above, L^{E1} and L^{E3} represent a single bond or a divalent linking group selected from the group consisting of —O—, —S—, —COO—, —OCO—, —CONR^{L1}—, —NR^{L1}COO—, —CR^{L1}N—, a substituted or unsubstituted divalent aliphatic group, a substituted or unsubstituted divalent aromatic group, and a combination thereof, and R^{L1} represents a hydrogen atom or an alkyl group having 1 to 20 carbon atoms.

Here, examples of the substituted or unsubstituted divalent aliphatic group represented by one aspect of L^{E1} and L^{E3} include an alkylene group having 1 to 20 carbon atoms, which may have a substituent, and a cycloalkylene group having 3 to 20 carbon atoms, which may have a substituent (for example, a cyclohexylene group). Among these, an alkylene group having 1 to 15 carbon atoms is preferable, an alkylene group having 1 to 8 carbon atoms is more preferable, and a methylene group, an ethylene group, a propylene group, or a butylene group is still more preferable.

In addition, examples of the substituted or unsubstituted divalent aromatic group represented by one aspect of L^{E1} and L^{E3} include a divalent aromatic hydrocarbon group which may have a substituent and a divalent aromatic heterocyclic group which may have a substituent. Examples of the divalent aromatic hydrocarbon group include a group obtained by removing one hydrogen atom from each of two carbon atoms constituting a ring structure of an aromatic hydrocarbon ring such as a benzene ring, a naphthalene ring, an anthracene ring, a triphenylene ring, and a fluorene ring; and among these, a phenylene group or a naphthylene group obtained by removing one hydrogen atom from each of two carbon atoms constituting a ring structure of a benzene ring or a naphthalene ring is preferable. On the other hand, examples of the divalent aromatic heterocyclic group include a group obtained by removing one hydrogen atom from each of two carbon atoms constituting a ring structure of an aromatic heterocyclic ring such as a furan ring, a pyrrole ring, a thiophene ring, a pyridine ring, a thiazole ring, a benzothiazole ring, an oxadiazole ring, a thiazolothiazole ring, and a phenanthroline ring.

Examples of the substituent which may be included in the divalent aliphatic group or the divalent aromatic group include the groups described in the substituent W described above.

In addition, the alkyl group having 1 to 20 carbon atoms, represented by one aspect of R^{L1} described above, is preferably an alkyl group having 1 to 6 carbon atoms, and specific examples thereof include a methyl group, an ethyl group, a propyl group, an isopropyl group, an n-butyl group, an isobutyl group, a sec-butyl group, a tert-butyl group, an n-pentyl group, and an n-hexyl group.

In addition, in Formula (E-1), the ring E represents a ring structure having a cationized nitrogen atom, as described above.

The ring E is preferably a ring structure represented by Formula (E-1-1). Furthermore, in Formula (E-1-1), * represents a bonding position to L^{E1}.

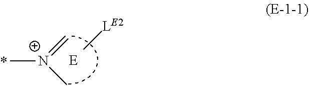

Examples of the ring structure of the ring E include a pyridine ring, a picoline ring, a 2,2′-bipyridyl ring, a 4,4′-bipyridyl ring, a 1,10-phenanthroline ring, a quinoline ring, an oxazole ring, a thiazole ring, an imidazole ring, a pyrazine ring, a triazole ring, and a tetrazole ring.

In addition, the ring E is preferably a quaternary imidazolium ion or a quaternary pyridinium ion.

In addition, in Formula (E-1), X represents an anion, as described above.

Examples of X include a halogen anion (for example, a fluorine ion, a chlorine ion, a bromine ion, an iodine ion, and the like), a sulfonate ion (for example, a methanesulfonate ion, a trifluoromethanesulfonate ion, a methylsulfate ion, a vinylsulfonate ion, an allylsulfonate ion, a p-toluenesulfonate ion, a p-chlorobenzenesulfonate ion, a p-vinylbenzenesulfonate ion, a 1,3-benzenedisulfonate ion, a 1,5-naphthalenedisulfonate ion, a 2,6-naphthalenedisulfonate ion, and the like), a sulfate ion, a carbonate ion, a nitrate ion, a thiocyanate ion, a perchlorate ion, a tetrafluoroborate ion, a picrate ion, an acetate ion, a benzoate ion, a p-vinyl benzoate ion, a formate ion, a trifluoroacetate ion, a phosphate ion (for example, hexafluorophosphate ion), and a hydroxide ion. X is preferably a halogen anion, a sulfonate ion, or a hydroxide ion. In addition, a chlorine ion, a bromine ion, an iodine ion, a methanesulfonate ion, a vinylsulfonate ion, a p-toluenesulfonate ion, or a p-vinylbenzenesulfonate ion is particularly preferable.

In addition, in Formula (E-1), L^{E2} represents a hydrogen atom or a substituent, as described above.

Examples of the substituent represented by one aspect of L^{E2} include the groups described in the substituent W described above, and among these, an alkylamino group having 1 to 10 carbon atoms, an aliphatic hydrocarbon group (for example, an alkyl group having 1 to 20 carbon atoms), a heterocyclic group, or a cyano group is preferable.

In addition, in Formula (E-2), as described above, R^{E4} and R^{E5} each independently represent a hydrogen atom, a substituted or unsubstituted aliphatic hydrocarbon group, a substituted or unsubstituted aryl group, or a substituted or unsubstituted heteroaryl group, and R^{E4} and R^{E5} may be linked to each other through an alkylene linking group, an arylene linking group, or a linking group consisting of a combination thereof.

Examples of the substituted or unsubstituted aliphatic hydrocarbon group represented by one aspect of R^{E4} and R^{E5} include an alkyl group, an alkenyl group, or an alkynyl group, which may have a substituent.

Specific examples of the alkyl group include linear, branched, or cyclic alkyl groups such as a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, a sec-butyl group, a tert-butyl group, an isopentyl group, a neopentyl group, a 1-methylbutyl group, an isohexyl group, a 2-methylhexyl group, a cyclopentyl group, a cyclohexyl group, a 1-adamantyl group, and a 2-norbornyl group.

Specific examples of the alkenyl group include linear, branched, or cyclic alkenyl groups such as a vinyl group, a 1-propenyl group, a 1-butenyl group, a 1-methyl-1-propenyl group, a 1-cyclopentenyl group, and a 1-cyclohexenyl group.

Specific examples of the alkynyl group include an ethynyl group, a 1-propynyl group, a 1-butynyl group, and a 1-octynyl group.

In addition, examples of the substituted or unsubstituted aryl group represented by one aspect of R^{E4} and R^{E5} include those in which 1 to 4 benzene rings form a fused ring and those in which a benzene ring and an unsaturated five-membered ring form a fused ring, and specific examples thereof include a phenyl group, a naphthyl group, an anthryl group, a phenanthryl group, an indenyl group, an acenaphthenyl group, a fluorenyl group, and a pyrenyl group.

Moreover, examples of the substituted or unsubstituted heteroaryl group represented by one aspect of R^{E4} and R^{E5} include a heteroaryl group obtained by removing one hydrogen atom on a heteroaromatic ring including one or more heteroatoms selected from the group consisting of a nitrogen atom, an oxygen atom, and a sulfur atom.

Specific examples of the heteroaromatic ring including one or more heteroatoms selected from the group consisting of a nitrogen atom, an oxygen atom, and a sulfur atom include pyrrole, furan, thiophene, pyrazole, imidazole, triazole, oxazole, isoxazole, oxadiazole, thiazole, thiadiazole, indole, carbazole, benzofuran, dibenzofuran, thianaphthene, dibenzothiophene, indazole benzimidazole, anthranil, benzisoxazole, benzoxazole, benzothiazole, purine, pyridine, pyridazine, pyrimidine, pyrazine, triazine, quinoline, acridine, isoquinoline, phthalazine, quinazoline, quinoxaline, naphthyridine, phenanthroline, and pteridine.

Examples of the substituent which may be included in the R^{E4} and R^{E5} include the groups described in the above-described substituent W.

Specific examples of the monomer forming the repeating unit represented by Formula (E-1) include monomers represented by Formulae I-1 to I-11.

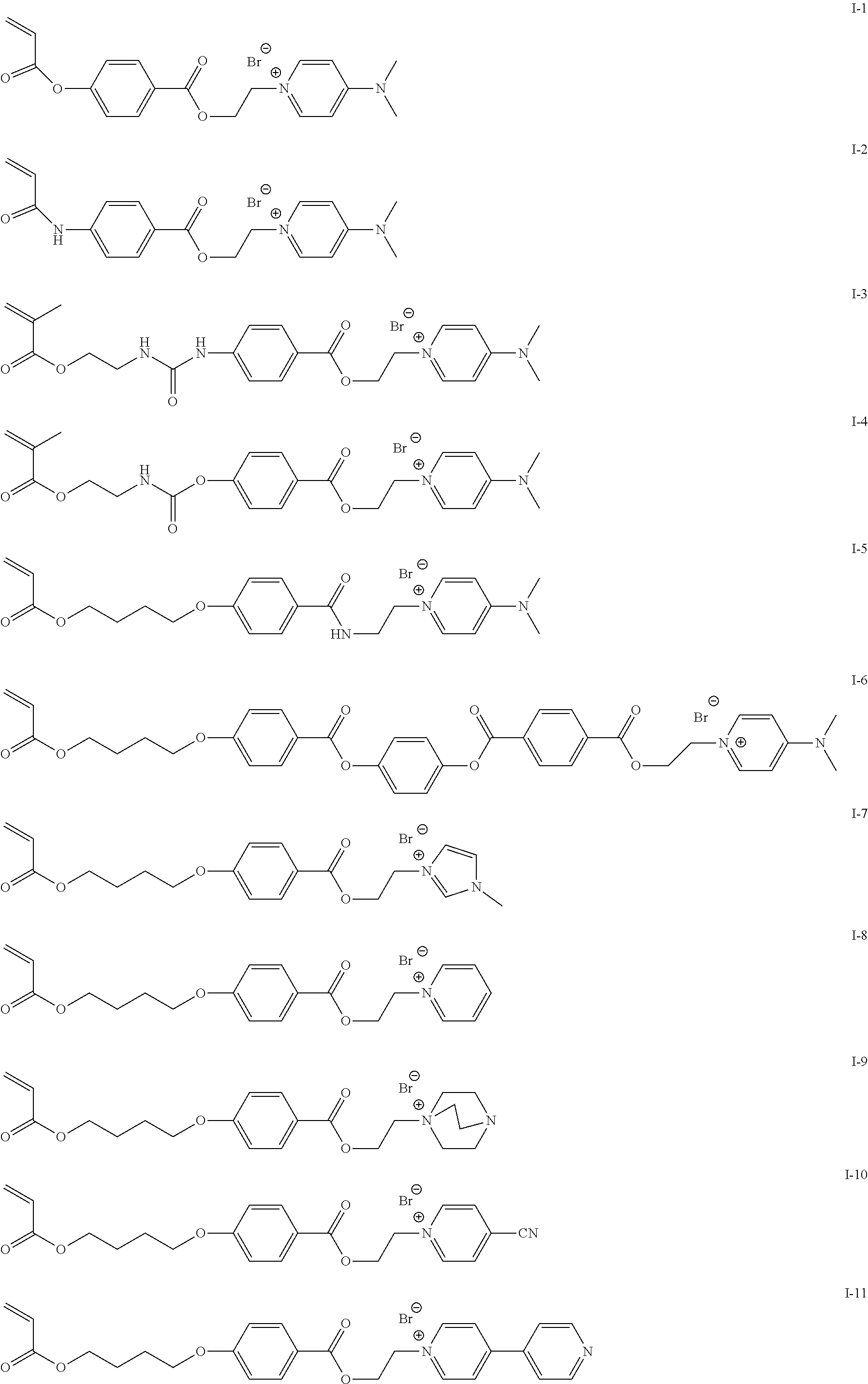

Specific examples of the monomer forming the repeating unit represented by Formula (E-2) include monomers represented by Formulae II-1 to II-12.

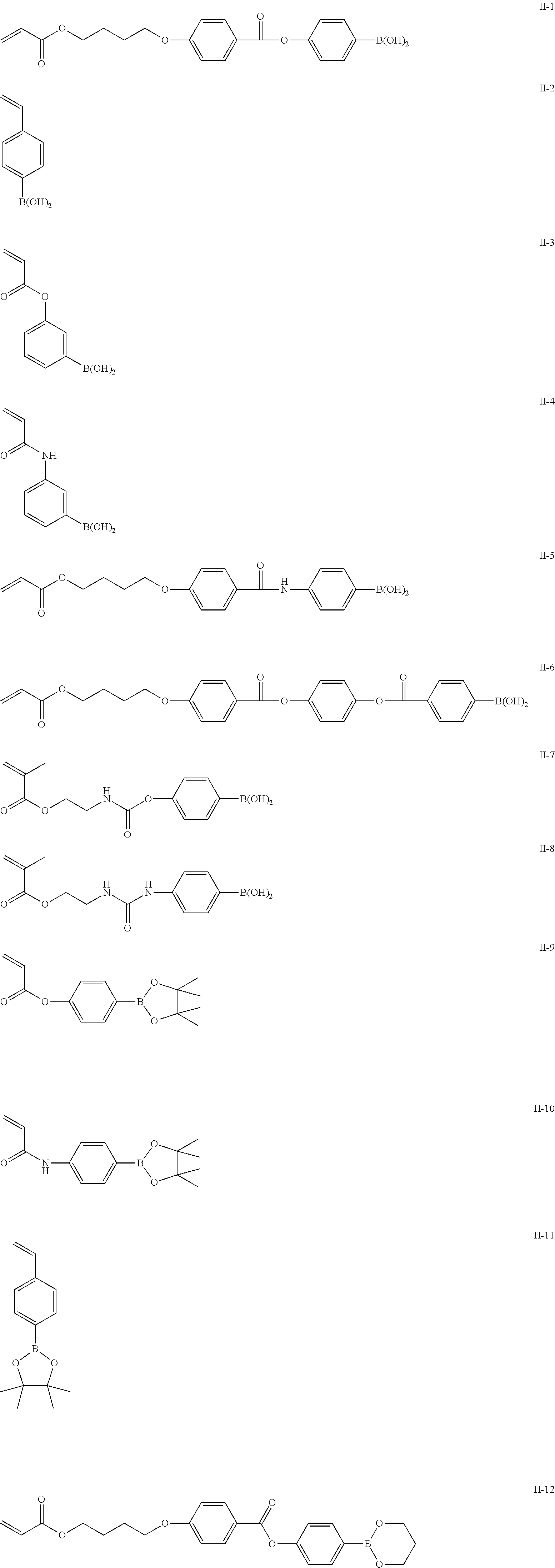

In the present invention, from the viewpoint of further suppressing the occurrence of the surface unevenness, it is more preferable that the repeating unit E satisfying the condition 2 is the repeating unit represented by Formula (E-2).

The polymer 1 having the repeating unit E satisfying the condition 2 may further have the repeating unit E satisfying the condition 1 described above, that is, the repeating unit having a polar group at the terminal of the side chain, and may satisfy the condition 1 described above.

In a case where the polymer 1 has the repeating unit E, the content of the repeating unit E is preferably 5% to 70% by mass, more preferably 10% to 65% by mass, and still more preferably 15% to 60% by mass with respect to all repeating units (100% by mass) of the polymer 1. In a case where the content of the repeating unit E is within the above-described range, the effect of the present invention is more excellent.

In the polymer 1, the repeating unit E may be contained alone or in combination of two or more kinds thereof. In a case where two or more kinds of the repeating units E are contained, the content of the repeating unit E means the total content of the repeating units E.

### (Repeating Unit F)

From the viewpoint of improving the adhesiveness between the light absorption anisotropic film and the adjacent layer, it is preferable that the polymer 1 having the repeating unit E further has a repeating unit F containing a polymerizable group.

The repeating unit F is preferably a repeating unit represented by Formula (F).

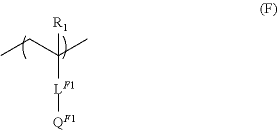

In Formula (F), R^{F1} represents a hydrogen atom or an alkyl group having 1 to 20 carbon atoms, and among these, a hydrogen atom or an alkyl group having 1 to 10 carbon atoms is preferable, a hydrogen atom or an alkyl group having 1 to 4 carbon atoms is more preferable, and a hydrogen atom or a methyl group is still more preferable.

In addition, in Formula (F), L^{F1} represents a single bond, —O—, —S—, —COO—, —OCO—, —CONR^{L2}—, —NR^{L2}COO—, —CR^{L2}N—, a substituted or unsubstituted divalent aliphatic group, a substituted or unsubstituted divalent aromatic group, or a divalent linking group selected from the group consisting of a combination thereof, where R^{L2} represents a hydrogen atom, an alkyl group having 1 to 20 carbon atoms, or -L^{F1}-Q^{F1}. In a case where R¹² is -L^{F1}-Q^{F1}, Q^{F1} represents a polymerizable group as in Q^{F1} of (F) described above.

Here, examples of the divalent aliphatic group and the divalent aromatic group represented by L^{F1} include the same groups as those described for L^{E1} in Formula (E-1), and examples of the alkyl group having 1 to 20 carbon atoms represented by R¹² include the same groups as those described for R^{L1} in relation to Formula (E-1).

In addition, in Formula (F), Q^{F1} represents a polymerizable group.

In the present invention, the polymerizable group represented by Q^{F1} in Formula (F) is preferably any polymerizable group selected from the group consisting of groups represented by Formulae (F-1) to (F-7), more preferably any polymerizable group selected from the group consisting of groups represented by Formulae (F-1) to (F-3), and still more preferably a polymerizable group represented by Formula (F-1) or (F-2).

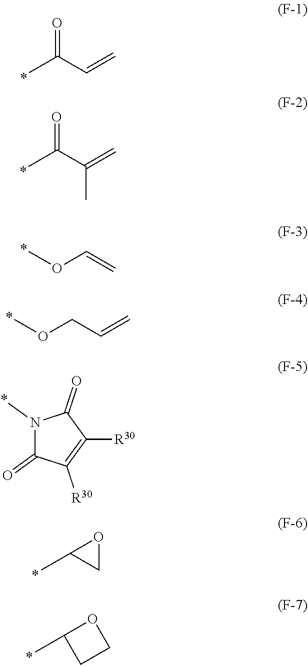

In Formulae (F-1) to (F-7), * represents a bonding position to L^{F2}. R³⁰ represents a hydrogen atom or an alkyl group having 1 to 5 carbon atoms, and two R³⁰'s may be the same or different from each other, and may be linked to each other to form a ring structure.

In addition, specific examples of the alkyl group having 1 to 5 carbon atoms represented by R³⁰ include a methyl group, an ethyl group, a propyl group, an isopropyl group, and an n-butyl group.

In the present invention, from the viewpoint of ease of manufacturing, economy, and radical polymerizability, the above-described repeating unit represented by Formula (F-1) is preferably a repeating unit in which, in Formula (F-1), R^{F1} is a hydrogen atom or a methyl group, and L^{F1} is a divalent linking group selected from the group consisting of a combination of —O—, —COO—, —OCO—, and a substituted or unsubstituted divalent aliphatic group (preferably an alkylene group having 2 to 8 carbon atoms).

Specific examples of the repeating unit F include a repeating unit represented by the following formula.

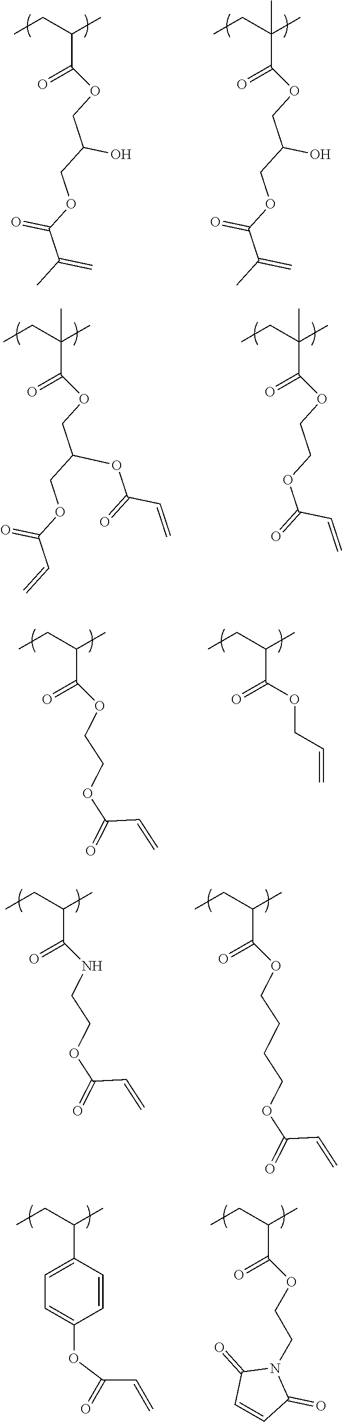

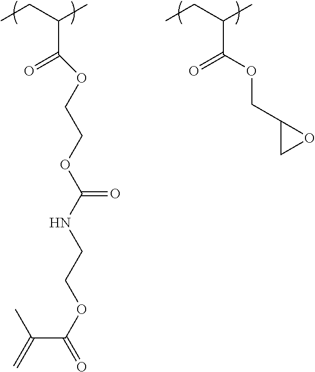

In a case where the polymer 1 has the repeating unit F, a content of the repeating unit F is preferably 1% to 30% by mass and more preferably 5% to 20% by mass with respect to all repeating units (100% by mass) of the polymer 1.

In the polymer 1, the repeating unit F may be included alone or in combination of two or more kinds thereof. In a case where two or more kinds of the repeating units F are included, the content of the repeating unit F means the total content of the repeating units F.

### <Content>

A content of the polymer 1 is preferably 0.001 to 0.500 parts by mass, more preferably 0.002 to 0.400 parts by mass, and still more preferably 0.003 to 0.300 parts by mass with respect to the total solid content mass (100 parts by mass) of the liquid crystal composition. In a case where the content of the polymer 1 is within the above-described range, the effect of the present invention is more excellent.

The content of the polymer 1 is preferably 0.001 to 0.530 parts by mass, more preferably 0.002 to 0.430 parts by mass, and still more preferably 0.003 to 0.320 parts by mass with respect to the total amount (100 parts by mass) of the liquid crystal compound and the dichroic substance in the liquid crystal composition. In a case where the content of the polymer 1 is within the above-described range, the effect of the present invention is more excellent.

### <Molecular Weight>

From the viewpoint that the effect of the present invention is more excellent, a weight-average molecular weight (Mw) of the polymer 1 is preferably 2,000 to 1,000,000, more preferably 3,000 to 200,000, and still more preferably 5,000 to 80,000.

Here, the weight-average molecular weight (Mw) of the polymer 1 is calculated by polystyrene conversion under measurement conditions of tetrahydrofuran as an eluent, a flow rate of 0.35 mL/min, and a temperature of 40° C. by gel permeation chromatography (EcoSEC HLC-8320GPC (manufactured by Tosoh Corporation)). In addition, TSKgel SuperHZM-H, TSKgel SuperHZ4000, and TSKgel SuperHZ200 (manufactured by Tosoh Corporation) are used as columns.

### [Polymer 2]

The liquid crystal composition according to the embodiment of the present invention contains a polymer 2. The polymer 2 is a polymer which has a repeating unit A including a structure represented by Formula (A) and is different from the above-described polymer 1.

It is preferable that the polymer 2 does not substantially have a fluorine atom. The expression “does not substantially have a fluorine atom” means that a total content of fluorine atoms contained in the polymer 2 is 5 parts by mass or less with respect to 100 parts by mass of the polymer 2. The total content of fluorine atoms contained in the polymer 2 is more preferably 3 parts by mass or less and still more preferably 0 parts by mass.

Here, the polymer different from the polymer 1 means a polymer having a different chemical structure from the polymer 1 or a polymer having the same chemical structure as the polymer 1 but having a different compositional ratio.

From the viewpoint that it is easy to obtain a light absorption anisotropic film exhibiting horizontal alignment (an angle θ formed by a transmittance central axis of the light absorption anisotropic film and a normal direction of a surface of the light absorption anisotropic film is more than 45° and 90° or less) and the effect of the present invention is more excellent, the polymer 2 is preferably a polymer (copolymer) including the repeating unit A (preferably, the repeating unit A-1) and at least one of the repeating unit B or the repeating unit D, and more preferably a polymer (copolymer) including the repeating unit A (preferably, the repeating unit A-1), the repeating unit B, and the repeating unit D.

On the other hand, from the viewpoint that it is easy to obtain a light absorption anisotropic film exhibiting vertical alignment (an angle θ formed by a transmittance central axis of the light absorption anisotropic film and a normal direction of a surface of the light absorption anisotropic film is 0° or more and 45° or less) and the effect of the present invention is more excellent, the polymer 2 is also preferably a polymer (copolymer) including the repeating unit A (preferably, the repeating unit A-1) and a repeating unit E satisfying Condition 1 or Condition 2 described later, and may further include a repeating unit F.

Each repeating unit in the polymer 2 (that is, the repeating unit A, the repeating unit B, the repeating unit D, the repeating unit E, and the repeating unit F) has the same preferred aspect as each repeating unit in the polymer 1, and thus the description thereof will not be repeated.

In a case where the purpose is to obtain a light absorption anisotropic film exhibiting horizontal alignment using the liquid crystal composition according to the embodiment of the present invention, a content A2 of the repeating unit A with respect to all repeating units (100% by mass) contained in the polymer 2 is preferably 5.0% to 50.0% by mass, more preferably 10.0% to 50.0% by mass, and still more preferably 10.0% to 40.0% by mass. In a case where the content of the repeating unit A is within the above-described range, the effect of the present invention is more excellent.

In a case where the purpose is to obtain a light absorption anisotropic film exhibiting vertical alignment using the liquid crystal composition according to the embodiment of the present invention, a content A2 of the repeating unit A with respect to all repeating units (100% by mass) contained in the polymer 2 is preferably 5.0% to 70.0% by mass, more preferably 5.0% to 65.0% by mass, still more preferably 10.0% to 65.0% by mass, and particularly preferably 15.0% to 60.0% by mass. In a case where the content of the repeating unit A is within the above-described range, the effect of the present invention is more excellent.

In the polymer 2, one kind of the repeating unit A may be included alone, or two or more kinds thereof may be included. In a case where two or more kinds of the repeating units A are contained, the content of the repeating unit A means the total content of the repeating units A.

In a case where the polymer 2 has the repeating unit B, a content of the repeating unit B is preferably 5.0% to 90.0% by mass, more preferably 10.0% to 85.0% by mass, and still more preferably 15.0% to 80.0% by mass with respect to all repeating units (100% by mass) contained in the polymer 2. In a case where the content of the repeating unit B is within the above-described range, the effect of the present invention is more excellent.

In the polymer 2, one kind of the repeating unit B may be included alone, or two or more kinds thereof may be included. In a case where two or more kinds of the repeating units B are contained, the content of the repeating unit B means the total content of the repeating units B.

In a case where the polymer 2 has the repeating unit D, a content of the repeating unit D is preferably 10.0% to 90.0% by mass, more preferably 20.0% to 85.0% by mass, and still more preferably 25.0% to 80.0% by mass with respect to all repeating units (100% by mass) contained in the polymer 2. In a case where the content of the repeating unit D is within the above-described range, the effect of the present invention is more excellent.

In the polymer 2, one kind of the repeating unit D may be included alone, or two or more kinds thereof may be included. In a case where two or more kinds of the repeating units D are included, the content of the repeating unit D means the total content of the repeating units D.

In a case where the polymer 2 has the repeating unit E, a content of the repeating unit E is preferably 5.0% to 80.0% by mass, more preferably 7.0% to 75.0% by mass, and still more preferably 9.0% to 70.0% by mass with respect to all repeating units (100% by mass) contained in the polymer 2. In a case where the content of the repeating unit E is within the above-described range, the effect of the present invention is more excellent.

In the polymer 2, one kind of the repeating unit E may be included alone, or two or more kinds thereof may be included. In a case where two or more kinds of the repeating units E are contained, the content of the repeating unit E means the total content of the repeating units E.

In a case where the polymer 2 has the repeating unit F, a content of the repeating unit F is preferably 5.0% to 40.0% by mass, and more preferably 10.0% to 30.0% by mass with respect to all repeating units (100% by mass) contained in the polymer 2.

In the polymer 2, one kind of the repeating unit F may be included alone, or two or more kinds thereof may be included. In a case where two or more kinds of the repeating units F are included, the content of the repeating unit F means the total content of the repeating units F.

### <Content>

A content of the polymer 2 is preferably 0.005 to 1.500 parts by mass, more preferably 0.007 to 1.200 parts by mass, and still more preferably 0.010 to 1.000 parts by mass with respect to the total solid content mass (100 parts by mass) of the liquid crystal composition. In a case where the content of the polymer 2 is within the above-described range, the effect of the present invention is more excellent.

The content of the polymer 2 is preferably 0.005 to 1.450 parts by mass, more preferably 0.008 to 1.300 parts by mass, and still more preferably 0.010 to 1.250 parts by mass with respect to the total amount (100 parts by mass) of the liquid crystal compound and the dichroic substance in the liquid crystal composition. In a case where the content of the polymer 2 is within the above-described range, the effect of the present invention is more excellent.

### <Molecular Weight>

From the viewpoint that the effect of the present invention is more excellent, a weight-average molecular weight (Mw) of the polymer 2 is preferably 2,000 to 1,000,000, more preferably 3,000 to 200,000, and still more preferably 5,000 to 80,000.

The Mw of the polymer 2 is calculated by the same method as that for the polymer 1.

### [A1/A2]

From the viewpoint that the alignment degree is more excellent, a ratio represented by A1/A2 is preferably more than 1, more preferably 1.1 or more, still more preferably 1.2 or more, and particularly preferably 1.3 or more, and from the viewpoint that the occurrence of the surface unevenness can be further suppressed, the ratio is preferably 8.0 or less, more preferably 7.50 or less, and still more preferably 7.0 or less.

A1 [unit: % by mass] means a content of the repeating unit A contained in the polymer 1 with respect to all repeating units contained in the polymer 1.

In addition, A2 [unit: % by mass] means a content of the repeating unit A contained in the polymer 2 with respect to all repeating units contained in the polymer 2.

### [X1 and X2]

In the present invention, in a case where a content of the silicon atom contained in the polymer 1 is defined as X1 parts by mass and a content of the silicon atom contained in the polymer 2 is defined as X2 parts by mass with respect to 100 parts by mass of a total solid content mass of the liquid crystal composition, a ratio represented by X1/X2 is 1 or more.

Here, X1 (unit: part by mass) is calculated as follows.

$$X 1 = [ content of polymer 1 with respect to total solid content mass ( 100 parts by mass ) of liquid crystal composition ] \times [ content of repeating unit having silicon atom with respect to all repeating units ( 100 \% by mass ) of polymer 1 / 100 ] \times [ content of silicon atom with respect to total mass ( 100 \% by mass ) of monomer corresponding to repeating unit having silicon atom / 100 ]$$

In addition, X2 (unit: part by mass) is also calculated in the same manner as X1, except that the polymer 2 is used instead of the polymer 1.

In a case where the purpose is to obtain a light absorption anisotropic film exhibiting horizontal alignment using the liquid crystal composition according to the embodiment of the present invention, the ratio represented by X1/X2 is preferably more than 1, more preferably 1.10 or more, still more preferably 1.370 or more, and particularly preferably 3.000 or more, and is preferably 41.32 or less, more preferably 25.000 or less, and still more preferably 15.000 or less.

In a case where X1/X2 is more than 1, the surface state and the alignment degree are more excellent. In addition, in a case where X1/X2 is 41.32 or less, the surface state and the alignment degree are more excellent.

In a case where the purpose is to obtain a light absorption anisotropic film exhibiting vertical alignment using the liquid crystal composition according to the embodiment of the present invention, the ratio represented by X1/X2 is preferably more than 1, more preferably 1.10 or more, still more preferably 2.000 or more, and particularly preferably 4.000 or more, and is preferably 79.34 or less, more preferably 50.000 or less, and still more preferably 30.000 or less.

In a case where X1/X2 is more than 1, the surface state and the alignment degree are more excellent. In addition, in a case where X1/X2 is 79.34 or less, the surface state and the alignment degree are more excellent.

In a case where the purpose is to obtain a light absorption anisotropic film exhibiting horizontal alignment using the liquid crystal composition according to the embodiment of the present invention, from the viewpoint that the effect of the present invention is more excellent, X1 is preferably 0.0016 to 0.057 parts by mass, more preferably 0.0040 to 0.0500 parts by mass, and still more preferably 0.0100 to 0.0450 parts by mass.

In a case where the purpose is to obtain a light absorption anisotropic film exhibiting horizontal alignment using the liquid crystal composition according to the embodiment of the present invention, from the viewpoint that the effect of the present invention is more excellent, X2 is preferably 0.0013 to 0.0500 parts by mass, more preferably 0.0030 to 0.0500 parts by mass, and still more preferably 0.0040 to 0.0300 parts by mass.

In a case where the purpose is to obtain a light absorption anisotropic film exhibiting vertical alignment using the liquid crystal composition according to the embodiment of the present invention, from the viewpoint that the effect of the present invention is more excellent, X1 is preferably 0.0027 to 0.0546 parts by mass, more preferably 0.0055 to 0.0400 parts by mass, and still more preferably 0.0100 to 0.0500 parts by mass.

In a case where the purpose is to obtain a light absorption anisotropic film exhibiting vertical alignment using the liquid crystal composition according to the embodiment of the present invention, from the viewpoint that the effect of the present invention is more excellent, X2 is preferably 0.0006 to 0.0437 parts by mass, more preferably 0.0010 to 0.0300 parts by mass, and still more preferably 0.0020 to 0.0200 parts by mass.

### Other Components

The liquid crystal composition according to the embodiment of the present invention may contain a component other than the above-described liquid crystal compound, dichroic substance, polymer 1, and polymer 2 (hereinafter, also referred to as “other components”).

Examples of the other components include an alignment agent, a polymerization initiator, and a solvent.

### <Alignment Agent>

The liquid crystal composition according to the embodiment of the present invention may contain an alignment agent. Examples of the alignment agent include boronic acid compounds and onium salts. The boronic acid compound functions as a horizontal alignment agent or a vertical alignment agent. In addition, the onium salt functions as a vertical alignment agent. The alignment agents may be used alone or in combination of two or more kinds thereof.

As the boronic acid compound, a compound represented by Formula (30) is preferable.

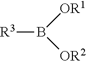

In Formula (30), R¹ and R² each independently represent a hydrogen atom, a substituted or unsubstituted aliphatic hydrocarbon group, a substituted or unsubstituted aryl group, or a substituted or unsubstituted heterocyclic group.

R³ represents a substituent containing a (meth)acryl group.

Specific examples of the boronic acid compound include a boronic acid compound represented by General Formula (I) described in paragraphs 0023 to 0032 of JP2008-225281A.

As the boronic acid compound, compounds shown below are also preferable.

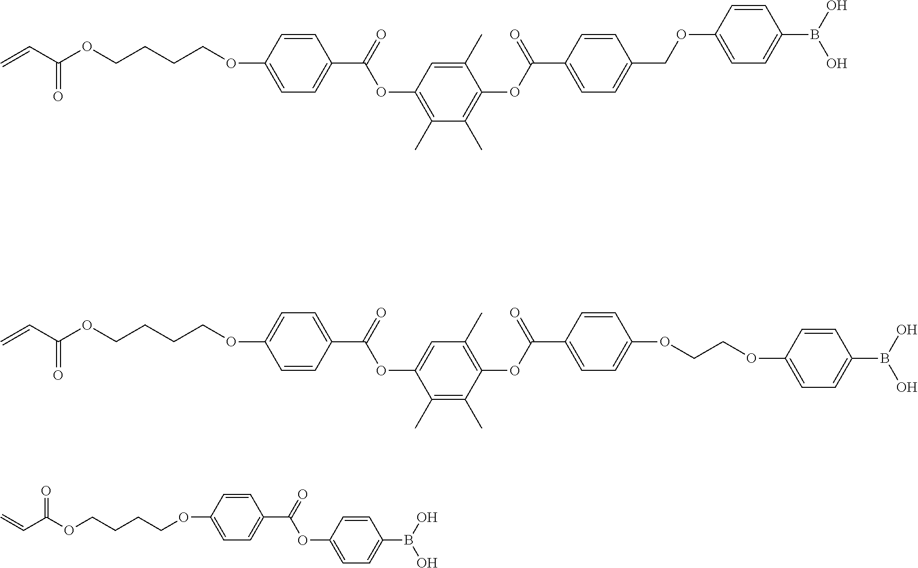 [SMILES: C=CC(=O)OCCCCOc1ccc(C(=O)Oc2cc(C)c(OC(=O)c3ccc(COc4ccc(B(O)O)cc4)cc3)c(C)c2C)cc1 ; C=CC(=O)OCCCCOc1ccc(C(=O)Oc2cc(C)c(OC(=O)c3ccc(OCCOc4ccc(B(O)O)cc4)cc3)c(C)c2C)cc1 ; C=CC(=O)OCCCCOc1ccc(C(=O)Oc2ccc(B(O)O)cc2)cc1]

Specific examples of the onium salt include the onium salts described in paragraphs 0052 to 0058 of JP2012-208397A, the onium salts described in paragraphs 0024 to 0055 of JP2008-026730A, and the onium salts described in JP2002-37777A.

In a case where the liquid crystal composition according to the embodiment of the present invention contains an alignment agent, a content of the alignment agent is preferably 0.01 to 30 parts by mass and more preferably 0.1 to 10 parts by mass with respect to the total solid content mass of the liquid crystal composition.

### <Polymerization Initiator>

The liquid crystal composition according to the embodiment of the present invention may contain a polymerization initiator. The polymerization initiator is not particularly limited, but a photosensitive compound, that is, a photopolymerization initiator is preferable.

As the photopolymerization initiator, various compounds can be used without any particular limitation. Examples of the photopolymerization initiator include α-carbonyl compounds (U.S. Pat. Nos. 2,367,661A and 2,367,670A), acyloin ether (U.S. Pat. No. 2,448,828A), α-hydrocarbon-substituted aromatic acyloin compounds (U.S. Pat. No. 2,722,512A), polynuclear quinone compounds (U.S. Pat. Nos. 3,046,127A and 2,951,758A), a combination of a triarylimidazole dimer and a p-aminophenyl ketone (U.S. Pat. No. 3,549,367A), acridine and phenazine compounds (JP1985-105667A (JP-S60-105667A) and U.S. Pat. No. 4,239,850A), oxadiazole compounds (U.S. Pat. No. 4,212,970A), o-acyloxime compounds ([65] of JP2016-27384A), and acylphosphine oxide compounds (JP1988-40799B (JP-S63-40799B), JP1993-29234B (JP-H5-29234B), JP1998-95788A (JP-H10-95788A), and JP1998-29997A (JP-H10-29997A)).

A commercially available product can also be used as such a photopolymerization initiator, and examples thereof include IRGACURE 184, IRGACURE 907, IRGACURE 369, IRGACURE 651, IRGACURE 819, IRGACURE OXE-01, and IRGACURE OXE-02 (all manufactured by BASF SE).

The polymerization initiators may be used alone or in combination of two or more kinds thereof.

In a case where the liquid crystal composition according to the embodiment of the present invention contains a polymerization initiator, a content of the polymerization initiator is preferably 0.01 to 30 parts by mass and more preferably 0.1 to 15 parts by mass with respect to the total solid content mass of the liquid crystal composition.

### <Solvent>

From the viewpoint of workability and the like, the liquid crystal composition according to the embodiment of the present invention preferably contains a solvent.

Examples of the solvent include organic solvents such as ketones (for example, acetone, 2-butanone, methyl isobutyl ketone, cyclopentanone, and cyclohexanone), ethers (for example, dioxane, tetrahydrofuran, tetrahydropyran, dioxolane, tetrahydrofurfuryl alcohol, and cyclopentyl methyl ether), aliphatic hydrocarbons (for example, hexane), alicyclic hydrocarbons (for example, cyclohexane), aromatic hydrocarbons (for example, benzene, toluene, xylene, and trimethylbenzene), halogenated carbons (for example, dichloromethane, trichloromethane (chloroform), dichloroethane, dichlorobenzene, and chlorotoluene), esters (for example, methyl acetate, ethyl acetate, butyl acetate, and diethyl carbonate), alcohols (for example, ethanol, isopropanol, butanol, and cyclohexanol), cellosolves (for example, methyl cellosolve, ethyl cellosolve, and 1,2-dimethoxyethane), cellosolve acetates, sulfoxides (for example, dimethyl sulfoxide), amides (for example, dimethylformamide, dimethylacetamide, N-methylpyrrolidone, N-ethylpyrrolidone, and 1,3-dimethyl-2-imidazolidinone), and heterocyclic compounds (for example, pyridine), and water. These solvents may be used alone or in combination of two or more kinds thereof.

Among these solvents, it is preferable to use an organic solvent and more preferable to use halogenated carbons or ketones from the viewpoint that the effects of the present invention are more excellent.

In a case where the liquid crystal composition according to the embodiment of the present invention contains a solvent, a content of the solvent is preferably 70% to 99% by mass, more preferably 83% to 97% by mass, and still more preferably 85% to 95% by mass with respect to the total mass of the liquid crystal composition.

### [Light Absorption Anisotropic Film]

The light absorption anisotropic film according to the embodiment of the present invention is a light absorption anisotropic film (light absorption anisotropic layer) formed using the above-described liquid crystal composition according to the embodiment of the present invention.

The method of producing the light absorption anisotropic film according to the embodiment of the present invention is not particularly limited, but a method of sequentially performing a step of coating an alignment film with the above-described liquid crystal composition to form a coating film (hereinafter, also referred to as “coating film forming step”) and a step of aligning liquid crystal components contained in the coating film (hereinafter, also referred to as “aligning step”) in this order (hereinafter, also referred to as “present production method”) is preferable from the viewpoint that the alignment degree of the light absorption anisotropic film to be obtained is further increased.

The liquid crystal component is a component containing not only the liquid crystal compound described above but also a dichroic substance having liquid crystallinity.

Hereinafter, each of the steps will be described.

### [Coating Film Forming Step]

The coating film forming step is a step of coating the alignment film with the above-described liquid crystal composition to form a coating film.

The liquid crystal composition can be easily applied onto the alignment film by using the liquid crystal composition containing the above-described solvent or using a liquid-like material such as a melt obtained by heating the liquid crystal composition.

Examples of the method of coating the liquid crystal composition include known methods such as a roll coating method, a gravure printing method, a spin coating method, a wire bar coating method, an extrusion coating method, a direct gravure coating method, a reverse gravure coating method, a die-coating method, a spraying method, and an inkjet method.

### <Alignment Film>

The alignment film can be provided by methods such as rubbing treatment of an organic compound (preferably a polymer) on a film surface, oblique vapor deposition of an inorganic compound, formation of a layer having microgrooves, or accumulation of an organic compound (for example, @-tricosanoic acid, dioctadecylmethylammonium chloride, or methyl stearate) by the Langmuir-Blodgett method (LB film). Furthermore, an alignment film in which an alignment function is generated by application of an electric field, application of a magnetic field, or irradiation with light is also known. Among these, an alignment film formed by a rubbing treatment is preferable in view of easy control of a pretilt angle of the alignment film, and a photo-alignment film formed by light irradiation is also preferable in view of alignment uniformity in the present invention.

### (Rubbing Treatment Alignment Film)

A polymer material used for the alignment film formed by performing a rubbing treatment is described in multiple documents, and a plurality of commercially available products can be used. In the present invention, polyvinyl alcohol or polyimide and derivatives thereof are preferably used. The alignment film can refer to the description on page 43, line 24 to page 49, line 8 of WO2001/88574A1. The thickness of the alignment film is preferably in a range of 0.01 to 10 μm and more preferably in a range of 0.01 to 1 μm.

### (Photo-Alignment Film)

Photo-alignment materials used for the alignment film formed by light irradiation are described in a large number of documents. In the present invention, preferred examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadimide compounds having a photo-alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. Azo compounds, photo-crosslinkable polyimides, polyamides, or esters are more preferable.

The photo-alignment film formed of the above-described material is irradiated with linearly polarized light or non-polarized light to produce a photo-alignment film.

In the present specification, the “irradiation with linearly polarized light” and the “irradiation with non-polarized light” are operations for causing a photo-reaction in the photo-alignment material. A wavelength of the light to be used varies depending on the photo-alignment material to be used, and is not particularly limited as long as the wavelength is required for the photo-reaction. The peak wavelength of the light used for light irradiation is preferably 200 nm to 700 nm, and ultraviolet light having a light peak wavelength of 400 nm or less is more preferable.

Examples of a light source used for the light irradiation include commonly used light sources, for example, lamps such as a tungsten lamp, a halogen lamp, a xenon lamp, a xenon flash lamp, a mercury lamp, a mercury xenon lamp, or a carbon arc lamp, various lasers [such as a semiconductor laser, a helium neon laser, an argon ion laser, a helium cadmium laser, and a yttrium aluminum garnet (YAG) laser], a light emitting diode, and a cathode ray tube.

As a method of obtaining the linearly polarized light, a method of using a polarizing plate (for example, iodine polarizing plate, dichroic substance polarizing plate, and wire grid polarizing plate), a method of using a prismatic element (for example, Glan-Thomson prism) or a reflective type polarizer using Brewster's angle, or a method of using light emitted from a polarized laser light source can be adopted. In addition, by using a filter, a wavelength conversion element, or the like, only light having a required wavelength may be radiated selectively.

In a case where light to be applied is linearly polarized light, a method of applying light vertically or obliquely to the upper surface with respect to the alignment film or the surface of the alignment film from the rear surface is employed. An incidence angle of light varies depending on the photo-alignment material, but is preferably 0° to 90° (vertical) and more preferably 40° to 90°.

In a case where the light to be applied is the non-polarized light, the alignment film is irradiated with the non-polarized light obliquely. An incidence angle is preferably 10° to 80°, more preferably 20° to 60°, and particularly preferably 30° to 50°.

An irradiation time is preferably 1 minute to 60 minutes and more preferably 1 minute to 10 minutes.

In a case where patterning is required, a method of performing irradiation with light using a photo mask as many times as necessary for pattern preparation or a method of writing a pattern by laser light scanning can be employed.

### [Alignment Step]

The alignment step is a step of aligning a dichroic substance contained in the coating film. In this manner, the light absorption anisotropic film according to the embodiment of the present invention can be obtained. In the aligning step, the dichroic substance is considered to be aligned along the liquid crystal compound aligned by the alignment film.

The aligning step may have a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the dichroic substance contained in the liquid crystal composition may be aligned by performing the above-described coating film forming step or drying treatment. For example, in an embodiment in which the liquid crystal composition is prepared as a coating solution containing a solvent, the light absorption anisotropic film according to the embodiment of the present invention may be obtained by drying the coating film and removing the solvent from the coating film so that the dichroic substance contained in the coating film is aligned.

The aligning step preferably has a heating treatment. As a result, the dichroic substance contained in the coating film is further aligned, and the alignment degree of the obtained light absorption anisotropic film is further increased.

From the viewpoint of manufacturing suitability or the like, the heat treatment is performed at a temperature of preferably 10° C. to 250° C. and more preferably 25° C. to 190° C. In addition, the heating time is preferably 1 to 300 seconds and more preferably 1 to 60 seconds.

The aligning step may include a cooling treatment performed after the heating treatment. The cooling treatment is a treatment of cooling the heated coating film to room temperature (20° C. to 25° C.). As a result, the alignment of the dichroic substance contained in the coating film is further fixed, and the alignment degree of the light absorption anisotropic film is further increased. The cooling unit is not particularly limited, and the cooling can be performed by a known method.

The light absorption anisotropic film according to the embodiment of the present invention can be obtained by performing the above-described steps.

### Other Steps

The present manufacturing method may include a step of curing the light absorption anisotropic film after the above-described alignment step (hereinafter, also referred to as “curing step”).

The curing step is performed by, for example, heating the layer and/or irradiating (exposing) the layer with light. Among these, it is preferable that the curing step is performed by irradiating the light absorption anisotropic film with light.

Various light sources such as infrared rays, visible light, and ultraviolet rays can be used as the light source for curing, but ultraviolet rays are preferable. In addition, ultraviolet rays may be applied while the light absorption anisotropic film is heated during the curing, or ultraviolet rays may be applied through a filter which transmits only a specific wavelength.

Further, the exposure may be performed under a nitrogen atmosphere. In a case where the curing of the light absorption anisotropic film proceeds by radical polymerization, since the inhibition of polymerization by oxygen is reduced, it is preferable that exposure is performed in a nitrogen atmosphere.

A thickness of the light absorption anisotropic film is not particularly limited, but from the viewpoint that the effect of the present invention is more excellent, it is preferably 0.3 to 10 μm and more preferably 0.5 to 9 μm.

The liquid crystal compound and the dichroic substance contained in the light absorption anisotropic film according to the embodiment of the present invention are immobilized in an alignment state.

Examples of one aspect of the light absorption anisotropic film according to the embodiment of the present invention include an aspect in which an angle θ (hereinafter, also simply referred to as “transmittance central axis angle θ”) between a transmittance central axis of the light absorption anisotropic film and a normal direction of a surface of the light absorption anisotropic film is more than 45° and 90° or less, and it is more preferably 75° or more and 90° or less and still more preferably 80° or more and 90° or less.

A laminate including a light absorption anisotropic film (polarizer) in which the transmittance central axis angle θ is more than 45° and 90° or less and a λ/4 plate (described later) is suitably used as a circularly polarizing plate.

Examples of another aspect of the light absorption anisotropic film according to the embodiment of the present invention include an aspect in which the transmittance central axis angle θ is 0° or more and 45° or less, and it is more preferably 0° or more and 35° or less and still more preferably 0° or more and less than 35°.

A laminate including a light absorption anisotropic film in which the transmittance central axis angle θ is 0° or more and 45° or less and a polarizer having an absorption axis in a plane is suitably used as a viewing angle control film.

Here, the transmittance central axis is a direction in which the highest transmittance is exhibited in a case where the transmittance is measured by changing an inclination angle (polar angle) and an inclination direction (azimuthal angle) with respect to a normal direction of a surface of the light absorption anisotropic film.

Specifically, Mueller matrix at a wavelength of 550 nm is measured using AxoScan OPMF-1 (manufactured by Opto Science, Inc.). More specifically, in the measurement, the azimuthal angle along which the transmittance central axis is inclined is first searched for, and then the Mueller matrix at a wavelength of 550 nm is actually measured while changing, at intervals of 1°, the polar angle, which is an angle with respect to the normal direction of the surface of the light absorption anisotropic film, from −70° to 70° in a plane extending along the azimuthal angle and including the normal direction of the surface of the light absorption anisotropic film (the plane including the transmittance central axis and orthogonal to the film surface), and the transmittance of the light absorption anisotropic film is derived. As a result, the direction at which the highest transmittance is exhibited is defined as the transmittance central axis.

The transmittance central axis denotes a direction of an absorption axis (major axis direction of a molecule) of the dichroic substance contained in the light absorption anisotropic film.

The transmittance central axis angle θ can be set to a desired value, for example, by adjusting the type, content, and the like of the alignment agent.

### [Laminate]

The laminate according to the embodiment of the present invention has a light absorption anisotropic film, and the light absorption anisotropic film may be disposed on a substrate. In addition, in a case where the laminate according to the embodiment of the present invention has a substrate, an alignment film may be provided between the substrate and the light absorption anisotropic film.

Hereinafter, each member constituting the laminate according to the embodiment of the present invention will be described.

### [Substrate]

As the base material, a transparent support is preferable. The transparent support is intended to refer to a support having a visible light transmittance of 60% or more, which preferably has a visible light transmittance of 80% or more, and more preferably 90% or more.

As the transparent support, a known transparent resin film, a transparent resin plate, a transparent resin sheet, or the like can be used without particular limitation.

Examples of the transparent resin film include a cellulose acylate film (such as a cellulose triacetate film (refractive index of 1.48), a cellulose diacetate film, a cellulose acetate butyrate film, or a cellulose acetate propionate film), a polyethylene terephthalate film, a polyether sulfone film, a polyacrylic resin film, a polyurethane-based resin film, a polyester film, a polycarbonate film, a polysulfone film, a polyether film, a polymethylpentene film, a polyether ketone film, and a (meth)acrylonitrile film.

Among these, a cellulose acylate film which is highly transparent, has a small optical birefringence, is easily produced, and is typically used as a protective film of a polarizing plate is preferable, and a cellulose triacetate film is more preferable.

A thickness of the base material is usually 20 to 100 μm.

In the present invention, it is particularly preferable that the base material is a cellulose ester-based film having a film thickness of 20 to 70 μm.

### [Light Absorption Anisotropic Film]

The light absorption anisotropic film according to the embodiment of the present invention is as described above, and thus the description thereof will not be repeated.

### [Alignment Film]

The alignment film (alignment layer) is as described above, and thus the description thereof will not be repeated.

### [λ/4 Plate]

Examples of one suitable aspect of the laminate according to the embodiment of the present invention include an aspect in which the laminate includes a light absorption anisotropic film (particularly, a light absorption anisotropic film in which the transmittance central axis angle θ is more than 45° and 90° or less) and a λ/4 plate. Such a laminate (optical film) is suitably used as a circularly polarizing plate.

The λ/4 plate is a plate having a λ/4 function, and specifically, a plate having a function of converting linearly polarized light of a specific wavelength into circularly polarized light (or circularly polarized light into linearly polarized light).

Specific examples of an aspect in which the λ/4 plate has a monolayer structure include a stretched polymer film and a retardation film in which a light absorption anisotropic film having a λ/4 function is provided on a support. In addition, specific examples of an aspect in which the λ/4 plate has a multilayer structure include a broadband λ/4 plate obtained by laminating a λ/4 plate and a λ/2 plate.

The λ/4 plate and the light absorption anisotropic film may be provided to be in contact with each other, or another layer may be provided between the λ/4 plate and the light absorption anisotropic film. Examples of such a layer include a pressure sensitive adhesive layer or an adhesive layer for ensuring the adhesiveness, and a barrier layer.

### [Polarizer]

Examples of another suitable aspect of the laminate according to the embodiment of the present invention include an aspect in which the laminate includes a light absorption anisotropic film (particularly, a light absorption anisotropic film in which the transmittance central axis angle θ is 0° or more and 45° or less) and a polarizer having an absorption axis in a plane. Such a laminate (optical film) is suitably used as a viewing angle control film used for controlling a viewing angle.

The polarizer is preferably disposed on a side of the light absorption anisotropic film opposite to the base material. The polarizer may be disposed to be in contact with a surface of the light absorption anisotropic film, or may be disposed on the surface of the light absorption anisotropic film through another layer (for example, a known adhesive layer or pressure-sensitive adhesive layer).

The polarizer is not particularly limited as long as the polarizer is a member having an absorption axis in the plane and having a function of converting light into specific linearly polarized light, and a known polarizer in the related art can be used. As the polarizer, an iodine-based polarizer, a dye-based polarizer using a dichroic dye, a polyene-based polarizer, or the like is used. Examples of the iodine-based polarizer and the dye-based polarizer include a coating type polarizer and a stretching type polarizer, and both polarizers can be applied.

A polarizer in which a dichroic organic coloring agent is aligned by using alignment of the liquid crystal compound is preferable as the coating type polarizer, and a polarizer prepared by adsorbing iodine or a dichroic dye on polyvinyl alcohol and stretching the polyvinyl alcohol is preferable as the stretching type polarizer.

Examples thereof include a light absorption anisotropic film described in JP2010-152351A, which does not contain a liquid crystal compound and contains a dichroic coloring agent compound which is horizontally aligned (in a direction intersecting a thickness direction of the light absorption anisotropic film), and a light absorption anisotropic film described in WO2017/154907A, which contains a liquid crystal compound and a dichroic coloring agent compound which is horizontally aligned.

### [Barrier Layer]

The laminate according to the embodiment of the present invention preferably has a barrier layer together with the light absorption anisotropic film.

Here, the barrier layer is also referred to as a gas-shielding layer (oxygen-shielding layer), and has a function of protecting the polarizer of the present invention from gas such as oxygen in the atmosphere, the moisture, or the compound contained in an adjacent layer.

From the viewpoint of further improving durability, the laminate according to the embodiment of the present invention preferably has a barrier layer having an oxygen permeability coefficient of 200 cc/m²·day atm or less in an adjacent layer of the light absorption anisotropic film, and more preferably has a barrier layer having an oxygen permeability coefficient of 50 cc/m²·day atm or less.

In addition, in the adjacent layer of the light absorption anisotropic film, in a case where there is a layer having an oxygen permeability coefficient of 200 cc/m²·day atm or less other than the above-described barrier layer, the barrier layer may not be provided.

Here, the oxygen permeability coefficient is an index indicating an amount of oxygen passing through the film per unit time and unit area, and in the present invention, a value measured by an oxygen concentration device (for example, MODEL3600 manufactured by Hack Ultra Analytical) in an environment of 25° C. and a relative humidity (RH) of 50% is employed.

Examples of the organic compound contained in the barrier layer include a polymerizable compound having a high hydrogen bonding property and a compound having a large number of polymerizable groups per molecular weight, from the viewpoint of high oxygen barrier function. Examples of the compound having a large number of polymerizable groups per molecular weight include pentaerythritol tetra(meth)acrylate and dipentaerythritol hexa(meth)acrylate.

Examples of the polymerizable compound having a high hydrogen bonding property include an epoxy compound, and specific examples thereof include compounds represented by the following formulae. Among these, 3′,4′-epoxycyclohexylmethyl-3,4-epoxycyclohexanecarboxylate represented by CEL2021P is preferable.

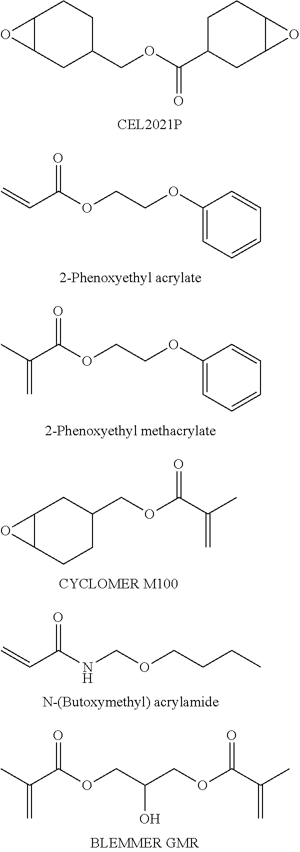

From the viewpoint of preventing the diffusion of the dichroic coloring agent in the light absorption anisotropic film during durability, as the barrier layer, it is also preferable to use a polymer having a hydrophilic group described in paragraph 0056 of WO2019-22121A or a water-soluble polymer described in paragraphs 0117 to 0133 of JP2017-083843A. In addition, descriptions disclosed in paragraphs 0014 to 0054 of JP2014-159124A, paragraphs 0042 to 0075 of JP2017-121721A, paragraphs 0045 to 0054 of JP2017-115076A, paragraphs 0010 to 0061 of JP2012-213938A, and paragraphs 0021 to 0031 of JP2005-169994A can be referred to.

### [Pressure-Sensitive Adhesive Layer]

The laminate according to the embodiment of the present invention may or may not include a pressure-sensitive adhesive layer.

Examples of the pressure-sensitive adhesive constituting the pressure-sensitive adhesive layer include a pressure-sensitive adhesive and an adhesive.

Examples of the pressure sensitive adhesive include a rubber-based pressure sensitive adhesive, an acrylic pressure sensitive adhesive, a silicone-based pressure sensitive adhesive, an urethane-based pressure sensitive adhesive, a vinyl alkyl ether-based pressure sensitive adhesive, a polyvinyl alcohol-based pressure sensitive adhesive, a polyvinyl pyrrolidone-based pressure sensitive adhesive, a polyacrylamide-based pressure sensitive adhesive, and a cellulose-based pressure sensitive adhesive, among which an acrylic pressure sensitive adhesive (pressure sensitive adhesive) is preferable.

Examples of the adhesive include a polyvinyl alcohol adhesive (water paste), a solvent-type adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet curable adhesive, and a visible light-curable adhesive; and among these, an ultraviolet curable adhesive is preferable.

A thickness of the pressure-sensitive adhesive layer is not particularly limited, but from the viewpoint of thinning, it is preferably 25 μm or less, more preferably 15 μm or less, and still more preferably 5 μm or less. The lower limit thereof is not particularly limited, but is 0.1 μm or more in many cases.

From the viewpoint of simplification and thinning, it is also preferable to provide the pressure-sensitive adhesive layer with a function of improving the durability of the barrier layer, and to adopt a configuration in which the light absorption anisotropic film and the pressure-sensitive adhesive layer are adjacent to each other without the barrier layer. For example, a configuration in which the alignment layer, the light absorption anisotropic layer, the pressure-sensitive adhesive layer, and the retardation layer are arranged adjacent to each other can be mentioned.

From the viewpoint of preventing the diffusion of the dichroic substance in the light absorption anisotropic film during durability, as the pressure-sensitive adhesive layer in this case, for example, an adhesive containing polyvinyl alcohol as a main component, an ultraviolet (UV) adhesive having a low oxygen permeability, a pressure-sensitive adhesive containing a hydrophilic group-containing polymer, or the like is preferable.

### [Image Display Device]

The display device (image display device) according to the embodiment of the present invention includes the above-described light absorption anisotropic film (preferably, the above-described laminate) and a display element.

The light absorption anisotropic film and the liquid crystal cell may be laminated through a known adhesive layer or pressure-sensitive adhesive layer.

The display element used in the display device according to the embodiment of the present invention is not particularly limited, and examples thereof include a liquid crystal cell, an organic electroluminescence (hereinafter, abbreviated as “EL”) display panel, and a plasma display panel.

Among these, a liquid crystal cell or an organic EL display panel is preferable. That is, as the display device according to the embodiment of the present invention, a liquid crystal display device obtained by using a liquid crystal cell as a display element or an organic EL display device obtained by using an organic EL display panel as a display element is preferable.

Some image display devices are thin and can be molded into a curved surface. Since the light absorption anisotropic film used in the present invention is thin and easily bent, the light absorption anisotropic film can be suitably applied to an image display device having a curved display surface.

In addition, some image display devices have a pixel density of more than 250 ppi and are capable of high-definition display. The light absorption anisotropic film used in the present invention can be suitably applied to such a high-definition image display device without causing moire.

### [Liquid Crystal Display Device]

Preferred examples of the liquid crystal display device, which is an example of the display device according to the embodiment of the present invention, include an aspect having the above-described viewing angle control film and a liquid crystal cell.

Specific examples of the configuration include a configuration in which the viewing angle control film is disposed on a front-side polarizing plate or a rear-side polarizing plate. In these configurations, the viewing angle at which the vertical direction or the horizontal direction is light-shielded can be controlled.

In addition, the viewing angle control film may be disposed on both the front-side polarizing plate and the rear-side polarizing plate. With such a configuration, viewing angle control is possible in which light is shielded in all directions and only light in the front direction is transmitted.

Further, a plurality of viewing angle control films may be laminated with a retardation layer interposed therebetween. By controlling the phase difference value and the optical axis direction, the transmission performance and the light shielding performance can be controlled. For example, by disposing a polarizer, a viewing angle control film, a λ/2 wavelength plate (the axial angle is an angle shifted by 45° with respect to the alignment direction of the polarizer), and a viewing angle control film, it is possible to perform viewing angle control in which the light is shielded in all directions and the light is transmitted only in the front direction. As the retardation layer, a positive A-plate, a negative A-plate, a positive C-plate, a negative C-plate, a B plate, an O plate, or the like can be used. From the viewpoint of reducing the thickness of the viewing angle control system, it is preferable that the thickness of the retardation layer is small as long as the optical characteristics, the mechanical properties, and the manufacturing suitability are not impaired, and specifically, the thickness thereof is preferably in a range of 1 to 150 μm, more preferably in a range of 1 to 70 μm, and still more preferably in a range of 1 to 30 μm.

Hereinafter, the liquid crystal cell constituting the liquid crystal display device will be described in detail.

### <Liquid Crystal Cell>

It is preferable that the liquid crystal cell used for the liquid crystal display device is in a vertical alignment (VA) mode, an optically compensated bend (OCB) mode, an in-plane-switching (IPS) mode, or a twisted nematic (TN) mode, but the present invention is not limited thereto.

In the liquid crystal cell in a TN mode, rod-like liquid crystalline molecules are substantially horizontally aligned at the time of no voltage application and further twisted and aligned at 60° to 120°. The liquid crystal cell in a TN mode is most frequently used as a color TFT liquid crystal display device and is described in a plurality of documents.

In the liquid crystal cell in a VA mode, rod-like liquid crystalline molecules are substantially vertically aligned at the time of no voltage application. The concept of the liquid crystal cell in a VA mode includes (1) a liquid crystal cell in a VA mode in a narrow sense where rod-like liquid crystal molecules are aligned substantially vertically at the time of no voltage application and substantially horizontally at the time of voltage application (described in JP1990-176625A (JP-H2-176625A)), (2) a liquid crystal cell (in an MVA mode) (SID97, described in Digest of Tech. Papers (proceedings) 28 (1997) 845) in which the VA mode is formed to have multi-domain in order to expand the viewing angle, (3) a liquid crystal cell in a mode (n-ASM mode) in which rod-like liquid crystal molecules are substantially vertically aligned at the time of no voltage application and twistedly multi-domain aligned at the time of voltage application (described in proceedings of Japanese Liquid Crystal Conference, p. 58 to 59 (1998)), and (4) a liquid crystal cell in a SURVIVAL mode (presented at LCD International 98). Further, the liquid crystal cell in the VA mode may be any of a patterned vertical alignment (PVA) type, an optical alignment (OA) type, or a polymer-sustained alignment (PSA) type. Details of these modes are described in JP2006-215326A and JP2008-538819A.

In the liquid crystal cell in an IPS mode, liquid crystal compounds are aligned substantially parallel to the substrate, and the liquid crystalline molecules respond planarly through application of an electric field parallel to the substrate surface. That is, the liquid crystal compounds are aligned in the plane in a state where no electric field is applied. In the IPS mode, black display is carried out in a state where no electric field is applied, and absorption axes of a pair of upper and lower polarizing plates are orthogonal to each other. A method of reducing leakage light during black display in an oblique direction and improving the viewing angle using an optical compensation sheet is disclosed in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), and JP1998-307291A (JP-H10-307291A).

### [Organic EL Display Device]

Suitable examples of the organic EL display device, which is an example of the display device according to the embodiment of the present invention, include an aspect in which the above-described circularly polarizing plate and the organic EL display panel are provided in this order from the viewing side. In this case, the substrate, the light absorption anisotropic film, and the λ/4 plate are disposed in this order from the viewing side.

In addition, the organic EL display panel is a display panel configured using an organic EL element which has an organic light emitting layer (organic electroluminescence layer) sandwiched between electrodes (between a cathode and an anode). The configuration of the organic EL display panel is not particularly limited, and a known configuration is employed.

### [Reflective Linear Polarizer]

The image display device according to the embodiment of the present invention can include a reflective linear polarizer. The reflective linear polarizer exhibits an effect of reflecting a part of light emitted from the image display panel and reciprocating the light inside the optical system. From the viewpoint of suppressing stray light and ghosts, a reflective linear polarizer having a high degree of polarization is preferable.

As the reflective linear polarizer, a film obtained by stretching a dielectric multi-layer film, a wire grid polarizer, or the like as described in JP2011-053705A can be used. As a commercially available product thereof, a reflective type polarizer (trade name: APF, IQPE) manufactured by 3M Company, a wire grid polarizer (trade name: WGF) manufactured by Asahi Kasei Corporation, or the like can be suitably used.

### [Virtual Reality Display Device]

A first aspect of a virtual reality display device which is an example of the display device according to the embodiment of the present invention is a virtual reality display device including, in the following order: an image display panel; a first absorption type linear polarizer (light absorption anisotropic film); a first retardation layer; a second retardation layer; a reflective type linear polarizer; a third retardation layer; a half mirror; and a second absorption type linear polarizer (light absorption anisotropic film).

A second aspect of the virtual reality display device is a virtual reality display device including, in the following order: an image display panel; a first absorption type linear polarizer; a first retardation layer; a half mirror; a reflective type circular polarizer; a second retardation layer; and a second absorption type linear polarizer.

A third aspect of the virtual reality display device is a virtual reality display device including, in the following order: an image display panel; a first absorption type linear polarizer; a first retardation layer; a half mirror; a second retardation layer; a reflective type linear polarizer; and a second absorption type linear polarizer.

Furthermore, it is also preferable that a fourth retardation layer is provided on a viewing side of the second absorption type linear polarizer.

In the virtual reality display device according to the embodiment of the present invention, a curved substrate having a lens shape can be used as a base material (for example, a member between the second retardation layer 12 and the half mirror 40 in the FIGURE).

In this case, the light absorption anisotropic film or the laminate according to the embodiment of the present invention can be processed into a three-dimensional curved surface and used.

The FIGURE is a side view schematically showing an embodiment of a virtual reality display device according to the present invention. In a virtual reality display device 100 of the FIGURE, a second absorption type linear polarizer 22, a second retardation layer 12, a half mirror 40, an antireflection layer 50, a reflective type circular polarizer 30, a positive C-plate 60, a first retardation layer 11, a first absorption type linear polarizer 21, a third retardation layer 13, and an image display panel 70 are disposed in this order from a visible side.

### EXAMPLES

Hereinbelow, the present invention will be described in more detail with reference to Examples. Materials, used amounts, ratios, treatment details, treatment procedures, and the like shown in the following examples can be appropriately changed within a range not departing from the scope of the present invention. Therefore, the scope of the present invention should not be restrictively interpreted by the following Examples.

### Example 1-1

A surface of a cellulose acylate film (TAC base material having a thickness of 60 μm; TG60, manufactured by FUJIFILM Corporation) was saponified with an alkali solution, and a composition P1 for forming an alignment film shown below was applied onto the surface with a wire bar. The support on which the coating film was formed was dried with hot air at 60° C. for 60 seconds and further dried with hot air at 100° C. for 120 seconds to form an alignment film P1. Next, a rubbing treatment (rotation speed of a roller: 1,000 rotations/1.8 mm spacer thickness, stage speed: 1.8 m/min) was carried out once to obtain a film with an alignment layer. A film thickness of the alignment film P1 was 1 μm.

Composition P1 for forming alignment film

| | |
|---|---|
| Modified polyvinyl | 3.80 parts by mass |
| alcohol PVA-1 | |
| IRGACURE 2959 | 0.20 parts by mass |
| Water | 70.00 parts by mass |
| Methanol | 30.00 parts by mass |

Modified Polyvinyl Alcohol PVA-1

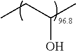

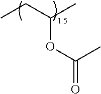

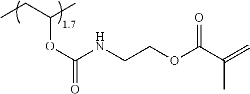

### [Preparation of Light Absorption Anisotropic Film]

The following composition (liquid crystal composition) 1-1 for forming a light absorption anisotropic film was continuously applied onto the obtained alignment film P1 with a wire bar, heated at 140° C. for 30 seconds, and cooled to room temperature (23° C.). Next, the coating layer was heated at 85° C. for 40 seconds, and then cooled to room temperature again. Thereafter, the film was irradiated with a light emitting diode (LED) lamp (central wavelength of 365 nm) for 2 seconds under an irradiation condition of an illuminance of 200 mW/cm², thereby immobilizing the alignment states of the liquid crystal compound and the dichroic substance in the film, and a light absorption anisotropic film 1-1 was laminated on the alignment film P1. A film thickness of the light absorption anisotropic film 1-1 was 1.0 μm.

Formulation of Composition 1-1 for Forming Light Absorption Anisotropic Film

| | |
|---|---|
| The following liquid crystal compound L1 | 51.900 parts by mass |
| The following liquid crystal compound L5 | 20.760 parts by mass |
| The following dichroic substance Y1 | 0.727 parts by mass |
| The following dichroic substance M1 | 4.671 parts by mass |
| The following dichroic substance C1 | 18.684 parts by mass |
| Polymerization initiator I1 (IRGACURE OXE-02, manufactured by BASF SE) | 3.010 parts by mass |
| The following polymer A1 (polymer 1) | 0.083 parts by mass |
| The following polymer B1 (polymer 2) | 0.166 parts by mass |
| Tetrahydrofuran | 190.000 parts by mass |
| Cyclopentanone | 1,710.000 parts by mass |

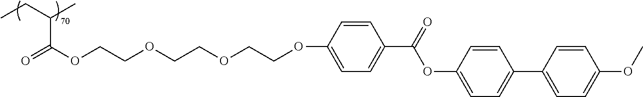

L1 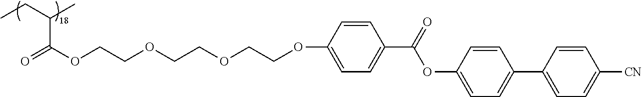 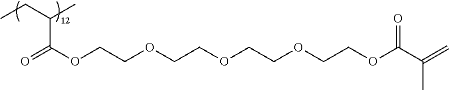 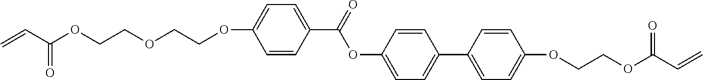 [SMILES: C=CC(=O)OCCOCCOc1ccc(C(=O)Oc2ccc(-c3ccc(OCCOC(=O)C=C)cc3)cc2)cc1]
L6 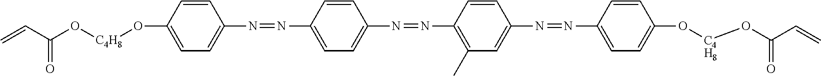
Y1 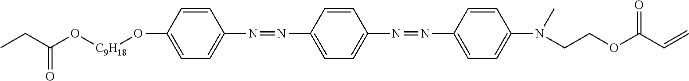
M1 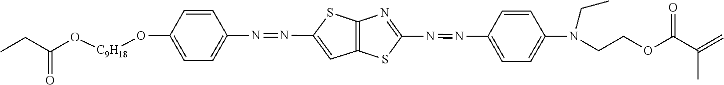
C1 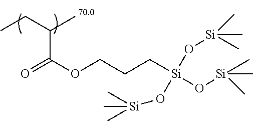 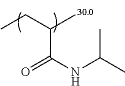
Mw 18000 A1 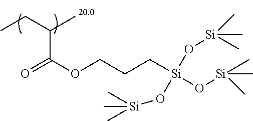 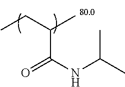
Mw 18000 B1

The numerical values next to the parentheses of each repeating unit denote the content (% by mass) of each repeating unit with respect to all the repeating units of each polymer. In addition, Mw represents a weight-average molecular weight.

The liquid crystal compound L¹ is a polymer liquid crystal compound, and the liquid crystal compound L⁵ is a low-molecular-weight liquid crystal compound.

### [Production of Barrier Layer]

The following barrier composition was continuously applied onto the light absorption anisotropic film 1-1 with a wire bar. Next, the film was dried at 80° C. and irradiated with an LED lamp (central wavelength: 365 nm) for 2 seconds under an irradiation condition of an illuminance of 200 mW/cm², thereby obtaining a laminate H1 in which a barrier layer BA1 was formed. A film thickness of the barrier layer was 1.0 μm.

(Composition BA1 for forming barrier layer)

| | |
|---|---|
| Modified polyvinyl alcohol | 3.8 parts by mass |
| PVA-1 shown above | |
| IRGACURE 2959 | 0.20 parts by mass |
| Water | 70.00 parts by mass |
| Methanol | 30.00 parts by mass |

### Examples 1-2 to 1-10 and Comparative Examples 1-1 and 1-2

Each laminate of Examples 1-2 to 1-10 and Comparative Examples 1-1 and 1-2 was obtained in the same manner as in Example 1-1, except that the composition of the composition (liquid crystal composition) 1-1 for forming a light absorption anisotropic film was changed to the composition shown in Table 1 below and the type of the alignment film was changed as shown in Table 1 below.

A method of producing the alignment film P2 is shown below.

### [Alignment Film P2]

The following composition P2 for forming an alignment film was applied onto a cellulose acylate film (TAC base material having a thickness of 60 μm; TG60 manufactured by FUJIFILM Corporation) with a wire bar. The cellulose acylate film on which the coating film was formed was dried with hot air at 140° C. for 120 seconds to form an alignment film P2. Subsequently, the coating film was irradiated with polarized ultraviolet rays (10 mJ/cm2, using an ultra-high pressure mercury lamp) to obtain a film with a photo-alignment film. A film thickness of the alignment film P1 was 1.5 μm.

(Composition P2 for forming alignment film)

| | |
|---|---|
| Polymer P2 shown below | 100.00 parts by mass |
| Acid generator PAG-1 (manufactured by Sanxin | 12.00 parts by mass |
| Chemical Industry Co., Ltd.) | |
| DIPEA (N,N-diisopropylethylamine) | 0.6 parts by mass |
| Methyl ethyl ketone | 665.00 parts by mass |
| Butyl acetate | 166.00 parts by mass |

Polymer P2

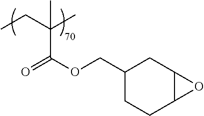

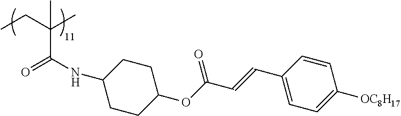

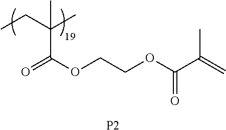

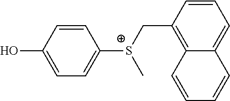 [SMILES: C[S+](Cc1cccc2ccccc12)c1ccc(O)cc1]

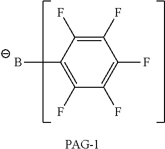

Components other than the components described above among the components indicated by symbols in Table 1 are shown below. The numerical values next to the parentheses of each repeating unit denote the content (% by mass) of each repeating unit with respect to all the repeating units of each polymer.

The liquid crystal compounds L2 to L4 are polymer liquid crystal compounds, and the liquid crystal compounds L6 to L12 are low-molecular-weight liquid crystal compounds.

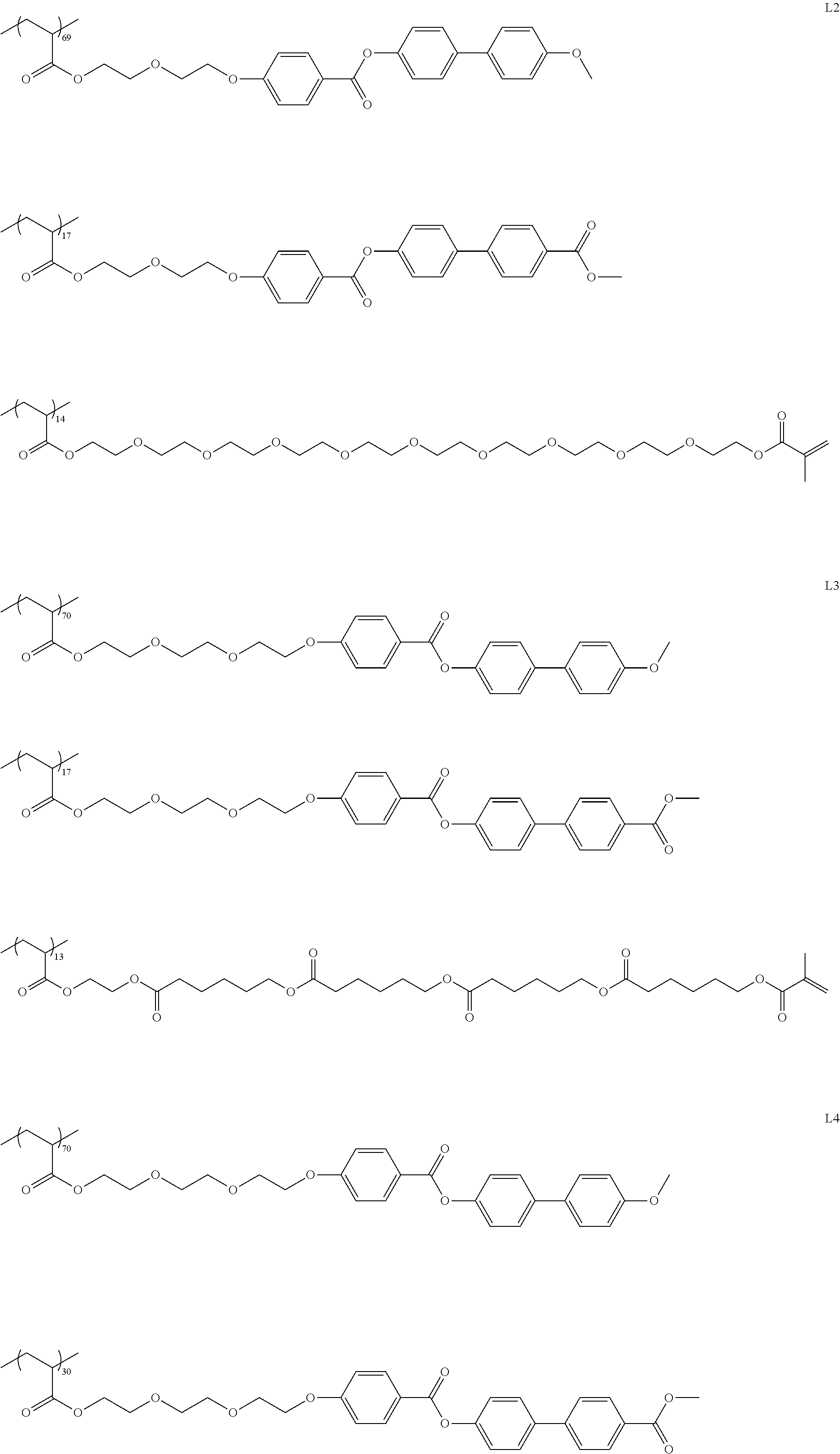

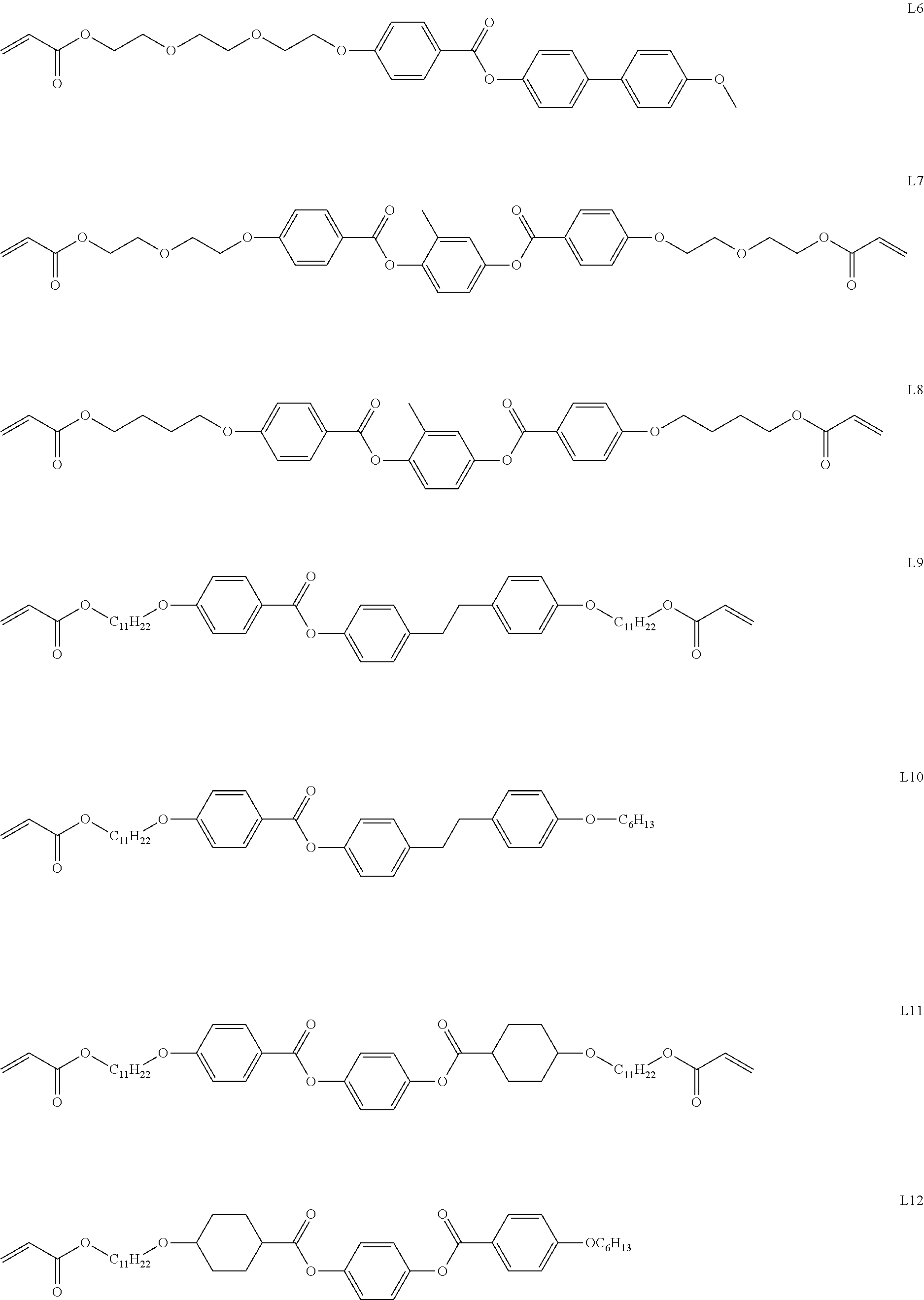

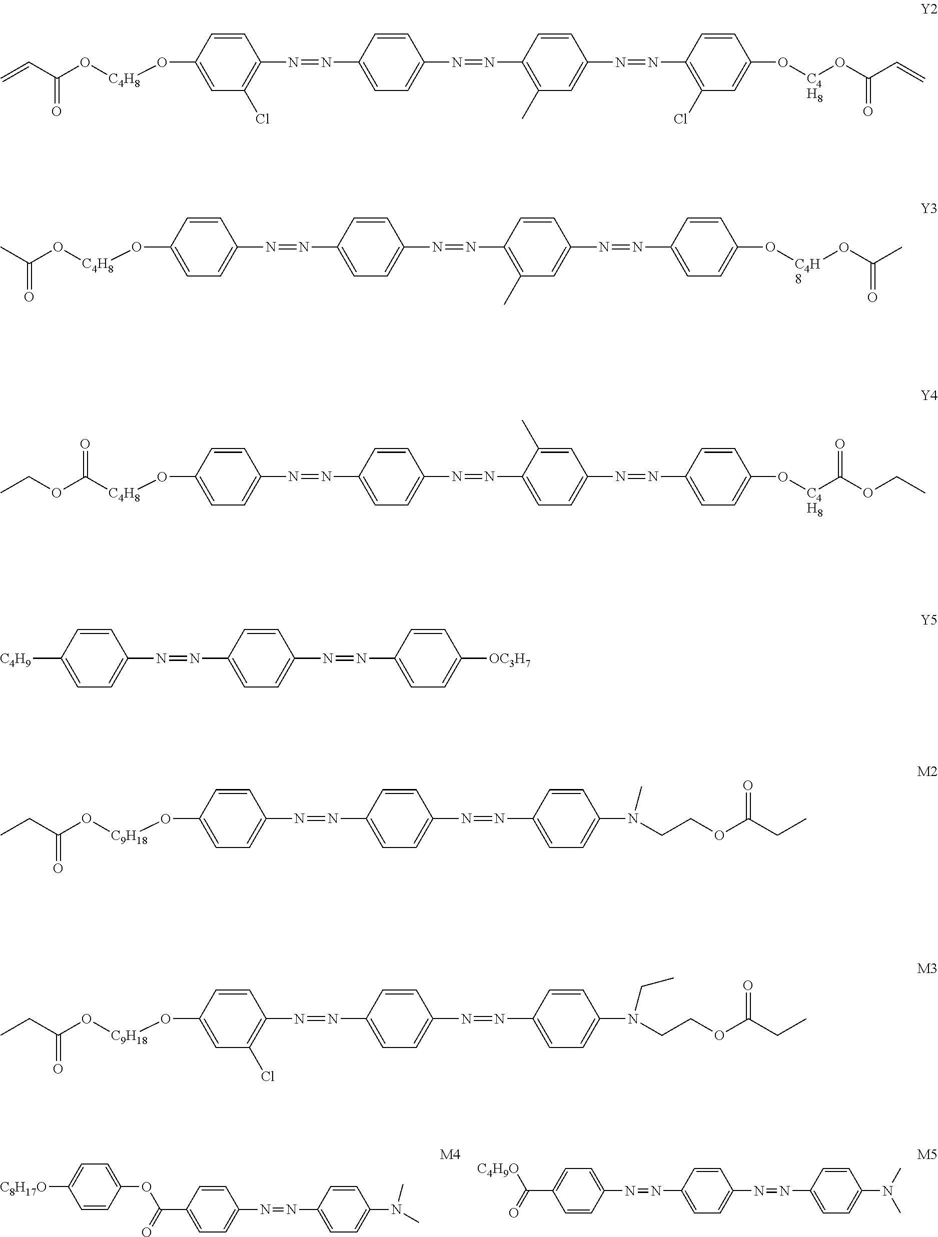

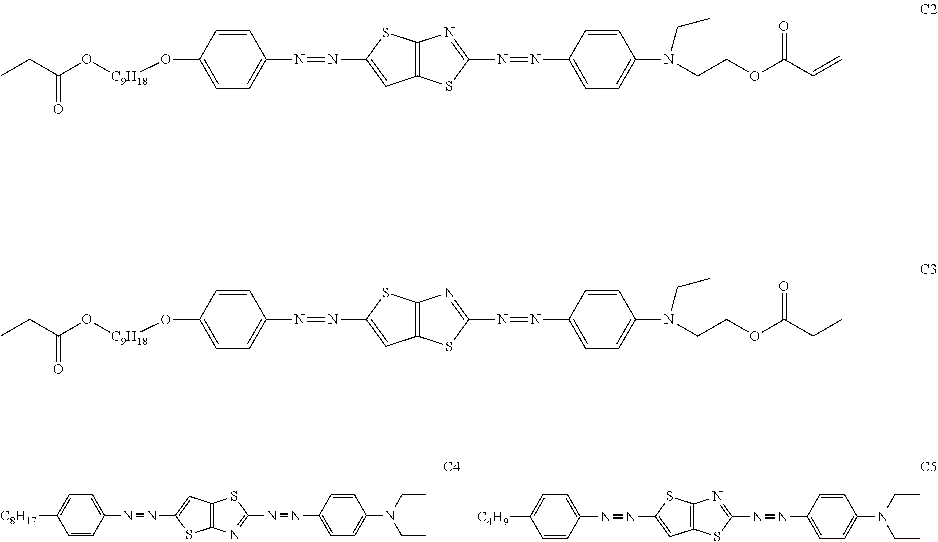

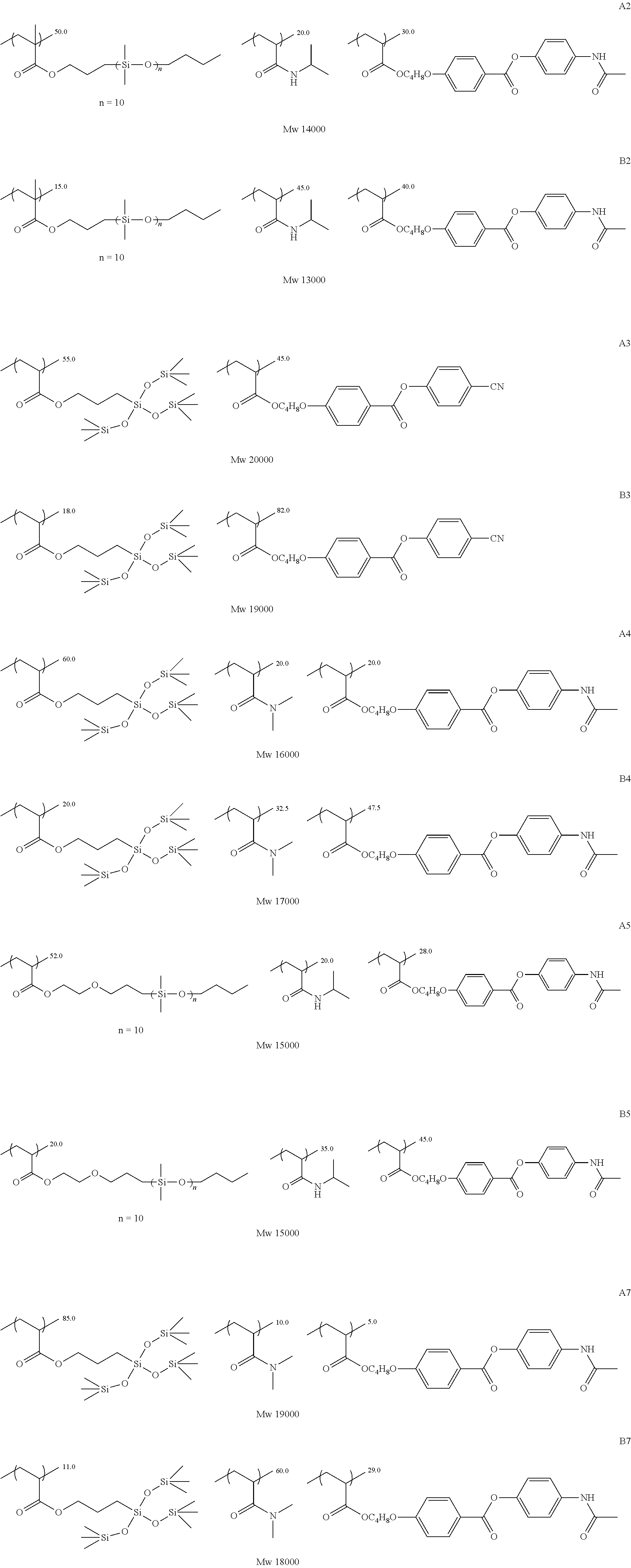

### [Evaluation Test]

### [Surface State]

Each laminate of Examples and Comparative Examples was disposed on a polarizing plate to be in a crossed nicols state, observed, and rotated in a horizontal plane to confirm the bright and dark states. Unevenness during the application of the composition for forming a light absorption anisotropic film was confirmed from the bright and dark states. The results are shown in Table 1.
A: no unevenness was observed visually in the entire surface.
B: weak unevenness was partially observed visually.
C: strong unevenness was partially observed visually.
D: strong unevenness was observed visually in the entire surface.

### [Alignment Degree]

Each laminate of the examples and the comparative examples was set on a sample table in a state where a linear polarizer was inserted on a light source side of an optical microscope (product name, “ECLIPSE E600 POL”, manufactured by Nikon Corporation), the absorbance of the light absorption anisotropic film in a wavelength range of 380 nm to 780 nm was measured at a pitch of 1 nm using a multi-channel spectroscope (product name, “QE65000”, manufactured by Ocean Optics, Inc.), and the alignment degree in a wavelength range of 400 nm to 700 nm was calculated according to the following equation. Based on the obtained alignment degree, the alignment degree was evaluated according to the following evaluation standards. The evaluation results are listed in Table 1.

$$Alignment degree : S = ( ( Az 0 / Ay 0 ) - 1 ) / ( ( Az 0 / Ay 0 ) + 2 )$$

In the above Formula, “Az0” represents the absorbance of the light absorption anisotropic film with respect to polarization in the absorption axis direction, and “Ay0” represents the absorbance of the light absorption anisotropic film with respect to polarization in the transmission axis direction.
A: 0.95 or more
B: 0.91 or more and less than 0.95
C: less than 0.91

Since all the layer configurations other than the light absorption anisotropic film included in the laminate do not have absorption in 400 to 700 nm, the alignment degree calculated above can be read as a value of the light absorption anisotropic film included in the laminate.

### [Transmittance Central Axis Angle θ]

In a case where the transmittance central axis angle θ was measured by the above-described method using the laminates of Examples and Comparative Examples, the transmittance central axis angle θ of all of the laminates of Examples and Comparative Examples was in a range of 80° to 90°.

Since all the layer configurations other than the light absorption anisotropic film included in the laminate do not have absorption anisotropy, the transmittance central axis angle θ calculated above can be read as a value of the light absorption anisotropic film included in the laminate.

TABLE 1

| | | Liquid crystal | | Liquid crystal | | Dichroic | | Dichroic | | Dichroic | | Dichroic | |
|---|---|---|---|---|---|---|---|---|---|---|---|---|---|
| | | composition | | composition | | substance | | substance | | substance | | substance | |
| | Alignment | | Parts by | | Parts by | | Parts by | | Parts by | | Parts by | | Parts by |
| | film | Type | mass | Type | mass | Type | mass | Type | mass | Type | mass | Type | mass |
| Example 1-1 | P1 | L1 | 51.900 | L5 | 20.760 | Y1 | 0.727 | M1 | 4.671 | C1 | 18.684 | — | 0.000 |
| Example 1-2 | P2 | L2 | 55.196 | L8 | 23.974 | Y4 | 1.673 | M2 | 4.349 | C2 | 2.788 | C3 | 8.363 |
| Example 1-3 | P1 | L3 | 52.835 | L6 | 21.971 | Y2 | 0.837 | M2 | 2.406 | C2 | 4.708 | C3 | 14.857 |
| Example 1-4 | P2 | LA | 52.144 | L7 | 22.065 | Y4 | 1.145 | M3 | 2.706 | C3 | 19.255 | — | 0.000 |
| Example 1-5 | P2 | L2 | 51.886 | L8 | 21.359 | Y3 | 0.938 | M3 | 2.501 | C3 | 19.900 | — | 0.000 |
| Example 1-6 | P2 | L9 | 67.702 | L10 | 22.567 | Y5 | 2.076 | M4 | 1.264 | M5 | 1.173 | C5 | 2.257 |
| Example 1-7 | P2 | L11 | 68.132 | L12 | 22.711 | Y5 | 2.271 | M4 | 2.271 | C4 | 1.363 | C5 | 1.181 |
| Example 1-8 | P1 | L4 | 51.135 | L5 | 21.477 | Y4 | 1.023 | M2 | 4.398 | C2 | 4.807 | C3 | 14.829 |
| Example 1-9 | P2 | L11 | 68.132 | L12 | 22.711 | Y5 | 2.271 | M4 | 2.271 | C4 | 1.363 | C5 | 1.181 |
| Example 1-10 | P1 | L4 | 52.144 | L5 | 22.065 | Y4 | 1.145 | M2 | 2.706 | C3 | 19.255 | — | 0.000 |
| Comparative | P1 | L1 | 51.824 | L5 | 20.730 | Y1 | 0.726 | M1 | 4.664 | C1 | 18.657 | — | 0.000 |
| Example 1-1 | | | | | | | | | | | | | |
| Comparative | P1 | L1 | 51.986 | L5 | 20.794 | Y1 | 0.728 | M1 | 4.679 | C1 | 18.715 | — | 0.000 |
| Example 1-2 | | | | | | | | | | | | | |

TABLE 2

| | Polymer 1 | | | Polymer 2 | | | | | Polymerization | | Tetra- | | | |
|---|---|---|---|---|---|---|---|---|---|---|---|---|---|---|
| | | | X1 | | | X2 | | | initiator | | hydro- | Cyclo- | | |
| | | Parts | (Parts | | Parts | (Parts | | | | (Parts | furan | pentanone | | Align- |
| | | by | by | | by | by | X1/ | A1/ | | by | Parts by | Parts by | Surface | ment |
| | Type | mass | mass) | Type | mass | mass) | X2 | A2 | Type | mass | mass | mass | state | degree |
| Example 1-1 | A1 | 0.083 | 0.016 | B1 | 0.166 | 0.009 | 1.778 | 3.50 | I1 | 3.010 | 190.000 | 1710.000 | A | A |
| Example 1-2 | A2 | 0.156 | 0.024 | B2 | 0.156 | 0.007 | 3.429 | 3.33 | I1 | 3.345 | 190.000 | 1710.000 | A | A |
| Example 1-3 | A3 | 0.115 | 0.017 | B3 | 0.178 | 0.009 | 1.889 | 3.06 | I1 | 2.092 | 190.000 | 1710.000 | A | A |
| Example 1-4 | A4 | 0.091 | 0.015 | B4 | 0.200 | 0.011 | 1.364 | 3.00 | I1 | 2.394 | 190.000 | 1710.000 | B | A |
| Example 1-5 | A5 | 0.114 | 0.017 | B5 | 0.178 | 0.010 | 1.700 | 2.60 | I1 | 3.126 | 190.000 | 1710.000 | A | A |
| Example 1-6 | A4 | 0.079 | 0.013 | B4 | 0.174 | 0.010 | 1.300 | 3.00 | I1 | 2.708 | 190.000 | 1710.000 | B | B |
| Example 1-7 | A5 | 0.099 | 0.015 | B5 | 0.155 | 0.009 | 1.667 | 2.60 | I1 | 1.817 | 190.000 | 1710.000 | A | B |
| Example 1-8 | A5 | 0.112 | 0.017 | B1 | 0.174 | 0.010 | 1.700 | 2.60 | I1 | 2.045 | 190.000 | 1710.000 | A | A |
| Example 1-9 | A4 | 0.088 | 0.014 | B3 | 0.167 | 0.008 | 1.750 | 3.33 | I1 | 1.817 | 190.000 | 1710.000 | A | B |
| Example 1- | A7 | 0.085 | 0.020 | B7 | 0.207 | 0.006 | 3.333 | 7.73 | I1 | 2.394 | 190.000 | 1710.000 | C | A |
| 10 | | | | | | | | | | | | | | |
| Comparative | A1 | 0.290 | 0.056 | — | 0.000 | 0.000 | — | — | I1 | 3.109 | 190.000 | 1710.000 | C | C |
| Example 1-1 | | | | | | | | | | | | | | |
| Comparative | — | 0.000 | 0.000 | B1 | 0.291 | 0.016 | — | — | I1 | 2.807 | 190.000 | 1710.000 | D | B |
| Example 1-2 | | | | | | | | | | | | | | |

In Table 1, the definitions of X1, X2, X1/X2, and A1/A2 are as described above.

As shown in Table 1, it was found that, in a case where a liquid crystal composition including the polymer 1 and the polymer 2 and having X1/X2 of 1 or more was used, a light absorption anisotropic film in which surface unevenness could be suppressed and the alignment degree was excellent was obtained (Examples 1-1 to 1-9).

From the comparison between Examples 1-1 to 1-8 and Example 1-9, it was found that, in a case where A1/A2 was 7.50 or less, the surface unevenness could be further suppressed.

From the comparison between Examples 1-1 to 1-3, 1-5, and 1-7 to 1-9 and Examples 1-4 and 1-6, it was found that, in a case where X1/X2 was 1.370 or more, the surface unevenness could be further suppressed.

From the comparison between Examples 1-1 to 1-5, 1-8, and 1-10 and Examples 1-6 to 1-7 and 1-9, it was found that, in a case where a polymer liquid crystal compound was used, the alignment degree was more excellent.

On the other hand, in a case where a liquid crystal composition including only one kind of polymer having the repeating unit A including a structure represented by Formula (A) was used, it was found that one of the surface unevenness or the alignment degree was deteriorated (Comparative Examples 1-1 and 1-2).

### Example 2-1

A film of the alignment film P1 used in Example 1-1 in a state in which the rubbing treatment was not performed was used as an alignment film P3.

### [Production of Light Absorption Anisotropic Film 2-1]

The obtained alignment film P3 was continuously coated with the following composition 11 for forming a light absorption anisotropic film using a wire bar, heated at 140° C. for 30 seconds, and cooled to room temperature (23° C.). Next, the coating layer was heated at 90° C. for 60 seconds and cooled to room temperature again. Thereafter, the film was irradiated with an LED lamp (central wavelength of 365 nm) for 2 seconds under an irradiation condition of an illuminance of 200 mW/cm², thereby immobilizing the alignment states of the liquid crystal compound and the dichroic substance in the film, and a light absorption anisotropic film 2-1 was produced on the alignment film P3. A film thickness of the light absorption anisotropic film 2-1 was 1.9 μm.

(Composition 2-1 for forming light absorption anisotropic film)

| | |
|---|---|
| Liquid crystal compound L1 shown above | 44.265 parts by mass |
| Liquid crystal compound L5 shown above | 26.559 parts by mass |
| Dichroic substance Y3 shown above | 9.837 parts by mass |
| Dichroic substance M3 shown above | 0.984 parts by mass |
| Dichroic substance C2 shown above | 1.967 parts by mass |
| Dichroic substance C3 shown above | 10.820 parts by mass |
| Polymer A8 shown below (polymer 1) | 0.118 parts by mass |
| Polymer B8 shown below (polymer 2) | 0.039 parts by mass |
| Vertical alignment agent G1 shown below | 1.476 parts by mass |
| Vertical alignment agent G2 shown below | 2.459 parts by mass |
| Polymerization initiator I1 (IRGACURE OXE-02, manufactured by BASF SE) | 1.476 parts by mass |
| Cyclopentanone (CPO) | 669.231 parts by mass |

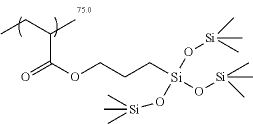

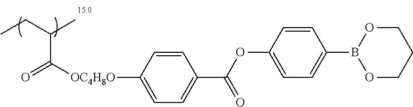

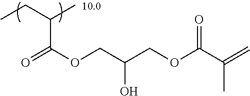

Mw 19000 A8 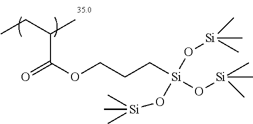 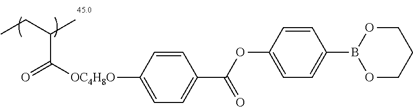 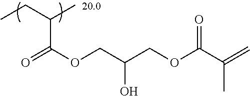
Mw 18000 B8 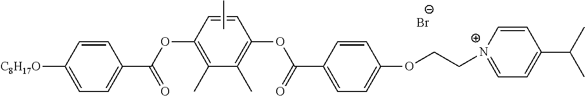
G1 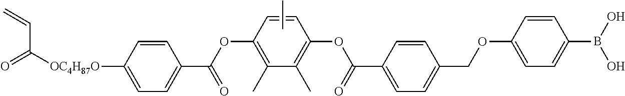
G2

### [Production of Barrier Layer]

A barrier layer BA1 was formed on the above-described light absorption anisotropic film 2-1 by the same method as in Example 1-1 to obtain a laminate V1.

### Examples 2-2 and 2-3 and Comparative Examples 2-1 and 2-2

Laminates of Examples 2-2 and 2-3 and Comparative Examples 2-1 and 2-2 were obtained in the same manner as in Example 2-1, except that the formulation of the composition (liquid crystal composition) 2-1 for forming a light absorption anisotropic film was changed to the formulation shown in Table 2.

Components other than the components described above among the components indicated by symbols in Table 2 are shown below. The numerical values next to the parentheses of each repeating unit denote the content (% by mass) of each repeating unit with respect to all the repeating units of each polymer.

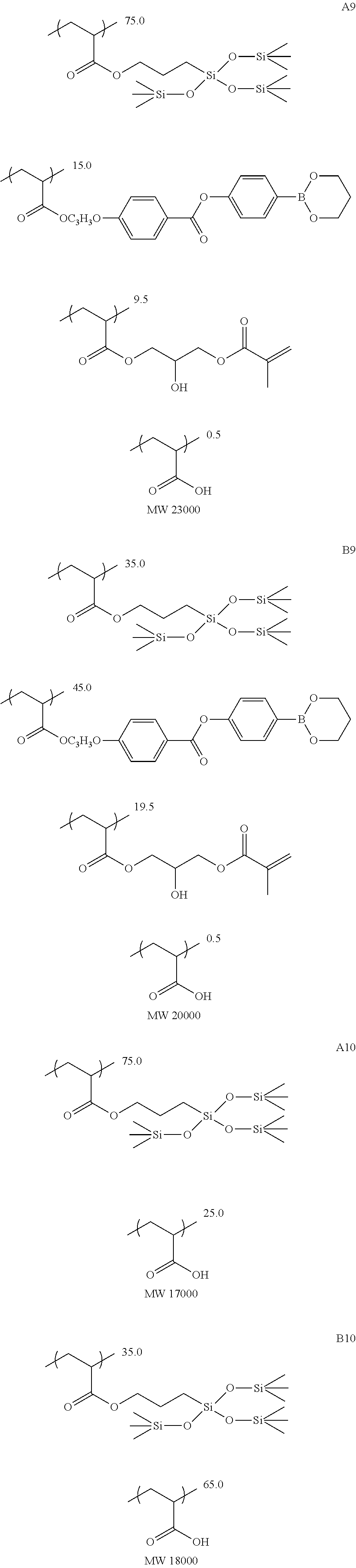

### [Evaluation Test]

### [Surface State]

Each laminate of Examples and Comparative Examples was disposed on a polarizing plate to be in a crossed nicols state, observed, and rotated in a horizontal plane to confirm the bright and dark states. Unevenness during the application of the composition for forming a light absorption anisotropic film was confirmed from the bright and dark states. The results are shown in Table 1.
A: no unevenness was observed visually in the entire surface.
B: weak unevenness was partially observed visually.
C: strong unevenness was partially observed visually.
D: strong unevenness was observed visually in the entire surface.

### [Alignment Degree]

Each laminate of the examples and the comparative examples was set on a sample table in a state where a linear polarizer was inserted on a light source side of an optical microscope (product name, “ECLIPSE E600 POL”, manufactured by Nikon Corporation), the absorbance of the light absorption anisotropic film in a wavelength range of 380 nm to 780 nm was measured at a pitch of 1 nm using a multi-channel spectroscope (product name, “QE65000”, manufactured by Ocean Optics, Inc.), and the alignment degree in a wavelength range of 400 nm to 700 nm was calculated according to the following equation. Based on the obtained alignment degree, the alignment degree was evaluated according to the following evaluation standards. The evaluation results are listed in Table 1.

$$Alignment degree : S = ( ( Az 0 / Ay 0 ) - 1 ) / ( ( Az 0 / Ay 0 ) + 2 )$$

In the above Formula, “Az0” represents the absorbance of the light absorption anisotropic film with respect to polarization in the absorption axis direction, and “Ay0” represents the absorbance of the light absorption anisotropic film with respect to polarization in the transmission axis direction.
A: 0.95 or more
B: 0.91 or more and less than 0.95
C: less than 0.91

Since all the layer configurations other than the light absorption anisotropic film included in the laminate do not have absorption in 400 to 700 nm, the alignment degree calculated above can be read as a value of the light absorption anisotropic film included in the laminate.

### [Transmittance Central Axis Angle θ]

In a case where the transmittance central axis angle θ was measured by the above-described method using the laminates of Examples and Comparative Examples, the transmittance central axis angle θ of all of the laminates of Examples and Comparative Examples was in a range of 0° to 10°.

Since all the layer configurations other than the light absorption anisotropic film included in the laminate do not have absorption anisotropy, the transmittance central axis angle θ calculated above can be read as a value of the light absorption anisotropic film included in the laminate.

TABLE 3

| | | Liquid crystal | | Liquid crystal | | Dichroic | | Dichroic | | Dichroic | | Dichroic | |
|---|---|---|---|---|---|---|---|---|---|---|---|---|---|
| | | composition | | composition | | substance | | substance | | substance | | substance | |
| | Alignment | | Parts by | | Parts by | | Parts by | | Parts by | | Parts by | | Parts by |
| | film | Type | mass | Type | mass | Type | mass | Type | mass | Type | mass | Type | mass |
| Example 2-1 | P3 | L1 | 44.265 | L5 | 26.559 | Y3 | 9.837 | M3 | 0.984 | C2 | 1.967 | C3 | 10.820 |
| Example 2-2 | P3 | L2 | 43.538 | L5 | 26.717 | Y2 | 10.390 | M2 | 0.693 | — | 0.000 | C3 | 12.864 |
| Example 2-3 | P3 | L2 | 44.178 | L5 | 26.507 | Y2 | 9.817 | M2 | 0.982 | — | 0.000 | C3 | 12.664 |
| Comparative | P3 | L1 | 44.265 | L5 | 26.559 | Y3 | 9.837 | M3 | 0.984 | C2 | 1.967 | C3 | 10.820 |
| Example 2-1 | | | | | | | | | | | | | |
| Comparative | P3 | L1 | 44.265 | L5 | 26.559 | Y3 | 9.837 | M3 | 0.984 | C2 | 1.967 | C3 | 10.820 |
| Example 2-2 | | | | | | | | | | | | | |

TABLE 4

| | Polymer 1 | | | Polymer 2 | | | | |
|---|---|---|---|---|---|---|---|---|
| | | | X1 | | | X2 | | |
| | | Parts | (Parts | | Parts | (Parts | | |
| | | by | by | | by | by | X1/ | A1/ |
| | Type | mass | mass) | Type | mass | mass) | X2 | A2 |
| Example 2-1 | A8 | 10.118 | 0.024 | B8 | 0.039 | 0.004 | 6.000 | 2.14 |
| Example 2-2 | A9 | 0.119 | 0.024 | B9 | 0.040 | 0.004 | 6.000 | 2.14 |
| Example 2-3 | A10 | 0.118 | 0.024 | B10 | 0.039 | 0.004 | 6.000 | 2.14 |
| Comparative | A8 | 0.157 | 0.032 | — | 0.000 | 0.000 | — | — |
| Example 2-1 | | | | | | | | |
| Comparative | — | 0.000 | 0.000 | B8 | 10.157 | 0.015 | — | — |
| Example 2-2 | | | | | | | | |
| | | | | | Poly- | | | |
| | Vertical | | Vertical | | meri- | Cyclo- | | |
| | alignment | | alignment | | zation | penta- | | |
| | agent | agent | initiator | none | Parts | Parts | Sur- | Align- |
| | | by | | by | by | by | face | ment |
| | Type | mass | Type | mass | mass | mass | state | degree |
| Example 2-1 | G1 | 1.476 | G2 | 2.459 | 1.476 | 669.231 | A | A |
| Example 2-2 | G1 | 1.583 | G2 | 2.573 | 1.484 | 669.231 | A | A |
| Example 2-3 | G1 | 1.669 | G2 | 2.553 | 1.473 | 669.231 | B | A |
| Comparative | G1 | 1.476 | G2 | 2.459 | 1.476 | 669.231 | D | B |
| Example 2-1 | | | | | | | | |
| Comparative | G1 | 1.476 | G2 | 2.459 | 1.476 | 669.231 | D | B |
| Example 2-2 | | | | | | | | |

In Table 2, the definitions of X1, X2, X1/X2, and A1/A2 are as described above.

As shown in Table 2, it was found that, in a case where a liquid crystal composition including the polymer 1 and the polymer 2 and having X1/X2 of 1 or more was used, a light absorption anisotropic film in which surface unevenness could be suppressed and the alignment degree was excellent was obtained (Examples 2-1 to 2-3).

From the comparison between Examples 2-1 and 2-2 and Example 2-3, it was found that, in a case where at least one of the polymer 1 or the polymer 2 had the repeating unit E satisfying the above-described condition 2 for the purpose of obtaining a light absorption anisotropic film exhibiting vertical alignment, the surface unevenness could be further suppressed.

On the other hand, it was found that, in a case where a liquid crystal composition including only one kind of polymer having the repeating unit A including the structure represented by Formula (A) was used, at least one of the surface unevenness or the alignment degree was deteriorated (Comparative Examples 2-1 and 2-2).

### EXPLANATION OF REFERENCES

100: virtual reality display device
11: first retardation layer
12: second retardation layer
13: third retardation layer
21: first absorption type linear polarizer
22: second absorption type linear polarizer
30: reflective circular polarizer
40: half mirror
50: antireflection layer
60: positive C-plate
70: image display panel

What is claimed is:

1. A liquid crystal composition comprising:
a liquid crystal compound;
a dichroic substance;
a polymer 1 having a repeating unit A including a structure represented by Formula (A); and
a polymer 2 having a repeating unit A including a structure represented by Formula (A), the polymer 2 being different from the polymer 1,
wherein in a case where a content of silicon atoms contained in the polymer 1 is denoted by X1 parts by mass and a content of silicon atoms contained in the polymer 2 is denoted by X2 parts by mass with respect to 100 parts by mass of a total solid content mass of the liquid crystal composition, a ratio represented by X1/X2 is 1 or more, 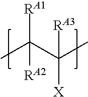
in Formula (A),
R^{A1} and R^{A2} each independently represent a hydrogen atom or an alkyl group,
R^{A3} represents a hydrogen atom, a halogen atom, or a substituent,
X represents a substituent including one or more structures represented by Formula (a), 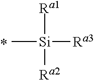
in Formula (a),
* represents a bonding position,
R^{a1}, R^{a2}, and R^{a3} each independently represent an alkyl group, an alkenyl group, an aryl group, or an alkylene aryl group, which may have a substituent.

2. The liquid crystal composition according to claim 1,
wherein in a case where a content of the repeating unit A contained in the polymer 1 is denoted by A1% by mass with respect to all repeating units of the polymer 1, and a content of the repeating unit A contained in the polymer 2 is denoted by A2% by mass with respect to all repeating units of the polymer 2, a ratio represented by A1/A2 is more than 1.

3. The liquid crystal composition according to claim 2,
wherein the ratio represented by A1/A2 is 1.2 to 7.50.

4. The liquid crystal composition according to claim 2,
wherein A1 is 30.0% to 75.0% by mass, and
A2 is 10.0% to 50.0% by mass.

5. The liquid crystal composition according to claim 2,
wherein A1 is 30.0% to 90.0% by mass, and
A2 is 5.0% to 65.0% by mass.

6. The liquid crystal composition according to claim 1,
wherein the ratio represented by X1/X2 is 1.10 to 41.32.

7. The liquid crystal composition according to claim 1,
wherein the ratio represented by X1/X2 is 1.10 to 79.34.

8. The liquid crystal composition according to claim 1,
wherein X1 is 0.0016 to 0.057 parts by mass, and
X2 is 0.0013 to 0.0500 parts by mass.

9. The liquid crystal composition according to claim 1,
wherein X1 is 0.0027 to 0.0546 parts by mass, and
X2 is 0.0006 to 0.0437 parts by mass.

10. The liquid crystal composition according to claim 1,
wherein at least one of the polymer 1 or the polymer 2 has a repeating unit B represented by Formula (B), 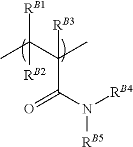
in Formula (B),
R^{B1}, R^{B2}, and R^{B3} each independently represent a hydrogen atom, a halogen atom, a cyano group, an alkyl group, an alkenyl group, or an aryl group,
R^{B4} and R^{B5} each independently represent a hydrogen atom or a substituent, and in a case where R^{B4} and R^{B5} each represent a substituent, R^{B4} and R^{B5} may be linked to each other to form a ring.

11. The liquid crystal composition according to claim 1,
wherein at least one of the polymer 1 or the polymer 2 has a repeating unit D represented by Formula (D), 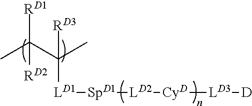
in Formula (D),
R^{D1}, R^{D2}, and R^{D3} each independently represent a hydrogen atom, a halogen atom, a cyano group, an alkyl group, an alkenyl group, or an aryl group,
L^{D1} represents a single bond, —COO—, or —CO—,
Sp^{D1} represents a divalent hydrocarbon group having 1 to 20 carbon atoms, provided that, one —CH₂— or two or more —CH₂—'s which are not adjacent to each other among —CH₂—'s constituting a part of the hydrocarbon group may be each independently substituted with —O—, —S—, —NH—, or —N(Q)-, and Q represents a substituent,
L^{D2} and L^{D3} each independently represent a single bond or a divalent linking group,
Cy^{D} represents a divalent linking group including a mesogen group,
D represents a hydrogen-bonding group formed of a hydrogen atom and a non-metal atom of Groups 14 to 16, provided that, the non-metal atom may have a substituent, and
n represents an integer of 1 to 3, and in a case where n is 2 or 3, a plurality of L^{D2}'s may be the same or different from each other, and a plurality of Cy^{D}'s may be the same or different from each other.

12. The liquid crystal composition according to claim 1,
wherein at least one of the polymer 1 or the polymer 2 has both a repeating unit B represented by Formula (B) and a repeating unit D represented by Formula (D), 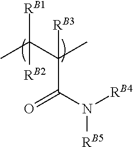
in Formula (B),
R^{B1}, R^{B2}, and R^{B3} each independently represent a hydrogen atom, a halogen atom, a cyano group, an alkyl group, an alkenyl group, or an aryl group,
R^{B4} and R^{B5} each independently represent a hydrogen atom or a substituent, in a case where R^{B4} and R^{B5} each represent a substituent, R^{B4} and R^{B5} may be linked to each other to form a ring, 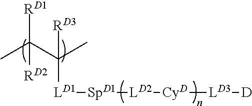
in Formula (D),
R^{D1}, R^{D2}, and R^{D3} each independently represent a hydrogen atom, a halogen atom, a cyano group, an alkyl group, an alkenyl group, or an aryl group,
L^{D1} represents a single bond, —COO—, or —CO—,
Sp^{D1} represents a divalent hydrocarbon group having 1 to 20 carbon atoms, provided that, one —CH₂— or two or more —CH₂—'s which are not adjacent to each other among —CH₂—'s constituting a part of the hydrocarbon group may be each independently substituted with —O—, —S—, —NH—, or —N(Q)-, and Q represents a substituent,
L^{D2} and L^{D3} each independently represent a single bond or a divalent linking group,
Cy^{D} represents a divalent linking group including a mesogen group,
D represents a hydrogen-bonding group formed of a hydrogen atom and a non-metal atom of Groups 14 to 16,
provided that, the non-metal atom may have a substituent, and
n represents an integer of 1 to 3, and in a case where n is 2 or 3, a plurality of L^{D2}'s may be the same or different from each other, and a plurality of Cy^{D}'s may be the same or different from each other.

13. The liquid crystal composition according to claim 1,
wherein at least one of the polymer 1 or the polymer 2 has a repeating unit E which does not contain a fluorine atom and a polymerizable group, and
the repeating unit E satisfies Condition 1 or Condition 2,
Condition 1: the repeating unit E has a polar group at a terminal of a side chain,
Condition 2: the repeating unit E is represented by Formula (E-1) or (E-2), 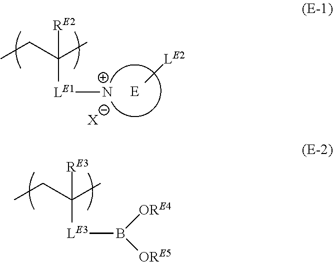
in Formula (E-1),
R^{E2} represents a hydrogen atom or a substituent,
L^{E1} represents a single bond or a divalent linking group selected from the group consisting of —O—, —S—, —COO—, —OCO—, —CONR^{L1}—, —NR^{L1}COO—, —CR^{L1}N—, a substituted or unsubstituted divalent aliphatic group, a substituted or unsubstituted divalent aromatic group, and a combination thereof, and R^{L1} represents a hydrogen atom or an alkyl group having 1 to 20 carbon atoms,
a ring E represents a ring structure having a cationized nitrogen atom,
X represents an anion,
L² represents a hydrogen atom or a substituent,
in Formula (E-2),
R^{E3} represents a hydrogen atom or a substituent,
L^{E3} represents a single bond or a divalent linking group selected from the group consisting of —O—, —S—, —COO—, —OCO—, —CONR^{L1}—, —NR^{L1}COO—, —CR^{L1}N—, a substituted or unsubstituted divalent aliphatic group, a substituted or unsubstituted divalent aromatic group, and a combination thereof, and R^{L1} represents a hydrogen atom or an alkyl group having 1 to 20 carbon atoms,
R^{E4} and R^{E5} each independently represent a hydrogen atom, a substituted or unsubstituted aliphatic hydrocarbon group, a substituted or unsubstituted aryl group, or a substituted or unsubstituted heteroaryl group, and R^{E4} and R^{E5} may be linked to each other through a linking group consisting of an alkylene linking group, an arylene linking group, or a combination of these groups.

14. A light absorption anisotropic film obtained by using the liquid crystal composition according to claim 1.

15. The light absorption anisotropic film according to claim 14,
wherein an alignment state of the liquid crystal compound and the dichroic substance contained in the light absorption anisotropic film is immobilized, and
an angle θ between a transmittance central axis of the light absorption anisotropic film and a normal direction of a surface of the light absorption anisotropic film is more than 45° and 90° or less.

16. The light absorption anisotropic film according to claim 14,
wherein an alignment state of the liquid crystal compound and the dichroic substance contained in the light absorption anisotropic film is immobilized, and
an angle θ between a transmittance central axis of the light absorption anisotropic film and a normal direction of a surface of the light absorption anisotropic film is 0° or more and 45° or less.

17. A laminate comprising: the light absorption anisotropic film according to claim 14; and
a λ/4 plate.

18. An image display device comprising:
the light absorption anisotropic film according to claim 14; and
a display element.

19. The liquid crystal composition according to claim 3,
wherein A1 is 30.0% to 75.0% by mass, and
A2 is 10.0% to 50.0% by mass.

20. The liquid crystal composition according to claim 3,
wherein A1 is 30.0% to 90.0% by mass, and
A2 is 5.0% to 65.0% by mass.
